(19) United States
(12) Patent Application Publication
(10) Pub. No.: US 2026/0340181 A1
(43) Pub. Date: Oct. 29, 2026

(54) RAPID DATA MIGRATION BETWEEN COMPUTING SYSTEMS USING AUTONOMOUS METADATA-DRIVEN PROCESSES

(71) Applicant: ADP, Inc., Roseland, NJ (US)

(72) Inventors: Keval Khara, New York, NY (US); Gabriel Rojas, New York, NY (US); Kunal Daral, New York, NY (US); Pramodh Thurayamannil Subramanian, New York, NY (US); Kumar Rangarajan, New York, NY (US); Karthik Ushkala, Alpharetta, GA (US); Ejona Kocibelli, New York, NY (US)

(73) Assignee: ADP, Inc., Roseland, NJ (US)

(21) Appl. No.: 19/661,316

(22) Filed: Apr. 28, 2026

Related U.S. Application Data
(60) Provisional application No. 63/796,658, filed on Apr. 29, 2025.

(51) Int. Cl. G06F 21/62; G06F 16/22; G06F 16/2457; G06F 21/31

(52) U.S. Cl. CPC G06F 21/6245; G06F 16/2282; G06F 16/24573; G06F 21/31

(57) ABSTRACT

Rapid data migration between computing systems using autonomous metadata-driven processes is provided. A system can include one or more process, coupled with memory. The one or more processors can select one or more agents based on a state of metadata that corresponds to a metadata-based platform, and each agent can execute a respective function to migrate client data onto the metadata-based platform. The one or more processors can transmit, using a first agent, a first message including a reference to the state of metadata of the metadata-based platform. The one or more processors can select, based on the first message, a second agent to execute a respective function. The one or more processors can generate, based on execution of respective functions of the first and second agent, a structured query to migrate at least a portion of the client data onto the metadata-based platform.

### TECHNICAL FIELD

This patent application is generally related to computing technology and, particularly, to the migration of data between computing systems.

### BACKGROUND

Client data can be migrated from one computing system or source to another computing system or target. However, data migration can cause delays, increase processing load or memory use, or result in errors when coordinating between different components or systems.

### SUMMARY

Aspects of the technical solutions described herein address the challenges associated with migrating data between different components and systems by using autonomous metadata-driven processes. The technical challenges associated with migrating data between computing systems can cause delays, increased processing load, and inconsistent data transformations. Such technical challenges can arise when multiple components operate without reference to a consistent metadata state, which can result in conflicting outputs, applying data transformations out of order or sequence, and redundant or excessive operations. The technical solutions described herein address such technical challenges and improve onboarding performance by coordinating execution of one or more autonomous metadata-driven processes using messages that reference a shared metadata state and associated client data for onboarding. The metadata-driven processes can include, utilize, or otherwise leverage artificial intelligence (AI)-based agents. For example, the AI-based agent can reduce delays that can occur when onboarding functions execute without coordination, which can result in idle time between processing stages or repeated retries. The technical solutions described herein can provide an autonomous metadata-driven process (e.g., via one or more AI-based agents) that reduces such delays by coordinating execution of onboarding functions using messages that reference a shared metadata state, such that each function proceeds based on outputs of prior processing.

In another example, processing load can increase when different components apply overlapping operations or perform unnecessary validations due to a lack of context. The technical solutions described herein reduce processing load by aligning the execution of each function with the metadata state, which reflects current constraints, schemas, and transformation logic. In yet another example, data transformations can become inconsistent when functions apply conflicting logic or operate on incompatible assumptions about client data. The technical solutions described herein reduce transformation inconsistencies by transmitting metadata-referenced messages between components, such that each transformation is applied in sequence and in accordance with a shared onboarding structure.

An aspect can include a system including one or more processors, coupled with memory. The one or more processors can select one or more agents from a plurality of agents based on a state of metadata that corresponds to a metadata-based platform. Each of the plurality of agents can be configured to execute respective functions to migrate client data onto the metadata-based platform. The one or more processors can transmit, using a first agent of the plurality of agents, a first message. The first message can include a reference to the state of metadata of the metadata-based platform. The one or more processors can select, based on the first message, a second agent of the plurality of agents to execute a respective function of the second agent. The second agent can be different from the first agent. The one or more processors can generate, based on execution of respective functions of the first agent and the second agent, a structured query. The structured query can be configured to migrate at least a portion of the client data onto the metadata-based platform.

The state of metadata can correspond to at least one configuration of a plurality of configurations associated with a plurality of service platforms. The one or more processors can select the at least one configuration based on an input corresponding with at least one service platform of the plurality of service platforms. The one or more processors can execute, responsive at least in part to selection of the at least one configuration, the respective functions of the plurality of agents to migrate the client data in accordance with the at least one configuration.

The first message can include a reference to the client data stored in a shared data repository or data source. The one or more processors can access the client data from the shared data repository or data source using the reference. The one or more processors can access the client data responsive at least in part to receiving the first message.

At least one of the plurality of agents can include a validation agent. The one or more processors can compare, using the validation agent, one or more values of the client data to the state of metadata. The one or more processors can compare the one or more values responsive to the execution of the respective functions of the one or more agents of the plurality of agents. The one or more processors can output a validation result based on determining whether the client data conforms to the state of metadata. To output the validation result, the one or more processors can use the validation agent.

The state of metadata can include a mapping of one or more definitions, constraints, schemas, or transformations associated with a metadata-based platform. The one or more processors can update client data using a respective function of the at least one of the plurality of agents in accordance with the one or more definitions, constraints, schemas, or transformations. To update the client data, the one or more processors can use at least one of the plurality of agents. The one or more processors can generate the structured query based on the one or more definitions, constraints, schemas, or transformations.

The one or more processors can remove personally identifiable information from client data. The one or more processors can process the state of metadata based on one or more predefined conditions associated with a respective function of each agent to determine whether to execute the respective function of each agent. To process the state of metadata, the one or more processors can use each agent of the plurality of agents.

The one or more processors can access a knowledge base. The knowledge base can include one or more migration instructions associated with prior onboarding instances. The one or more processors can access the knowledge base based on the state of metadata. The one or more processors can execute a respective function of the at least one agent based at least in part on the one or more migration instructions associated with the prior onboarding instances. To execute the respective function, the one or more processors can use at least one agent of the plurality of agents.

The one or more processors can generate a review prompt based on a confidence threshold associated with the execution of a respective function of the at least one agent. To generate the review prompt, the one or more processors can use at least one agent of the plurality of agents. The one or more processors can update client data based on input received via the review prompt. To update the client data, the one or more processors can use the at least one agent.

The one or more processors can execute, using at least one translation agent of the plurality of agents, a translation operation on the client data based on the state of metadata. The translation operation can convert one or more parameters of the client data that are associated with a first context to a second context selected for migration via the metadata-based platform.

The one or more processors can receive the client data from a plurality of source systems. The one or more processors can generate, in parallel for the plurality of source systems, respective source tables and respective mappings for the client data. The one or more processors can merge at least a portion of the respective source tables into a combined table. The one or more processors can validate the combined table. The one or more processors can generate the structured query responsive at least in part to validation of the combined table.

The one or more processors can identify a conversion stage associated with migration of the client data. The one or more processors can query, based at least in part on identification of the conversion stage, a knowledge base to retrieve a plurality of migration instructions that correspond to the conversion stage. The one or more processors can apply a first migration instruction of the plurality of migration instructions to directly modify execution of a first function of the respective functions of the plurality of agents. The one or more processors can provide a second migration instruction of the plurality of migration instructions as input to an artificial intelligence model used to execute a second function of the respective functions of the plurality of agents.

The one or more processors can determine, based on the state of metadata, a plurality of execution contexts associated with the client data. The one or more processors can initialize, for each execution context of the plurality of execution contexts, a context-specific metadata state. The one or more processors can execute, for each execution context, a respective migration workflow using the plurality of agents based on the context-specific metadata state to generate one or more results. The one or more processors can update, based at least in part on the one or more results, the context-specific metadata state for each execution context.

The one or more processors can receive a request associated with filtering of the client data. The one or more processors can generate, responsive at least in part to receipt of the request, one or more executable filters. The one or more processors can execute the one or more executable filters to remove at least a portion of the client data.

The one or more processors can cause a graphical user interface to display a tracker comprising a sequence of stages of a migration workflow. The sequence of stages can correspond to execution states of the respective functions of the plurality of agents. The one or more processors can output, via the graphical user interface, one or more selectable controls configured to control one or more stages of the sequence of stages.

An aspect can include a method. The method can include selecting, by one or more processors, coupled with memory, one or more agents from a plurality of agents based on a state of metadata that corresponds to a metadata-based platform. Each of the plurality of agents can be configured to execute respective functions to migrate client data onto the metadata-based platform. The method can include transmitting, by the one or more processors, using a first agent of the plurality of agents, a first message including a reference to the state of metadata of the metadata-based platform. The method can include selecting, by the one or more processors, based on the first message, a second agent of the plurality of agents to execute a respective function of the second agent. The second agent can be different from the first agent. The method can include generating, by the one or more processors, based on execution of respective functions of the first agent and the second agent, a structured query. The structured query can be configured to migrate at least a portion of the client data onto the metadata-based platform.

The state of metadata can correspond to at least one configuration of a plurality of configurations associated with a plurality of service platforms The method can include selecting, by the one or more processors, the at least one configuration based on an input corresponding with at least one service platform of the plurality of service platforms. The method can include executing, by the one or more processors, responsive at least in part to selection of the at least one configuration, the respective functions of the plurality of agents to migrate the client data in accordance with the at least one configuration.

The first message can include a reference to the client data stored in a shared data repository or data source. The method can include accessing, by the one or more processors, the client data from the shared data repository or data source using the reference. The method can include accessing the client data responsive at least in part to receiving the first message.

At least one of the plurality of agents can include a validation agent. The method can include comparing, by the one or more processors, one or more values of client data to the state of metadata. The method can include comparing the one or more values responsive to execution of the respective functions of the one or more agents of the plurality of agents. To compare the one or more values, the method can include using the validation agent. The method can include outputting, by the one or more processors, a validation result based on determining the client data conforms to the state of metadata. To output the validation result, the method can include using the validation agent.

The state of metadata can include a mapping of one or more definitions, constraints, schemas, or transformations associated with a metadata-based platform. The method can include updating, by the one or more processors, client data using a respective function of the at least one of the plurality of agents in accordance with the one or more definitions, constraints, schemas, or transformations. To update the client data, the method can include using at least one of the plurality of agents. The method can include generating, by the one or more processors, the structured query based on the one or more definitions, constraints, schemas, or transformations.

An aspect can include one or more non-transitory computer-readable storage medium (CRM). The one or more non-transitory CRM can have one or more instructions stored thereon, and the one or more instructions can be executable by one or more processors. The one or more instructions can be executable by the one or more processors to select one or more agents from a plurality of agents based on a state of metadata that corresponds to a metadata-based platform. Each of the plurality of agents can be configured to execute respective functions to migrate client data onto the metadata-based platform. The one or more instructions can be executable by the one or more processors to transmit, using a first agent of the plurality of agents, a first message. The first message can include a reference to the state of metadata of the metadata-based platform. The one or more instructions can be executable by the one or more processors to select, based on the first message, a second agent of the plurality of agents to execute a respective function of the second agent. The second agent can be different from the first agent. The one or more instructions can be executable by the one or more processors to generate, based on execution of respective functions of the first agent and the second agent, a structured query. The structured query can be configured to migrate at least a portion of the client data onto the metadata-based platform.

These and other aspects are discussed in detail below. The foregoing information and the following detailed description include illustrative examples of various aspects and provide an overview or framework for understanding the nature and character of the claimed aspects. The drawings provide illustrations and a further understanding of the various aspects are incorporated in and constitute a part of this specification. The foregoing information and the following detailed description and drawings include illustrative examples and should not be considered as limiting.

### BRIEF DESCRIPTION OF THE FIGURES

Aspects of this patent application are described in the detailed description which follows, in reference to the noted plurality of drawings by way of non-limiting examples of exemplary aspects of the technical solutions described herein.

FIG. 1 is an illustrative example of a system for rapid data migration between computing systems using autonomous metadata-driven processes, in accordance with some aspects.

FIG. 2 is an illustrative example of a computer-implemented method for rapid data migration between computing systems using autonomous metadata-driven processes, in accordance with some aspects.

FIG. 3 is an illustrative example of a computer-implemented method for rapid data migration between computing systems using autonomous metadata-driven processes, in accordance with some aspects.

FIG. 4 is an illustrative example of a system for rapid data migration between computing systems using autonomous metadata-driven processes, in accordance with some aspects.

FIG. 5 is an illustrative example of a computer-implemented method for full-stack rapid data conversion using autonomous metadata-driven processes, in accordance with some aspects.

FIG. 6 is an illustrative example of a computer-implemented method for multi-vendor data conversion using parallel vendor-specific processing and table merging, in accordance with some aspects.

FIG. 7 is an illustrative example of a computer-implemented method for using a knowledge base for data conversion with autonomous metadata-driven processes, in accordance with some aspects.

FIG. 8 is an illustrative example of a computer-implemented method for context-specific data conversion across a plurality of execution contexts, in accordance with some aspects.

FIG. 9 is an illustrative example of a computer-implemented method for associate-data filtering for a data conversion workflow, in accordance with some aspects.

FIGS. 10A-10L depicts illustrative examples of graphical user interfaces used for rapid data migration between computing systems using autonomous metadata-driven processes, in accordance with some aspects.

FIG. 11 depicts an illustrative architecture of a computing system implemented in some aspects.

### DETAILED DESCRIPTION

Following below are more detailed descriptions of various concepts related to, and aspects of, systems, methods, or non-transitory computer-readable storage media (CRM) for rapid data migration between computing systems using autonomous metadata-driven processes. The various concepts introduced above or discussed in greater detail below can be implemented in any of numerous ways.

Aspects of technical solutions described herein relate to rapid data migration between computing systems using autonomous metadata-driven processes. For example, the technical solutions described herein can transmit a first message using a first agent of a plurality of agents. The plurality of agents can include agents of various types configured to execute operations for data migration or client onboarding. For example, the agents can include one or more of an exploratory data analysis agent, a data extraction agent, a data mapping agent, a data transformation agent, a data translation agent, or a data validation and correction agent. In some examples, the first message transmitted by the first agent can include a reference to a state of metadata associated with a metadata-based platform. A metadata-based platform can include or refer to a system that uses a metadata state to define or control the processing, transformation, or storage of data. For example, the metadata-based platform can include a metadata state defining schema information, transformation logic, field mappings, validation constraints, or configuration parameters associated with data stored in the metadata-based platform. In some examples, based on the first message, a second agent can be selected to execute a respective function that differs from the respective function of the first agent. For example, the first agent may execute a first function using exploratory data analysis to identify relevant fields and data distributions, and the second agent may execute a second function by using data mapping based on the identified structure.

In some examples, the technical solutions herein further transmit, by the second agent, a second message based on the execution of the respective function of the second agent. The second message can include the reference to the state of metadata, and one or more additional agents can be selected based on the second message to execute additional respective functions. For example, a third agent can apply transformation logic based on the mapped fields, a fourth agent can validate the transformed data using metadata-defined rules, and so on. In some examples, agent selection and execution can repeat or iterate such that a dynamic and continuous processing flow is established based on upstream outputs provided by one or more agents and an updated metadata state. The technical solutions described herein further generate a structured query based on outputs of the one or more additional agents. The structured query can be configured for storage in the metadata-based platform and can reflect the transformations executed in accordance with the metadata state of the metadata-based platform. For example, the technical solutions described herein coordinate execution of agent functions using metadata-referenced messages that maintain alignment with defined schemas, constraints, or transformations, thereby avoiding redundant operations, delays, processing errors, or inconsistent transformations.

In some aspects, the state of metadata can correspond to a structured metadata object or record maintained by the metadata processing system and associated with a given onboarding or migration workflow instance. The state of metadata can include, for example, a metadata state identifier, version information, and one or more structured sets of definitions, constraints, schemas, transformation rules, routing directives, or validation criteria associated with the metadata‑based platform. The state of metadata can further include or reference service‑platform identifiers, import types, execution stages, and one or more configuration parameters that define permissible operations for a given stage of migration. The computing system can update the state of metadata as respective agent functions are executed, such that downstream agent selection and execution are performed with reference to an updated metadata state that reflects completion status, derived mappings, applied transformations, or validation outcomes produced during earlier stages.

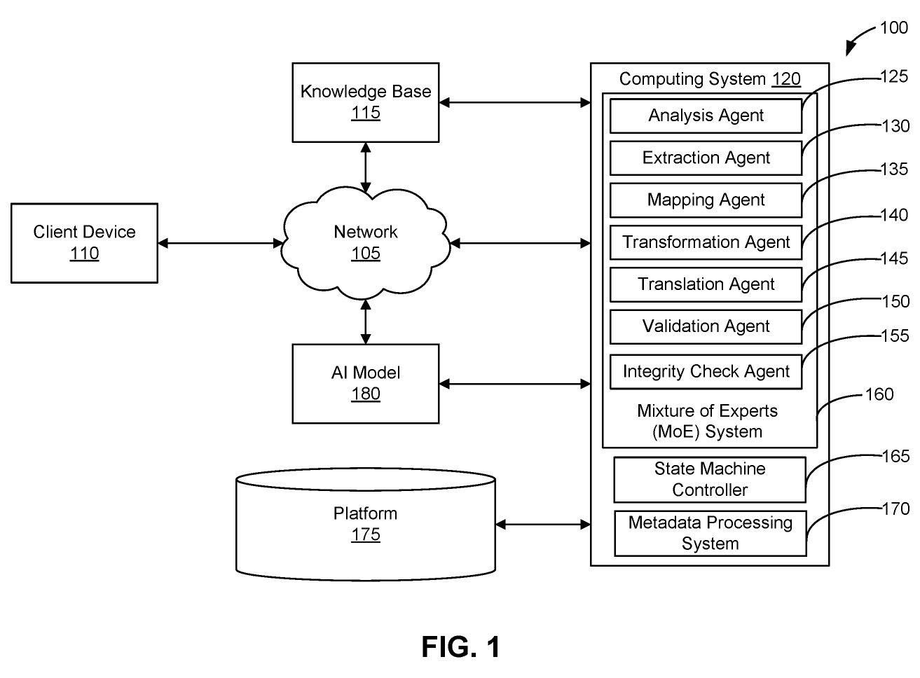

FIG. 1 is an illustrative example of system 100 for rapid data migration between computing systems using autonomous metadata-driven processes. The system 100 can include a computing system 120 that communicates or otherwise interfaces with a client device 110 via a network 105. The system 100 can include a knowledge base 115 and a platform 175 (e.g., a metadata-based platform). The computing system 120 can communicate or otherwise interface with the client device 110 via the network 105 to onboard or migrate client data onto the platform 175 (e.g., based on information, data, or instructions stored in the knowledge base 115). The computing system 120 can include or be communicatively coupled with a mixture of experts (MoE) system 160 having one or more of an analysis agent 125, an extraction agent 130, a mapping agent 135, a transformation agent 140, a translation agent 145, a validation agent 150, or an integrity check agent 155. The computing system 120 can include or be communicatively coupled with one or more of a state machine controller 165 and a metadata processing system 170. At least one (e.g., each) of the analysis agent 125, extraction agent 130, mapping agent 135, transformation agent 140, translation agent 145, validation agent 150, and integrity check agent 155 can include or be communicatively coupled with an artificial intelligence (AI) model 180. In some aspects, at least one (e.g., each) agent of the computing system 120 can execute or perform one or more operations (e.g., respective functions) to migrate client data received from the client device 110 onto the platform 175.

Although the components of FIG. 1 can be described in the singular form herein (e.g., a client device 110, computing system 120, etc.), it should be understood that the system 100 can include two or more of any components (e.g., two client devices 110, etc.). Each of the components or subsystems of system 100 (e.g., client device 110, knowledge base 115, computing system 120, analysis agent 125, extraction agent 130, mapping agent 135, transformation agent 140, translation agent 145, validation agent 150, integrity check agent 155, MoE system 160, state machine controller 165, metadata processing system 170, platform 175, AI model 180, etc.) can include one or more processors coupled with memory or software and configured to execute or perform the various processes and tasks described herein. In some aspects, one or more of the sub-systems of the computing system 120 (e.g., analysis agent 125, extraction agent 130, mapping agent 135, transformation agent 140, translation agent 145, validation agent 150, integrity check agent 155, MoE system 160, state machine controller 165, metadata processing system 170, platform 175, etc.) or other components of FIG. 1 (e.g., knowledge base 115, AI model 180, etc.) can be local to or remote from the computing system 120.

The network 105 can include a wireless or wired connection used by the client device 110 or the computing system 120 to store, transmit, receive, or display information for rapid data migration between computing systems using autonomous metadata-driven processes. The network 105 facilitates the client device 110 or the computing system 120 communicating with internal subcomponents (described herein) or external components. The computing system 120, for example, receives data from the client device 110 and transmits data to the client device 110 via the network 105. The network 105 can include a hardwired connection (e.g., copper wire or fiber optics) or a wireless connection (e.g., wide area network (WAN), controller area network (CAN), local area network (LAN), or personal area network (PAN)). For example, the network 105 can support Wi-Fi, Bluetooth, BLE, or other communication protocols for transferring data. In some aspects, one or more components of FIG. 1 (e.g., client device 110, computing system 120) use network 105 to perform the various processes and tasks described herein (e.g., transmitting messages, determining metadata states, onboarding client data onto a metadata platform, etc.).

The network 105 can facilitate communications in accordance with various communication protocols such as Transmission Control Protocol and Internet Protocol (TCP/IP), User Datagram Protocol (UDP), or IEEE communication protocols. In one example, the network 105 can include wireless communications according to Bluetooth specification sets, or another standard or proprietary wireless communication protocol. In another example, the network 105 can include communications over a cellular network, including, e.g., a GSM (Global System for Mobile Communications), CDMA (Code Division Multiple Access), EDGE (Enhanced Data for Global Evolution) network.

The systems or sub-systems described herein with regard to FIG. 1 (e.g., client device 110, knowledge base 115, computing system 120, analysis agent 125, extraction agent 130, mapping agent 135, transformation agent 140, translation agent 145, validation agent 150, integrity check agent 155, MoE system 160, state machine controller 165, metadata processing system 170, platform 175, etc.) can include any combination of hardware and software. For example, client device 110, knowledge base 115, computing system 120, analysis agent 125, extraction agent 130, mapping agent 135, transformation agent 140, translation agent 145, validation agent 150, integrity check agent 155, etc. can include any computing device including one or more processors coupled with memory or software and configured to perform or execute the various processes and tasks described herein.

The client device 110 can include a laptop, a desktop computer, a smart phone, a tablet, etc. In some aspects, the client device 110 can be operated by or associated with a user or client. The client device 110 can execute various applications, including any platform for performing various tasks or operations, such as a low-code platform, no-code platform, software-as-a-service platform (SaaS), web application, web browser, desktop application, or others. For example, the client device 110 can execute an interface (e.g., a graphical user interface or GUI, a chatbot interface, etc.) to receive inputs and display outputs. In some aspects, the client device 110 can include various input or output devices (e.g., an input/output circuit, a pointing device, a keyboard, a display, a touch screen, a microphone, a speaker, etc.). For example, the client device 110 can receive or provide client data via a user interaction with an input element (e.g., keyboard, microphone, touch screen, etc.).

The interface provided by client device 110 can include or refer to any data processing system configured to receive an input and provide or display an output. An input may include or refer to client data (e.g., entity data, customer data, etc.) provided or input via the client device 110. An output may include or refer to a prompt provided to guide onboarding (e.g., a review prompt), a request for additional client input (e.g., disambiguation prompt), or a status message (e.g., confirmation corresponding with successful onboarding). For example, the client device 110 can include one or more graphical user interfaces (GUIs), text-based interfaces (e.g., messaging app, chat window in a web application, etc.), voice-based interfaces (e.g., virtual assistant on a smart device), or multimodal interfaces (e.g., interface combining text, voice, or other inputs and outputs to facilitate user interaction). The client device 110 can display various information (e.g., images, text-based information, prompts, etc.) or interactive elements (e.g., user input fields, buttons, menus, etc.) using the interface. For example, the client device 110 can display, responsive to a request to onboard or migrate client data onto platform 175, an output corresponding to a result or current state of the migration or onboarding (e.g., pending, success, failure, etc.). The client device 110 can dynamically update the arrangement of information, contents, graphics, or other elements provided via the interface in response to various conditions or received data. The client device 110 can include various artificial intelligence functionalities or interface with an artificial intelligence model (e.g., a large language model or LLM, neural network, etc.).

In some examples, the client device 110 can display an interface (e.g., GUI). The interface can present a stage-based workflow view corresponding to a plurality of onboarding or migration stages executed by the computing system 120. For example, the interface can display a tracker indicating completed stages, active stages, pending stages, or exception states associated with execution of one or more agents during migration of the client data onto the platform 175. In some aspects, the interface can further output one or more interactive controls, panels, windows, or pop-up elements configured to receive user input associated with one or more stages of the migration workflow. For example, the client device 110 can display user-selectable controls for reviewing mappings, configuring translations, specifying filtering instructions, selecting a target environment, confirming validation outcomes, or advancing a current stage of the onboarding process.

The knowledge base 115 can include or refer to any data source, repository, or information management system configured to store, retrieve, or provide structured or unstructured information used by the computing system 120. For example, the knowledge base 115 can include internal sources (e.g., organizational documentation, metadata records, templates, or configuration data associated with previous onboarding sessions) and external sources (e.g., third-party APIs, industry repositories, public datasets, or reference material). The computing system 120 can access data or information stored in the knowledge base 115 using references, identifiers, fields, descriptors, similarity scores, or vectors. For example, one or more agents of the computing system 120 (e.g., analysis agent 125, validation agent 150) can query the knowledge base 115 to retrieve field mapping definitions, rule sets, or validation logic applicable to a given metadata state. In some aspects, the knowledge base 115 can include one or more indexing systems configured to support structured retrieval, including a vector-based search index, an ontology defining relationships between schema elements, or a graph-based structure mapping associations between transformation rules, onboarding workflows, and policy definitions. The computing system 120 can use the knowledge base 115 to supplement or update classification, mapping, transformation, or validation functions during execution of the onboarding process. For example, the analysis agent 125 can retrieve previously used mappings, profiles, templates, classifications, or labels from the knowledge base 115, and the validation agent 150 can retrieve constraints, definitions, or rules used to assess transformed data prior to storing the data in the platform 175.

In some examples, the knowledge base 115 can organize or index information based on one or more conversion stages, source-system identifiers, vendor identifiers, service platform identifiers, execution contexts, or metadata versions. For example, the computing system 120 can query the knowledge base 115 using a current conversion stage or source-system type to retrieve one or more entries that modify (e.g., adjust, configure, supplement, etc.) execution of one or more agent functions during migration of the client data. In some examples, the knowledge base 115 can store entries related to product-specific onboarding instructions, context-specific mappings, translation rules, filtering templates, or workflow definitions associated with different service platforms or prior onboarding sessions. The computing system 120 can access the stored entries to adapt or otherwise configuration migration logic used by agents for a selected product, source system, language context, operating region, or validation stage. For example, the computing system 120 can access entries used to directly control execution of one or more agent operations (e.g., by applying predefined parameters, instructions, rules, templates, mappings, routing directives, or other structured guidance, etc.), or can access entries used as contextual information provided to one or more agents or artificial intelligence models (e.g., as prompts, retrieved references, examples, workflow history, domain guidance, or other supplemental input, etc.) for use in performing operations for migration of the client data.

The computing system 120 can include any of one or more systems, devices, components, or elements configured to coordinate between one or more agents to facilitate rapid client implementation (e.g., onboarding onto the platform 175). For example, the computing system 120 can include a laptop, desktop computer, smart phone, tablet, server, database, etc., or can include a collection of such devices. The computing system 120 can include a communications unit configured to facilitate communications, or otherwise interface with, one or more components of the computing system 120 or the system 100. For example, the computing system 120 can receive data (e.g., client or customer data) from client device 110 and provide data (e.g., a prompt or response) to the client device 110 for onboarding or migration. The computing system 120 can correspond with an organization or can be used to perform or execute various processes associated with an organization.

In some aspects, the computing system 120 can execute an onboarding workflow for rapid client implementation in accordance with one of a plurality of metadata configurations associated with different service platforms or products. For example, the computing system 120 can select a configuration corresponding to a data platform, a balance platform, a benefits platform, a time platform, or another platform, and can coordinate the plurality of agents to migrate the client data in accordance with the selected configuration. In some aspects, the computing system 120 can further coordinate multiple migration runs in parallel for client data received from a plurality of source systems or for a plurality of execution contexts associated with the client data. For example, the computing system 120 can initiate separate agent workflows for different vendors, operating regions, jurisdictions, languages, or client-specific contexts while maintaining alignment with corresponding metadata states.

The computing system 120 can coordinate operations that are executed or performed by one or more AI-based agents (e.g., analysis agent 125, extraction agent 130, etc.) based on a metadata state referenced during one or more stages of client implementation or onboarding. The computing system 120 can coordinate or initiate a processing flow in which an agent executes a respective function and transmits a message referencing a current metadata state to a plurality of additional agents, an additional agent from the plurality of agents executes a respective function and transmits another message referencing a current metadata state to a plurality of additional agents, and the processing flow iteratively repeats. For example, the analysis agent 125 can transmit a message referencing a metadata state to one or more of the extraction agent 130, mapping agent 135, transformation agent 140, translation agent 145, or validation agent 150. In some aspects, the extraction agent 130 can be selected to execute a respective function based on the first message, based on the referenced metadata state, or other data included or referenced by the message. Further, the extraction agent 130 can transmit a second message referencing the metadata state to one or more of the analysis agent 125, mapping agent 135, transformation agent 140, translation agent 145, or validation agent 150. The computing system 120 can iteratively identify or provide a metadata state of the platform 175 to define schemas, mappings, transformation rules, or validation constraints used to guide the operation of each selected agent, as further described herein. The computing system 120 can use one or more of the MoE system 160, the state machine controller 165, or the metadata processing system 170 to coordinate operations that are executed or performed by the one or more AI-based agents.

The computing system 120 can include a state machine controller 165 configured to select and activate an additional agent based on outputs from another agent and a corresponding reference to a metadata state of the platform 175 included in a message. For example, the state machine controller 165 can include or refer to a system or a set of instructions configured to track a current process state (e.g., onboarding stage, agent execution stage, etc.) and determine a subsequent agent to activate based on outputs from a prior agent and a referenced metadata state. The state machine controller 165 can coordinate between agents of the computing system 120 (e.g., analysis agent 125, extraction agent 130, mapping agent 135, transformation agent 140, translation agent 145, validation agent 150) by identifying a metadata state or context that reflects the progress of client onboarding or data migration. For example, the state machine controller 165 can record metadata identifiers, states, outputs, statuses, and other data associated with a particular onboarding session or client workflow.

The state machine controller 165 can select an agent for execution. The state machine controller 165 can make the selection based on one or more factors, including, for example, output that was previously generated by the agent, the metadata state referenced in the triggering message, or one or more rules or selection heuristics (e.g., conditional rules, dependencies, agent readiness metrics, transformation sequences, etc.). In some examples, the state machine controller 165 can detect failure conditions based on outputs provided by one or more agents or timing constraints (e.g., a missing validation report, unresponsive agent status, or unexpected schema divergence), and can trigger predefined failover routines or recovery flows. For example, the state machine controller 165 can reinitiate execution of an agent with updated parameters, select an alternate agent from a secondary list, or pause further operations and generate a diagnostic alert. The state machine controller 165 can provide status information corresponding to a present state of client onboarding. For example, the state machine controller 165 can generate a progress log, visualization, or message stream based on state machine variables, outputs provided by one or more agents, or metadata. In some aspects, the state machine controller can interface with external dashboards or audit systems to present or provide compliance data associated with client onboarding.

In some aspects, messages transmitted between agents can include structured message payloads configured to coordinate execution of the respective functions of the plurality of agents. A message can include, for example, a reference to the current state of metadata, a reference to client data stored in a shared data repository, an identifier of a migration stage or execution context, and one or more outputs, confidence indicators, or status flags generated by an upstream agent. The state machine controller 165 can use information included in the message payload, together with the referenced state of metadata, to determine whether execution of a respective function of a downstream agent is permitted, deferred, repeated, or routed to an alternate agent. In this manner, the computing system can synchronize execution of autonomous metadata‑driven processes across agents based on a shared metadata state, rather than allowing agents to operate independently based on local assumptions.

In some aspects, the state machine controller 165 can determine whether to branch the onboarding workflow into additional stages, such as filtering stage (e.g., prior to execution of a mapping function). For example, responsive to a request indicating that one or more records are to be excluded, retained, or segmented, the state machine controller 165 can transition the onboarding session to a filtering stage and, upon completion of the filtering stage, resume the onboarding workflow at the mapping stage. In some examples, the state machine controller 165 can manage multiple concurrent workflow instances associated with different source systems, execution contexts, or service platform configurations. The state machine controller 165 can track a respective state, metadata context, and execution status for each workflow instance and can coordinate parallel or asynchronous execution of one or more agents across the workflow instances. In some aspects, the state machine controller 165 can provide workflow-state data for presentation via a user interface of the client device 110, such as a stage tracker, progress indicator, or notification associated with the migration workflow. For example, the state machine controller 165 can output stage identifiers, completion states, review states, or pending actions for display by the client device 110.

The computing system 120 can include a metadata processing system 170 configured to manage or update metadata states during onboarding. For example, the metadata processing system 170 can generate and maintain a hierarchical metadata structure (e.g., metadata hierarchy) that includes schema fields, transformation logic, validation rules, or version indicators associated with data stored in the platform 175. In some aspects, the metadata processing system 170 can store or provide metadata states for use by one or more agents (e.g., mapping agent 135, transformation agent 140, or validation agent 150) when executing respective functions. The metadata processing system 170 can facilitate versioning, inheritance, or propagation of metadata states across one or more agents during one or more onboarding sessions. In some aspects, the metadata processing system 170 can update a current metadata state during processing (e.g., onboarding or migration) and provide the updated metadata state to the state machine controller or to one or more agents executing downstream functions.

In some aspects, the metadata processing system 170 can maintain multiple metadata configurations associated with different service platforms, products, jurisdictions, operating regions, or execution contexts. For example, the metadata processing system 170 can initialize or update a context-specific metadata state for a selected service platform or for a subset of the client data associated with a particular execution context (e.g., source system, country or jurisdiction, language, etc.). In some examples, the metadata processing system 170 can associate a metadata state with one or more authorization parameters, such that access to data, intermediate outputs, or migration results is restricted based on a context-specific authorization scope. The metadata processing system 170 can provide the authorization parameters or metadata state to one or more systems or components (e.g., agents) during execution of the onboarding workflow.

The MoE system 160 can include or refer to a plurality of AI-based agents (e.g., analysis agent 125, extraction agent 130, mapping agent 135, transformation agent 140, translation agent 145, validation agent 150, and integrity check agent 155). In some examples, the MoE system 160 can be configured to coordinate agent selection and routing based on metadata states or context. For example, the MoE system 160 can receive a message referencing a metadata state and select a subsequent agent to execute a respective function based on agent specialization (e.g., an agent type) or prior execution performance (e.g., accuracy, speed, etc.). For example, the MoE system 160 can select among the included agents (e.g., analysis agent 125, extraction agent 130, mapping agent 135, transformation agent 140, translation agent 145, validation agent 150, etc.) based on metadata states or additional data (e.g., performance metrics). In some aspects, the MoE system 160 can resolve conflicts between multiple candidate agents or outputs by applying rule sets or thresholds defined in the metadata state. The MoE system 160 can update a routing strategy, selection record, or agent score based on the outcome of a selected function. In some aspects, the MoE system 160 can select or route one or more agents based on a selected service platform configuration, a source-system identifier, a conversion stage, or an execution context associated with the client data. For example, the MoE system 160 can route a first subset of client data to a first workflow instance associated with a first context and route a second subset of client data to a second workflow instance associated with a second context, while using different metadata states or rule sets for the respective workflow instances.

In some aspects, at least one (e.g., each) of the analysis agent 125, extraction agent 130, mapping agent 135, transformation agent 140, translation agent 145, validation agent 150, integrity check agent 155 can include or be configured to interface with at least one artificial intelligence (AI) model 180. For example, the AI model 180 can include any machine learning (ML) or intelligence model that generates content or new content, such as text, images, or code, by learning patterns and structures from existing data. For example, the AI model 180 can include a model, a computational system, or an algorithm that can learn patterns from data (e.g., chunks of data from various input documents, computer code, templates, forms, etc.) and make predictions or perform tasks without being explicitly programmed to perform such tasks. In some aspects, the AI model 180 can refer to or include an ML model that has been trained using machine learning to perform a task, such as classification, regression, or clustering. Examples of ML training techniques can include, for example, decision trees, neural networks, or support vector machines. In some aspects, the AI model 180 can refer to or include a large language model (LLM), a neural network, or any type of artificial intelligence. A large language model (LLM) can include or refer to a neural network-based model with a parameter count (e.g., number of adjustable weights) substantially equivalent to or exceeding one hundred billion parameters and trained on vast and heterogeneous datasets (e.g., collections of text from books, articles, web pages, etc.) to perform a range of tasks, including text generation, contextual question answering, and language analysis across diverse domains. The AI model 180 can include or refer to small or medium-sized models (e.g., models with less than one hundred billion parameters and/or trained for delimited tasks) or collections of such models. For example, the AI model 180 can include or refer to a collection or suite of rule-based systems and machine learning models used to perform domain-based tasks, including natural language processing, document analysis, or enterprise data interpretation.

In some examples, the AI model 180 can include, refer to, or otherwise utilize or access a retrieval-augmented generation (RAG) system. For example, the AI model 180 can include or be constructed based on a transformer architecture with one or more of self-attention mechanisms (e.g., model used to weigh the importance of different words or tokens in a sentence when encoding a word at a particular position), positional encoding, or encoder and decoder layers (e.g., multiple layers including multi-head self-attention mechanisms and feedforward neural networks). Transformer architecture can include, for example, a generative pre-trained transformer, a bidirectional encoder representations from transformers (BERT), a transformer-XL (e.g., using recurrence to capture longer-term dependencies beyond a fixed-length context window), a text-to-text transfer transformer, etc. The AI model 180 can be trained using a dataset of documents (e.g., web pages or content, text, images, videos, audio, or other data) and can be designed to understand and extract relevant information from the dataset. The AI model 180 can be trained (e.g., by a model training function) using any text-based dataset by converting the text data from the input dataset documents into numerical representations (e.g., embeddings) of the chunks of the documents. In some aspects, the artificial intelligence model can be generated or built using deep learning techniques, such as neural networks. Through training, the AI model 180 can adjust various internal parameters, such as relationships between embeddings or numerical values learned during training, to improve performance and improve the accuracy of outputs or predictions. In some aspects, adjusting internal parameters can include iteratively presenting embeddings of dataset chunks to the AI model 180, comparing outputs of the AI model 180 to verified or known results, and updating parameters (e.g., modifying weight matrices, recalibrating biases, or fine-tuning activation thresholds of the AI model 180) based on results of the comparison. By iteratively learning from the dataset embeddings, the AI model 180 can generalize knowledge and generate accurate outputs or insights when processing client data (e.g., for onboarding or migration onto platform 175).

In some aspects, each agent of the MoE system 160 (e.g., analysis agent 125, extraction agent 130, mapping agent 135, transformation agent 140, translation agent 145, validation agent 150, and integrity check agent 155) can include or refer to a software-executed processing instance configured to execute or perform one or more defined functions during client onboarding based on metadata states, intermediate outputs, or agent coordination logic. For example, each agent can be instantiated by or operate under the control of the computing system 120 to execute one or more functions on client data in a modular, stateless, or session-specific manner. For example, each AI-based agent can process data by issuing one or more requests to an artificial intelligence model or by executing predefined instructions stored in memory. In some arrangements, each agent can receive a message, execute a respective function based on referenced metadata and a current onboarding context, and transmit a subsequent message to one or more additional agents for continued processing. Each agent can operate independently, in parallel, or in sequence, and can be selected dynamically (e.g., using state machine controller 165, a routing system, etc.) based on metadata conditions, outputs provided by one or more agents, or task requirements.

In some arrangements, one or more agents of the computing system 120 can interface with one or more artificial intelligence models (e.g., AI model 180, large language models, other inference systems, etc.) to execute a respective function. For example, the analysis agent 125 can query AI model 180 with a structured payload representing a portion of employment data provided by a client (e.g., job titles, department names, compensation levels, etc.) and receive a structured summary from the AI model 180 indicating one or more candidate field types, detected anomalies, or suggested field groupings identified from the provided employment data. The extraction agent 130 can call or prompt AI model 180 to interpret semi-structured or unstructured employment data (e.g., resumes, HR exports, or job description tables) and identify location ranges, role identifiers, or formatting patterns within the data. The mapping agent 135 can issue a prompt to AI model 180 referencing target schema fields of the platform 175 and receive candidate mappings ranked or scored by the AI model 180 using embeddings or similarity scores. The transformation agent 140 can use AI model 180 to determine formatting or normalization routines for employment data (e.g., converting “Software Engineer II” to a normalized job code or harmonizing pay period formats across datasets). The translation agent 145 can transmit a structured prompt to AI model 180 including a value detected during onboarding (e.g., “Remote Eligible,” “PTO Tier 3”) and receive a ranked list of candidate substitutions or schema-aligned labels (e.g., “Remote Status,” “Leave Policy Level”) based on a translation configuration, dictionary object, or field metadata provided to or referenced by the AI model 180. The validation agent 150 can construct an input based on provided employment data and transmit the input to AI model 180, cause the AI model 180 to compare one or more values of the employment data to expected fields, threshold values, or conditional rules defined in the metadata state, and can further receive an output from the AI model 180 indicating whether the provided inputs satisfy (e.g., conform with) the defined constraints or including one or more discrepancies to be flagged for review. In some implementations, the one or more agents can prompt or query the AI model 180 using structured prompts with input data (e.g., schemas, references, classification tags, metadata states) and receive outputs (e.g., text, JSON objects, etc.) from the AI model 180 in response to the prompt or query. The agents or computing system 120 can process the outputs provided by the AI model 180 to validate, update, or annotate client data. The client data can include employment records, payroll entries, department hierarchies, benefits elections, work location assignments, compensation bands, leave history, job classifications, or position descriptions. At least one artificial intelligence model used by one or more of the agents (e.g., AI model 180) can interface with the knowledge base 115 (e.g., identifying field definitions, policy rules, or domain mappings) to generate outputs used during onboarding of client data.

The analysis agent 125 can perform exploratory data analysis (EDA) on incoming client data to generate data (e.g., insights) that support subsequent agent functions. For example, the analysis agent 125 can automatically profile received data to identify structural characteristics, field types, statistical distributions, or other metrics. In some examples, the analysis agent 125 can determine data dependencies or relationships among fields in input data (e.g., foreign key associations, nested hierarchies, or temporal linkages), which can be stored or used to generate or update the metadata state or for other purposes (e.g., to generate mapping templates). The analysis agent 125 can generate summaries or statistics (e.g., frequency counts, averages, standard deviations, etc.) or detect anomalies, outliers, or missing data patterns within a client dataset provided for onboarding onto the platform 175. The analysis agent 125 can facilitate an onboarding flow by transmitting a message that references an initial metadata state and includes a reference or pointer to additional data (e.g., client data or other data or characteristics used to select subsequent agents).

The extraction agent 130 can process client data received from the client device 110 or from another upstream agent (e.g., via a reference included in a message) and extract structured or semi-structured data from the processed client data. For example, the extraction agent 130 can parse client-provided files, customer logs, database logs, API responses, or other input data using an extraction function. In some examples, the extraction agent 130 can parse or analyze client data to identify and extract data elements such as terms, phrases, delimiters, fields, or headers from client data having various data types or formats (e.g., XML, JSON, CSV, etc.). The extraction agent 130 can process and extract at least a portion of client data included in structured datasets (e.g., columnar files), semi-structured datasets (e.g., partially or loosely formatted spreadsheets), or unstructured datasets (e.g., free-form text or multimedia) and can provide standardized data outputs based on the extracted data and the metadata state of the platform 175. In some aspects, the extraction agent 130 can generate or maintain extraction audit logs, including histories, techniques, or versions corresponding with extracted data. The computing system 120 can use the audit logs to verify extraction is successful, detect extraction errors, or support rollback operations in response to a detection of an error or inconsistency.

The mapping agent 135 can generate and evaluate mappings between the structure of client data and a reference schema of the platform 175 defined by the metadata state. For example, the mapping agent 135 can access a field guide or domain-specific mapping knowledge base (e.g., knowledge base 115) to retrieve mapping patterns or previously used mapping strategies, or can generate candidate mappings dynamically in response to the receipt of client data. In some aspects, the mapping agent 135 can generate schema mappings using algorithms that identify correspondences between fields or values of client data being onboarded with fields or values of client data previously onboarded onto the platform 175 (e.g., based on naming conventions, data types, statistical distributions, relational context, etc.). The mapping agent 135 can calculate confidence scores for proposed mappings based on metadata context, rule alignment, or historical mappings. The computing system 120 can store the generated mappings and scores in association with the current metadata state and provide the stored data to one or more additional agents (e.g., transformation agent 140) via a subsequent message.

The transformation agent 140 can perform one or more data transformations on the client data based on metadata rules, schema mappings, or natural language instructions. For example, the transformation agent 140 can apply predefined transformation logic (e.g., data type conversion, format normalization, field mapping, or restructuring) based on the output of the mapping agent 135 (e.g., by selecting a proposed mapping based on a ranking or comparison of confidence scores). In some examples, the transformation agent 140 can parse instructions (e.g., transformation instructions received as configuration metadata or natural language statements), use the instructions to update or modify execution (e.g., performance) of a respective function, and execute the respective function based on the instructions. For example, the transformation agent 140 can perform transformations based on one or more mappings or transformation instructions, including generating nested structures, splitting or merging fields, applying unit normalization logic, or performing restructuring operations. In some aspects, the computing system 120 can store a transformation history associated with the current onboarding session or client profile and retrieve the history to facilitate rollback, auditing, or iterative refinement.

The translation agent 145 can execute translation operations during client data onboarding based on the metadata state. In some examples, the translation agent 145 can apply field-level translations based on field guides, rule sets, or foundation tables. For example, the translation agent 145 can retrieve a translation rule from the metadata state corresponding to a target field identifier and apply a value substitution, field-level terminology adjustment, or normalization rule to the client data based on the retrieved translation rule. In some arrangements, the translation agent 145 can access various guides, lookup tables, or domain-specific repositories stored in the knowledge base 115 to determine one or more translation operations aligned with the metadata state of the platform 175. In some examples, the translation agent 145 can apply format-specific translations, such as converting localized values (e.g., regional date or number formats) or replacing abbreviations or shorthand identifiers with standardized values. In some aspects, the translation agent 145 can evaluate one or more context parameters (e.g., applied transformation rules or detected classifications) to select among translation candidates associated with the metadata state. The translation agent 145 can apply translation logic based on upstream outputs or conditional metadata constraints. The computing system 120 can record translation outcomes, applied substitution rules, or derived values to support traceability, consistency, or reuse across subsequent stages of onboarding. In some aspects, the translation agent 145 can translate one or more field values, labels, rules, or other parameters of the client data from a first context to a second context selected for migration onto the platform 175. For example, the first context can correspond to a first language, locale, jurisdiction, operating region, or source-system convention, and the second context can correspond to a target language, locale, jurisdiction, operating region, or platform-specific convention defined by the metadata state. In some examples, the translation agent 145 can execute the translation operation subsequent to a mapping stage and before a transformation stage, such that mapped fields are converted into context-appropriate values or labels prior to application of downstream transformation logic or validation rules.

The validation agent 150 can apply validation operations based on a current metadata state (e.g., multi-level validation operations) to determine whether outputs provided by one or more agents or client data conform with the state of metadata. For example, the validation agent 150 can execute rule-based checks to determine whether client data satisfies or conforms with one or more rules (e.g., schema alignment rules, formatting constraints, field completeness rules, or logical consistency rules) by referencing the metadata state or hierarchy. In some examples, the validation agent 150 can perform error correction by comparing or modeling outputs provided by one or more agents to predefined or known outputs. The validation agent 150 can be configured to flag discrepancies between expected and actual outputs and execute one or more additional operations (e.g., output a validation result, prompt a review, apply a correction, etc.). For example, the validation agent 150 can generate structured validation outputs, such as field-level validation results, summary reports, or compliance flags, which can be included in messages transmitted to downstream agents or to the state machine controller. In some aspects, the validation agent 150 can maintain a correction audit log referencing the original data entry, the applied correction, and the triggering rule or validation context. For example, the computing system 120 can associate the correction log with the metadata state and a client identifier for downstream reporting or integration into compliance systems. In some aspects, the validation agent 150 can analyze or validate outputs of each agent in response to execution of respective operations of each agent.

The integrity check agent 155 can apply correction logic based on the metadata state and one or more validation outcomes, correction rules, or policies. In some examples, the integrity check agent 155 can perform automatic error correction for detected issues by applying default values, inferred completions, or lookup-based replacements within fields of the client data provided for onboarding. For example, if the validation agent 150 detects a missing field value in the client data, the integrity check agent 155 can resolve the field using a metadata-defined fallback rule or domain-based logic retrieved from the knowledge base 115. In some aspects, the integrity check agent 155 can maintain a correction audit trail referencing the original data, the correction applied, and the associated rule or reasoning, and the integrity check agent 155 can store or provide the audit trail for subsequent validations or compliance verifications.

The platform 175 can include any combination of hardware or software for storing, managing, or updating client data. In some aspects, information in the platform 175 is stored using any type of memory, such as a cloud or hard drive. The platform 175 includes, for example, random access memory (RAM), dynamic random access memory (DRAM), static random access memory (SRAM), error-correcting code (ECC), read only memory (ROM), programmable read only memory (PROM), or electrically erasable read only memory (EEPROM). The information or data structures (e.g., client data, scanned documents, digital content, records, tables, lists, or spreadsheets, etc.) included within the platform 175 can be dynamic and change periodically (e.g., daily or by milliseconds), via an input from a user (e.g., updated or additional client data), via inputs from various components of the system 100 (e.g., computing system 120) and sub-systems of the computing system 120 (e.g., analysis agent 125, extraction agent 130, etc.), or via an external update to the system 100.

The platform 175 can include a metadata-based storage and integration system configured to manage structured or onboarded client data in accordance with a present metadata state of the onboarded data. In some aspects, the metadata state defines schema structures, mapping configurations, transformation logic, or validation rules that apply during onboarding or data migration. The platform 175 can store structured data in alignment with the current metadata state and can dynamically update the metadata state in response to changes in stored data or incoming client data. For example, if a first client and a second client provide datasets that include fields such as “Employee Name,” “Job Title,” and “Department ID,” the metadata state can reflect the included fields and associated formatting or validation parameters. If a third client submits data with a new field, such as “Employment Classification,” or uses an alternate field name, such as "DeptCode" (as a variant for "Department ID"), the computing system 120 can detect a divergence and update the metadata state to incorporate the additional field or normalize the alternate field name (e.g., into “Department”). The computing system 120 (e.g., using agents) can reference the updated metadata state to apply schema mappings or transformation functions to the client data prior to storage of the client data in the platform 175. In some examples, the platform 175 can maintain versioned metadata states corresponding to individual onboarding sessions or client profiles (e.g., a metadata state associated with the platform at a first time period, first interval, or first onboarding, a metadata state associated with the platform at a second time period, second interval, or second onboarding, etc.). The updated metadata state can be propagated via messages through the system 100 to prompt or guide one or more agents in mapping, transforming, or validating data based on the metadata state (e.g., schema definition) of the platform 175.

In some aspects, the platform 175 can support a plurality of metadata configurations corresponding to different service platforms, products, operating regions, or client deployment contexts. For example, the computing system 120 can select a metadata configuration for a particular product implementation (e.g., a time product, a benefits product, etc.) and generate the structured query in accordance with the selected metadata configuration. In some examples, the platform 175 can store migrated data according to context-specific metadata states associated with different source systems, jurisdictions, countries, or organizational scopes. The computing system 120 can update the metadata states independently for the respective contexts based on results generated during parallel or staged execution of the onboarding workflow.

In some aspects, the computing system 120 can transmit, using a first agent of a plurality of agents each configured to execute a respective function to migrate client data onto a metadata-based platform, a first message including a reference to a state of metadata of the metadata-based platform. For example, the metadata state can include a present configuration of the platform 175 (e.g., including or referencing schema definitions, validation rules, transformation parameters, or field mappings of the platform 175) prior to integration of additional client data, and the metadata state can be updated as additional client data is migrated onto the platform 175. The first agent can generate a first message including the metadata state (e.g., via a reference, identifier, or pointer) and further including a reference, pointer, or an identifier corresponding to a set of client data staged for onboarding (e.g., at an external storage location or interface). In some examples, in response to the analysis agent 125 performing or executing respective functions (e.g., data profiling, classification, or entity recognition operations) on the client data, the analysis agent 125 can transmit the first message to one or more (e.g., each) of extraction agent 130, mapping agent 135, transformation agent 140, translation agent 145, validation agent 150, or integrity check agent 155 for further processing.

In some aspects, the computing system 120 can select, using the plurality of agents, based on the first message, a second agent of the plurality of agents to execute a respective function of the second agent, the respective function of the second agent different from a respective function of the first agent. For example, the extraction agent 130 can be selected in response to receiving the first message transmitted by the analysis agent 125. The computing system 120 can use a state machine controller or mixture-of-experts (MoE) system to evaluate the metadata state and the agent output from the analysis agent 125 in determining a subsequent applicable agent. In some examples, the metadata state referenced in the first message can identify schema targets or configuration rules indicating that the client data is to be parsed or normalized prior to further processing. Based on this evaluation, the computing system 120 can select the extraction agent 130 to execute a respective function. For example, the extraction agent 130 can execute functions to retrieve the client data (e.g., via a reference, such as a pointer or identifier of the client data included in the first message) and execute operations of the extraction agent 130 on the retrieved client data, such as text parsing, table extraction, or pattern-based field identification. In some examples, the extraction agent 130 can use metadata-defined logic or field descriptions stored in the knowledge base 115 to guide the parsing or segmentation process. The respective function of the extraction agent 130 can generate intermediate output (e.g., extracted field-value pairs or tabular segments) associated with the referenced metadata state, for use in subsequent mapping, transformation, or validation stages. The computing system 120 can update an internal status record or processing context (e.g., state variables, routing table, or agent log) to reflect completion of the function of the extraction agent 130 and transition to a subsequent stage of onboarding.

In some aspects, the computing system 120 can transmit, using the second agent, to the plurality of agents, a second message including the reference to the state of metadata, the second message is generated based on execution of the respective function of the second agent. For example, the extraction agent 130 can generate the second message after completing extraction operations on the client data identified in the first message. The second message can include a reference to the metadata state previously identified by the analysis agent 125 (e.g., a pointer, identifier, etc.), and can further include a reference (e.g., pointer or identifier) to the extracted data segments produced by the extraction agent 130. The second message can be transmitted to one or more agents (e.g., analysis agent 125, mapping agent 135, transformation agent 140, validation agent 150, etc.) for continued onboarding operations based on the referenced metadata state and outputs provided by one or more agents.

In some aspects, the computing system 120 can select, using the plurality of agents, based on the second message, one or more additional agents of the plurality of agents to execute respective functions of the one or more additional agents, the respective function of the one or more additional agents different from the respective function of the first agent and the respective function of the second agent. For example, in response to receiving the second message transmitted by the extraction agent 130, the computing system 120 can select the mapping agent 135 to associate the extracted data fields with target schema fields defined in the metadata state. In some aspects, the mapping agent 135 can access metadata rules or schema alignment logic from the knowledge base 115 to generate a mapping between source and destination field identifiers. After completion of the mapping function, the computing system 120 can use the state machine controller to evaluate the updated metadata reference and outputs provided by one or more agents to select the transformation agent 140. In this example, the transformation agent 140 can apply normalization logic, field conversions, unit harmonization, or structural formatting operations based on transformation parameters defined in the metadata state. In some examples, the computing system 120 can further select the translation agent 145 to process transformed values using domain-specific translation models, dictionaries, or formatting adjustments (e.g., localization, encoding, or abbreviation expansion). Based on the updated metadata reference, the computing system 120 can then select the validation agent 150 to verify whether the transformed and translated data complies with schema constraints, field parameters or attributes, or integrity checks defined in the metadata state or retrieved from the knowledge base 115. In some aspects, the computing system 120 can use the validation agent 150 at multiple stages to validate intermediate outputs of prior agents before proceeding to subsequent processing (e.g., validate extracted fields before mapping, mapped fields before transformation, etc.). Additionally, the integrity check agent 155 can verify whether the transformed and translated data complies or conforms with schema constraints, field parameters, or data integrity standards.

In some aspects, the computing system 120 can generate, based on an output of executing the respective functions of the one or more additional agents, a structured query configured to migrate at least a portion of the client data onto the metadata-based platform. A structured query can include or refer to any data structure, instruction set, or machine-readable representation used to write, insert, or merge at least a portion (e.g., part) of the client data into a target schema associated with the metadata-based platform 175. For example, a structured query can include a structured query language (SQL) statement, an API request body, a data definition or manipulation command, or any serialized representation of field-value pairs aligned with the metadata state. In some aspects, the structured query can reflect schema-aligned representations of the client data, including field names, types, values, and relationships defined in the metadata state.

The computing system 120 can generate the structured query using field mappings, transformation outputs, and translation adjustments produced by the mapping agent 135, transformation agent 140, and translation agent 145. In some examples, the validation agent 150 or the integrity check agent 155 can verify the structured query for compliance with constraints, field parameters, or cross-record consistency defined in the metadata state. Upon successful verification, the computing system 120 can transmit or apply the structured query to migrate the client data to the platform 175 in accordance with a target schema (based on the schema definitions of the metadata-based platform 175).

In some aspects, generating the structured query can include constructing an intermediate, schema-aligned representation of at least a portion of the client data based on outputs of execution of the respective functions of the plurality of agents and the state of metadata. The computing system 120 can validate the intermediate representation against one or more definitions, constraints, schemas, or transformations specified by the state of metadata prior to generating a final executable form of the structured query. The final structured query can include, for example, a database insertion or merge statement, an application programming interface request payload, or another executable instruction configured to migrate the client data onto the metadata-based platform. By validating the structured query against the state of metadata prior to execution, the computing system 120 can prevent inconsistent data transformations, reduce redundant processing, and avoid execution retries that would otherwise occur when schema or constraint mismatches are detected after submission to the metadata-based platform.

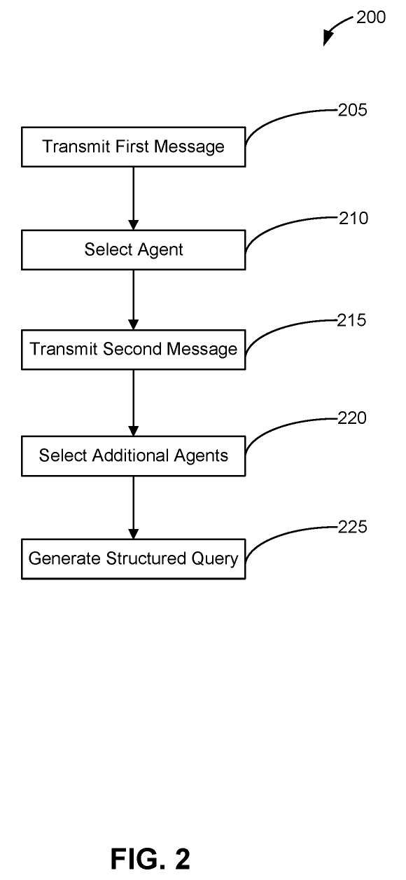

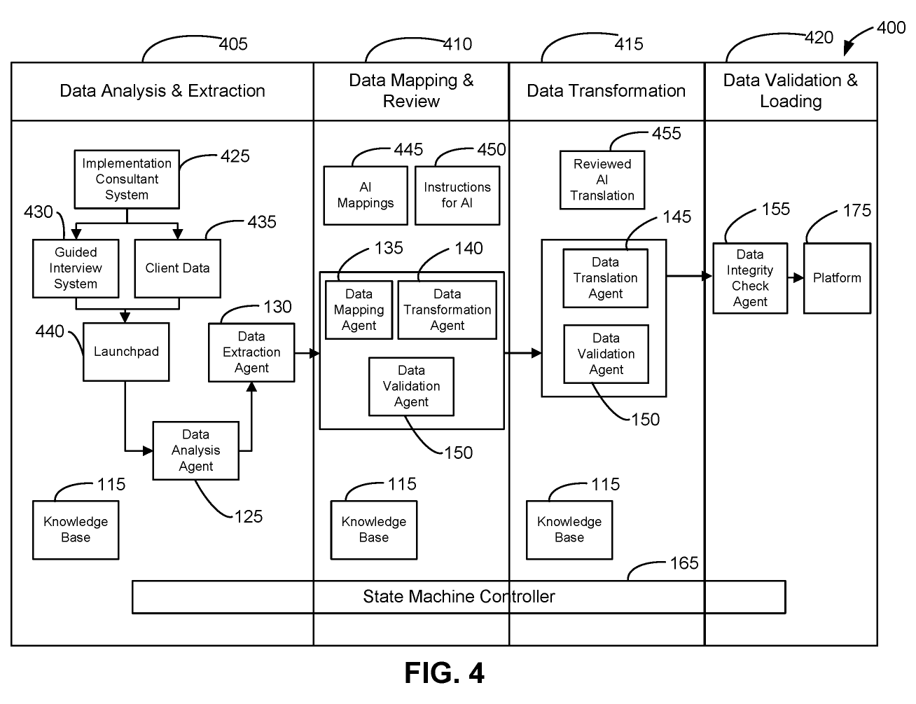

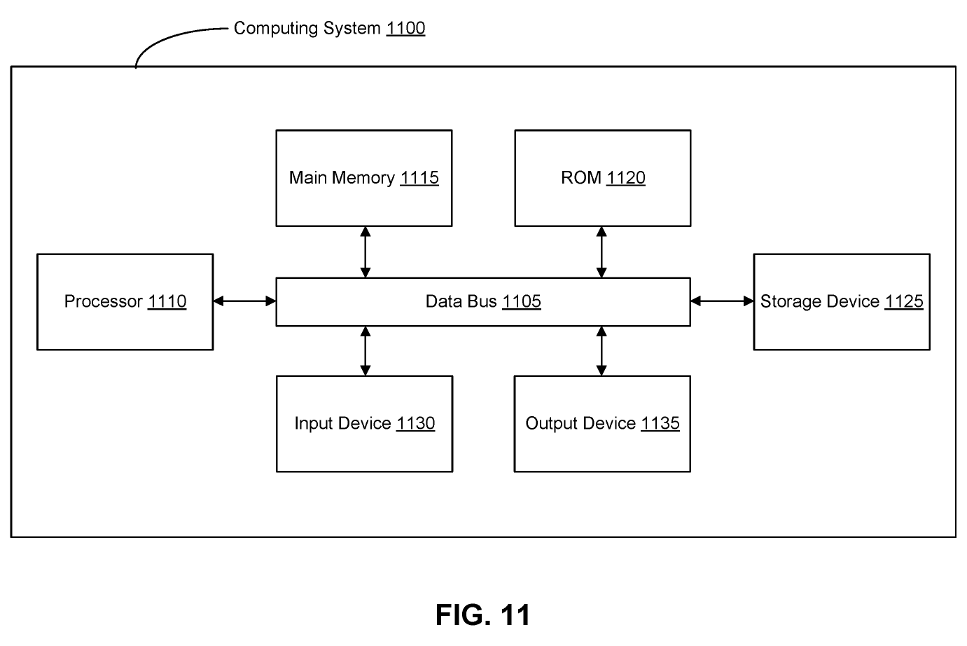

FIG. 2 is an illustrative example of a computer-implemented method for rapid data migration between computing systems using autonomous metadata-driven processes. Method 200 can be implemented using various systems, devices, or components discussed herein (e.g., one or more processors, one or more agents, system 100 or computing system 120 of FIG. 1, system 400 of FIG. 4, system 1100 of FIG. 11, etc.). Method 200 can include one or more of operations 205-225. For example, operation 205 can include the computing system transmitting a first message. Operation 210 can include the computing system selecting an agent. Operation 215 can include the computing system transmitting a second message. Operation 220 can include the computing system selecting additional agents. Operation 225 can include the computing system generating a structured query. Operations 205-225 can be removed, reordered, adjusted, bypassed, repeated, omitted, or otherwise modified in various aspects. In some aspects, one or more of operations of the method 200 can be incorporated into other methods discussed herein.

In some aspects, one or more operations of the method 200 (or other methods discussed herein) can be performed in accordance with a selected product or service-platform configuration, repeated (e.g., in parallel) for a plurality of source systems or execution contexts, or supplemented with additional operations. In some aspects, one or more operations of the method 200 (or other methods discussed herein) can be performed responsive to a user interaction received via a graphical user interface or another input, command, or selection (e.g., API call).

The method 200 can include the computing system transmitting a first message at operation 205. For example, operation 205 can include transmitting, by one or more processors, coupled with memory, using a first agent of a plurality of agents each configured to execute a respective function to migrate client data onto a metadata-based platform, a first message. The first message can include or refer to a structured data object or communication payload configured to coordinate execution of agent functions and reference a metadata state defining schema logic, transformation parameters, validation constraints, or field mappings associated with the metadata-based platform. For example, generating the first message can include the computing system 120 (e.g., via the analysis agent 125) sending, transmitting, propagating, or otherwise outputting a machine-readable message including a reference to a metadata state and an identifier of client data staged for onboarding. In some aspects, the first message can include a reference to a state of metadata of the metadata-based platform. In some examples, the first message can include a pointer or uniform resource identifier (URI) (e.g., reference) corresponding to the location of the client data (e.g., cloud storage bucket, staging API endpoint, or external database interface) and metadata versioning information that links the message to a current schema configuration of the platform 175. In some examples, the one or more processors can transmit the first message to one or more additional agents. Additionally, in some aspects, the one or more processors can generate the first message after executing an analysis operation on the client data (e.g., profiling or classification). In some examples, the first message can include flags or routing data used by the state machine controller or mixture-of-experts system to control downstream agent selection.

The method 200 can include the computing system selecting an agent at operation 210. For example, operation 210 can include selecting, by the one or more processors, using the plurality of agents, based on the first message, a second agent of the plurality of agents to execute a respective function of the second agent. The second agent can be selected by evaluating one or more elements of the first message, such as the referenced metadata state, control flags, or results from a prior agent’s function. For example, in response to receiving the first message from the analysis agent 125, the computing system 120 can evaluate whether the client data is to be parsed, normalized, or extracted, and select the extraction agent 130 to execute a subsequent operation. In another example, the computing system 120 can determine that the client data includes non-standard field names or irregular tabular formats, and select the mapping agent 135 to align those fields to target schema fields defined in the metadata-based platform. In some aspects, the computing system 120 can include a state machine controller or a mixture-of-experts system configured to determine agent selection logic based on metadata-defined rules, agent specialization, prior output characteristics, or routing directives encoded in the first message. Selecting the second agent can include updating an internal routing table, invoking an execution context for the selected agent, or registering the selected agent’s function as a subsequent task in the onboarding sequence. In some aspects, the respective function of the second agent is different from a respective function of the first agent. For example, where the first agent executes an analysis function on raw client data to determine structural attributes, the second agent can perform extraction, mapping, or transformation operations based on the metadata constraints associated with that structure. In some examples, the selection process can include fallback logic to re-select alternate agents if an initial function fails or returns an incomplete output.

The method 200 can include the computing system transmitting a second message at operation 215. For example, operation 215 can include transmitting, by the one or more processors, using the second agent, to the plurality of agents, a second message including the reference to the state of metadata. The second message can include or refer to a structured data object generated based on execution of the respective function of the second agent. For example, the computing system 120, using the extraction agent 130, can generate the second message by transmitting a machine-readable payload that includes a reference to the metadata state identified in the first message and a reference to extracted segments of the client data. In some examples, the extracted segments of the client data can include field-value pairs, tabular structures, or record subsets parsed by the extraction agent 130. Additionally, the second message can include metadata annotations, extraction summaries, or output statistics derived from the execution of the extraction agent 130. Further, in some examples, the second message can include one or more flags or routing indicators to identify subsequent processing logic based on metadata constraints or sequencing conditions. Moreover, the computing system 120 can transmit the second message to one or more other agents, such as the mapping agent 135, transformation agent 140, validation agent 150, or integrity check agent 155, to continue processing based on the metadata state and the extracted data output.

The method 200 can include the computing system selecting additional agents at operation 220. For example, operation 220 can include selecting, by the one or more processors, using the plurality of agents, based on the second message, one or more additional agents of the plurality of agents to execute respective functions of the one or more additional agents. For example, the computing system 120 can evaluate the second message to determine agent selection logic based on the referenced metadata state, output attributes from the second agent, or routing directives embedded in the second message. In some aspects, the respective function of the one or more additional agents is different from the respective function of the first agent and the respective function of the second agent. For example, in response to receiving the second message transmitted by the extraction agent 130, the computing system 120 can select the mapping agent 135 to associate extracted fields with schema-defined target fields specified in the metadata state. Additionally, the mapping agent 135 can generate a field-to-field association based on schema alignment logic or mapping rules retrieved from the knowledge base 115. Further, upon completion of the function of the mapping agent 135, the computing system 120 can select the transformation agent 140 to apply formatting operations, unit standardization, or type conversion rules corresponding to the referenced metadata state. In some examples, the computing system 120 can further select the translation agent 145 to apply dictionary-based substitutions, abbreviation expansions, or domain-specific formatting conventions based on metadata-defined translation parameters. Moreover, in some aspects, the computing system 120 can select the validation agent 150 to verify whether the outputs of the preceding agents satisfy (e.g., comply with) field constraints, value ranges, or structural consistency conditions defined in the metadata state or stored in the knowledge base 115. In some aspects, the validation agent 150 can be selected and executed after each respective function of the mapping agent 135, transformation agent 140, or translation agent 145 to verify intermediate outputs prior to further processing. Additionally, the computing system 120 can select the integrity check agent 155 to perform record-level or batch-level consistency checks, such as verifying keys, referential alignment, or data coherence prior to structured query generation.

The method 200 can include the computing system generating a structured query at operation 225. For example, operation 225 can include generating, by the one or more processors, based on an output of executing the respective functions of the one or more additional agents, a structured query configured to migrate at least a portion of the client data onto the metadata-based platform. For example, the computing system 120 can generate a structured query representing a normalized, mapped, transformed, validated, and schema-aligned version of the client data. In some examples, generating the structured query can include identifying one or more data fields from the output of the transformation agent 140, formatting the identified fields based on the field associations determined by the mapping agent 135, and applying one or more constraints verified by the validation agent 150. Further, the structured query can include insertion, update, or merge logic referencing the metadata state associated with the platform 175, such as table identifiers, column names, or data typing rules. Additionally, in some aspects, the one or more processors can serialize the structured query for downstream execution using a metadata-aware ingestion pipeline or staging interface of the platform 175. Moreover, the computing system 120 can log the generated structured query with metadata versioning information, client identifiers, and validation results to facilitate downstream traceability, error correction, or audits. The structured query can be received by the metadata-based platform (e.g., platform 175) and cause the platform to store the client data with additional client data from prior onboarding instances.

The state of metadata can correspond to at least one configuration of a plurality of configurations associated with a plurality of service platforms. For example, the plurality of configurations can include product-specific, platform-specific, domain-specific, tenant-specific, or deployment-specific configurations (e.g., configurations associated with a data platform, balance platform, benefits platform, time platform, payroll platform, human resources platform, or another service platform, etc.). In some examples, a given configuration can define or otherwise correspond to one or more schemas, field sets, transformation rules, validation constraints, routing directives, user interface parameters, workflow stages, translation settings, or loading targets (e.g., table structures, field definitions, permissible values, formatting logic, review requirements, or target environment settings, etc.) used during migration of the client data.

The method 200 can further include the computing system selecting the at least one configuration based on an input corresponding with at least one service platform of the plurality of service platforms. For example, the input can include a user input, system input, uploaded file attribute, application programming interface (API) call, configuration selection, workflow parameter, source-system identifier, tenant identifier, product identifier, or other indicator (e.g., a dashboard selection, command-line parameter, request payload value, metadata tag, or platform selection received via a graphical user interface, etc.) corresponding to the at least one service platform. In some examples, selecting the at least one configuration can include identifying, retrieving, loading, activating, or otherwise applying a corresponding configuration record, metadata profile, rule set, template, or workflow definition (e.g., by querying a repository, accessing a configuration store, loading a versioned metadata state, or matching the input to a predefined platform type, etc.).

The method 200 can further include the computing system executing, responsive at least in part to selection of the at least one configuration, the respective functions of the plurality of agents to migrate the client data in accordance with the at least one configuration. For example, executing the respective functions in accordance with the at least one configuration can include routing, parameterizing, constraining, sequencing, or otherwise controlling operations of the plurality of agents based on the selected configuration (e.g., by applying configuration-specific mappings, transformation logic, translation rules, filtering parameters, validation checks, review prompts, or loading instructions, etc.). In some examples, the computing system can cause one or more of the analysis agent 125, extraction agent 130, mapping agent 135, transformation agent 140, translation agent 145, validation agent 150, or integrity check agent 155 to process the client data using configuration-specific logic associated with the selected service platform (e.g., service-platform-specific schemas, product-specific field relationships, context-specific rules, or target-platform-specific query templates, etc.).

The first message can include a reference to the client data stored in a shared data repository or data source. For example, the shared data repository can include or refer to a staging area, object store, database interface, API-accessible data feed, or a shared cloud-based storage service including the client data prepared for onboarding. The reference can include or refer to a pointer, uniform resource identifier (URI), database key, record identifier, or other structured token used to retrieve the associated client data. The first message can include one or more of a reference to the metadata state associated with the metadata-based platform and a reference to a client-specific data set located at an external storage location. In some aspects, the method 200 can further include, responsive at least in part to receiving the first message, accessing, by the one or more processors, the client data from the shared data repository or data source using the reference. For example, in response to receiving the first message from the analysis agent 125, the extraction agent 130 can retrieve a file, data stream, or structured object from a shared data source using the identifier included in the message and begin processing operations based on metadata state. In some examples, the shared data repository can support real-time access or versioned retrieval, and the client data can be accessed using authentication credentials or context tokens included in a provided message.

At least one of the plurality of agents can include a validation agent. The method 200 can further include, responsive to execution of the respective function of one or more of the plurality of agents, comparing, by the one or more processors, using the validation agent, one or more values of the client data to the state of metadata. For example, the validation agent 150 can receive an output from a prior agent (e.g., mapping agent 135 or transformation agent 140) and access the referenced metadata state to retrieve validation rules, field constraints, attributes, or domain specifications used to compare the client data to an expected schema or format. In some aspects, the validation agent 150 can execute one or more rule-based comparison functions to determine whether field-level values, record completeness, or data structures align with constraints defined in the metadata-based platform. In some examples, the computing system 120 can apply the validation agent 150 after each agent output, such that intermediate validation checks are executed prior to progressing to a subsequent agent. Additionally, in some aspects, the validation agent 150 can access the knowledge base 115 to retrieve external reference standards, templates, or value ranges used to validate specific field types or structural patterns within the client data.

The method 200 can further include the computing system outputting, using the validation agent, a validation result based on determining the client data conforms to the state of metadata. For example, the validation agent 150 can generate a structured validation result object including outcome status, pass/fail flags, identified discrepancies, or contextual annotations corresponding to the metadata-defined rules. In some examples, the validation result can include references to the validated data segment, the applied rule set, and an indication of any violations or compliance metrics. Additionally, the computing system 120 can transmit the validation result to the state machine controller or store the result in a logging repository for audit tracking, review workflows, or downstream decisioning. In some aspects, the validation result can be incorporated into a structured query or message stream used to complete onboarding or initiate a remediation process based on the validation outcome.

The state of metadata can include a mapping of one or more definitions, constraints, schemas, or transformations associated with the metadata-based platform. For example, the metadata state can define expected field names, permissible value ranges, normalization logic, formatting conversions, encoding parameters, expected or defined fields, or conditional validation parameters associated with a target data model of the platform 175. In some aspects, the method 200 can further include updating, by the one or more processors, using at least one of the plurality of agents, the client data using the respective function of the at least one of the plurality of agents in accordance with the one or more definitions, constraints, schemas, or transformations. For example, the transformation agent 140 can update a date field format from a national standard (e.g., MM/DD/YYYY) to an international standard (e.g., ISO 8601), apply unit conversions based on field metadata (e.g., cents to dollars, foreign currency to U.S. currency, etc.), or re-structure flat data into nested groupings based on a defined schema. In some examples, the mapping agent 135 can reassign input fields to names defined in the metadata state, or realign source-to-target field associations using schema definitions retrieved from the knowledge base 115. In some aspects, the metadata state can define transformation sequences or hierarchical application order (e.g., mapping before transformation before validation) that governs how the client data is updated throughout onboarding.

The method 200 can include the computing system generating the structured query based on the one or more definitions, constraints, schemas, or transformations. For example, the structured query can include an SQL statement, an API request payload, a configuration script, or a parameterized data object formatted in accordance with a schema referenced by the metadata-based platform. The structured query can be constructed to insert, update, or merge one or more records into the platform 175, based on the data values transformed and validated by the plurality of agents. In some aspects, the structured query can include embedded metadata tags, versioning identifiers, or validation result annotations to indicate compliance with the constraints and transformation logic defined in the metadata state. Additionally, in some examples, the structured query can be assembled by the computing system 120 using outputs provided by one or more agents, query templates, or schema-driven code generation routines associated with the platform 175.

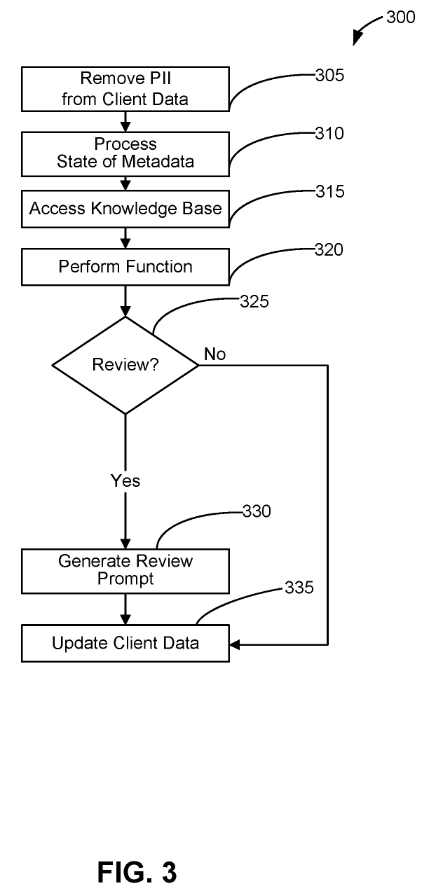

FIG. 3 is an illustrative example of a computer-implemented method for rapid data migration between computing systems using autonomous metadata-driven processes. Method 300 can be implemented using various systems, devices, or components discussed herein (e.g., one or more processors, one or more agents, system 100 or computing system 120 of FIG. 1, system 400 of FIG. 4, system 1100 of FIG. 11, etc.). Method 300 can include one or more operations 305-335. For example, operation 305 can include a computing system removing personally identifiable information (PII) from client data. Operation 310 can include the computing system processing a state of metadata. Operation 315 can include the computing system accessing a knowledge base. Operation 320 can include the computing system executing a function. Operation 325 can include determining whether a review is to be performed. Operation 330 can include the computing system generating a review prompt. Operation 335 can include the computing system updating the client data. Operations 305-335 can be removed, reordered, adjusted, bypassed, repeated, omitted, or otherwise modified in various aspects. In some aspects, one or more of operations of the method 300 can be incorporated into other methods discussed herein.

The method 300 can include the computing system removing personally identifiable information from the client data at operation 305. To remove personally identifiable information, the computing system can execute, perform, or otherwise facilitate a data sanitization process that can eliminate, redact, obfuscate, or otherwise mask or reduce one or more values or attributes of the client data that can be used to identify an individual. For example, removing personally identifiable information from the client data can include the computing system 120 (e.g., via the analysis agent 125 or extraction agent 130) scanning, identifying, flagging, or otherwise processing records of the client data to isolate fields or entries tagged as including personally identifiable information. In some examples, the one or more processors can apply rule-based logic, pattern recognition functions, or trained models to detect personally identifiable information such as names, addresses, phone numbers, email addresses, government identifiers, or account numbers. For example, the analysis agent 125 can detect regular expressions corresponding to email formats or national identification number patterns. Additionally, in some examples, the extraction agent 130 can execute redaction routines to replace detected personally identifiable information with null values, hash representations, tokenized substitutes, or metadata-linked pseudonyms. In some aspects, the one or more processors can reference a metadata state or access definitions stored in the knowledge base 115 to determine the field types or attribute labels associated with personally identifiable information and apply removal rules accordingly.

The method 300 can include the computing system processing the state of metadata based on one or more predefined conditions associated with a respective function of each agent. To process the state of metadata, the computing system can use each agent of the plurality of agents. For example, the computing system can process the state of metadata to determine whether to execute the respective function of each agent based on the one or more predefined conditions. In some examples, each agent of the plurality of agents can process, parse, or otherwise evaluate the state of metadata to determine whether execution of a respective function of the agent is applicable based on a current onboarding context, session state, or metadata-defined configuration. For example, the mapping agent 135 can determine that the metadata state includes field mapping definitions not yet satisfied and identify that its mapping function is to be executed. In another example, the transformation agent 140 can evaluate whether transformation parameters, unit formats, or data normalization instructions stored in the metadata state indicate that a transformation function is applicable. In some aspects, each agent can perform an evaluation independently based on internal logic or rule sets associated with the metadata state, or in coordination with a state machine controller or routing mechanism that provides agent-specific context. Further, in some aspects, the outcome of this metadata-based evaluation can determine whether the respective function of the agent is executed or performed during the current onboarding session. In some aspects, the predefined conditions can include schema availability, field completeness, data type compatibility, or dependency flags defined in the metadata state for each respective function. For example, the predefined conditions for the mapping agent 135 can include the presence of unmatched source fields and missing schema linkages, while the predefined conditions for the transformation agent 140 can include detection of non-normalized formats or flagged unit inconsistencies. Additionally, the predefined conditions can include threshold-based indicators or routing directives used by the state machine controller to determine whether to trigger an agent function, defer execution, or request review intervention during onboarding.

The method 300 can include the computing system accessing, based on the state of metadata, a knowledge base including one or more migration instructions associated with prior onboarding instances at operation 315. Accessing the knowledge base can include retrieving configuration parameters, schema alignment records, transformation mappings, or validation rule sets previously used for onboarding client data aligned with comparable metadata states. For example, the one or more processors can evaluate a current metadata reference and identify a prior metadata identifier associated with a stored onboarding record associated with a past onboarding instance (e.g., a previous integration of client data). In some examples, the one or more processors can access migration instructions corresponding to onboarding a data source having a similar schema structure, record layout, or entity field set. Additionally, the one or more processors can extract field mappings, rule constraints, or processing order information from the accessed migration instructions to support consistent transformation or validation decisions during the current onboarding instance.

The method 300 can include the computing system executing, using at least one agent of the plurality of agents, a respective function of the at least one agent at operation 320. The execution of the respective function of the at least one agent can be based at least in part on the one or more migration instructions associated with the prior onboarding instances. For example, performing the respective function can include executing a transformation, mapping, validation, or classification function defined in the retrieved migration instructions. In some examples, the mapping agent 135 can execute a field alignment operation based at least in part on a previously stored key-value structure defining source-to-target schema mappings. Additionally, the transformation agent 140 can apply a defined sequence of operations to convert data units, apply format conversions, or restructure nested attributes according to logic stored in the migration instructions. In some aspects, the validation agent 150 can verify data integrity using historical constraint sets or rule chains associated with prior client profiles stored in the knowledge base.

The method 300 can include the computing system determining whether a review is to be executed at operation 325. The determination of whether the review is to be performed can be based on a result of the function executed in operation 320. Determining whether a review is to be performed can include evaluating one or more confidence metrics, error flags, routing directives, or metadata-based thresholds associated with the result of the function. For example, in response to a mapping operation executed by the mapping agent 135, the one or more processors can evaluate whether a mapping confidence score falls below a defined threshold in the metadata state. In another example, in response to a transformation executed by the transformation agent 140, the one or more processors can determine whether an ambiguity tag, fallback operation, or format collision was recorded during transformation, and whether such a condition triggers a review flag. In some aspects, if the review condition is not satisfied, the one or more processors can bypass user interaction and proceed directly to a subsequent processing operation (e.g., operation 335), continuing execution based on the current metadata state and the result of the prior function. In some aspects, if the review condition is satisfied, the one or more processors can initiate a review stage by executing operation 330. In such examples, the one or more processors can route the current result to a graphical review interface, generate a review prompt, or log a request for review into a pending action queue. Additionally, in some aspects, determining whether a review is to be performed can include consulting audit history, metadata override records, or domain-specific policy rules stored in the knowledge base 115 that define which types of outputs prompt user confirmation based on client-specific onboarding profiles.

The method 300 can include the computing system generating, using at least one agent of the plurality of agents, a review prompt at operation 330. The generation of the review prompt can be based on a confidence threshold associated with execution of a respective function of the at least one agents. For example, the review prompt can include or refer to a graphical interface element rendered on a client device, such as a structured form, dialogue box, or confirmation window configured to display a result of the respective function or additional data (e.g., a confidence metric, and one or more selectable inputs for user validation, revision, or approval). For example, the mapping agent 135 can generate a review prompt including one or more proposed field alignments between a source data element and a schema field of the metadata-based platform, along with a match score or alignment reason. In some examples, the transformation agent 140 can trigger a review prompt including one or more candidate conversion formats, value ranges, or formatting options associated with a metadata-defined transformation rule. Additionally, the one or more processors can embed routing metadata, audit tags, or contextual summaries within the review prompt to guide downstream agent behavior based on received user input. In some aspects, the confidence threshold can include a predefined metric value associated with the output of the agent function, such as a probability score, matching ratio, or rule satisfaction percentage. Additionally, the confidence threshold can be defined in the metadata state or derived from historical agent performance and can determine whether the review prompt is generated automatically, suppressed, or deferred to a later stage based on output certainty.

The method 300 can include the computing system updating, by the one or more processors, using the at least one agent, the client data based on input received via the review prompt at operation 335. For example, the one or more processors can receive a user-selected field mapping, value override, format correction, or other user-specified instruction via the review prompt, and can apply the input to modify one or more values of the client data. For example, if the review prompt displays multiple candidate schema fields and a user selects one of the options, the mapping agent 135 can update a mapping table or field alignment index accordingly. In some aspects, the computing system 120 can store the updated client data in a staging buffer, update a metadata state to reflect the accepted change, or propagate the update to downstream agents (e.g., the validation agent 150 or integrity check agent 155). Additionally, the update can be recorded as a review-based override in an agent execution log or metadata update register for auditability or reuse in future onboarding sessions.

The method 300 can further include the computing system executing, using at least one translation agent of the plurality of agents, a translation operation on the client data based on the state of metadata. For example, the at least one translation agent can include the translation agent 145 or another agent configured to interpret, convert, normalize, localize, or otherwise adjust one or more portions of the client data based on translation logic defined by the state of metadata (e.g., field-level translation rules, locale-specific mappings, jurisdiction-specific terminology, language-specific labels, formatting conventions, code sets, or other context-specific parameters, etc.). In some examples, executing the translation operation can include identifying, selecting, applying, substituting, transforming, or otherwise processing one or more values, labels, attributes, instructions, or other parameters of the client data in accordance with the state of metadata (e.g., by applying dictionary-based substitutions, lookup-table conversions, metadata-defined translation rules, context-specific formatting logic, or other translation operations, etc.).

In some examples, the translation operation can convert one or more parameters of the client data that are associated with a first context to a second context selected for migration via the metadata-based platform. For example, the one or more parameters can include field values, labels, identifiers, units, codes, categories, descriptors, instructions, or other data elements associated with the client data (e.g., source-system terminology, localized text, region-specific values, date formats, compensation labels, job classifications, leave categories, or other context-dependent parameters, etc.). In some examples, the first context and the second context can include different languages, locales, jurisdictions, operating regions, countries, source systems, service platforms, product configurations, or other execution contexts associated with migration of the client data (e.g., a first country-specific data format and a second country-specific data format, a first source-system naming convention and a target platform naming convention, or a first language representation and a second language representation, etc.). In some examples, converting the one or more parameters can include replacing, reformatting, mapping, translating, standardizing, or otherwise modifying the one or more parameters such that the client data conforms to the second context selected for migration via the metadata-based platform.

In some examples of the method 300, the computing system can receive the client data from a plurality of source systems. For example, the plurality of source systems can include a plurality of vendor systems, enterprise systems, client-managed systems, third-party systems, internal repositories, file sources, application programming interfaces (APIs), databases, cloud-based storage locations, or other data sources associated with the client data (e.g., payroll systems, benefits systems, time-tracking systems, human resources systems, spreadsheets, flat files, document repositories, or other structured or semi-structured data sources, etc.). In some examples, receiving the client data can include accessing, retrieving, ingesting, importing, downloading, collecting, or otherwise obtaining one or more portions of the client data from the plurality of source systems (e.g., by receiving uploaded files, querying APIs, reading database exports, accessing shared storage locations, or processing staged source-system extracts, etc.).

In some examples of the method 300, the computing system can generate, in parallel for the plurality of source systems, respective source tables and respective mappings for the client data. For example, the respective source tables can include source-specific tables, intermediate tables, normalized tables, staging tables, working tables, or other tabular representations corresponding to the client data received from the plurality of source systems (e.g., a first table for data from a first vendor system, a second table for data from a second vendor system, or separate tables organized by source type, region, product, or client entity, etc.). In some examples, the respective mappings can include field mappings, schema mappings, value mappings, crosswalks, correspondences, or other associations between source-system data and target metadata-based platform fields (e.g., mappings between source field names and target field identifiers, source values and normalized values, or source tables and destination schema structures, etc.). In some examples, generating the respective source tables and the respective mappings in parallel can include concurrently creating, populating, deriving, processing, or otherwise producing multiple source-specific outputs for different source systems at the same time or during overlapping time intervals (e.g., using separate workflow instances, parallel agent executions, concurrent processing threads, or other simultaneous processing techniques, etc.).

In some examples of the method 300, the computing system can merge at least a portion of the respective source tables into a combined table. For example, the combined table can include a consolidated table, merged table, aggregated table, unified table, intermediate load table, validation table, or other combined data structure representing at least a portion of the client data from the plurality of source systems (e.g., a table combining records associated with a common entity type, common product, common jurisdiction, or common target schema, etc.). In some examples, merging the at least the portion of the respective source tables can include joining, combining, appending, reconciling, aligning, deduplicating, or otherwise integrating records, fields, rows, columns, or other data elements from the respective source tables into the combined table (e.g., by matching common identifiers, aligning shared fields, grouping similar record types, or consolidating source-specific entries into a target-oriented table structure, etc.).

In some examples of the method 300, the computing system can validate the combined table. For example, the combined table can be validated based on one or more rules, constraints, checks, thresholds, or other criteria associated with the metadata-based platform or the state of metadata (e.g., schema conformance rules, field completeness requirements, referential integrity checks, business rule validations, duplicate detection checks, data type checks, or range validations, etc.). In some examples, validating the combined table can include evaluating, verifying, checking, comparing, testing, or otherwise assessing the combined table to determine whether the combined table satisfies one or more requirements for migration of the client data (e.g., whether merged records conform to expected field definitions, whether required values are present, whether values satisfy platform-specific rules, or whether source-system inconsistencies have been resolved, etc.).

In some examples of the method 300, the computing system can generate the structured query responsive at least in part to validation of the combined table. For example, generating the structured query responsive at least in part to validation of the combined table can include generating the structured query subsequent to, based on, or in response to determining that the combined table satisfies one or more validation conditions, thresholds, constraints, or approval criteria (e.g., upon successful completion of schema checks, referential integrity checks, business rule checks, or other validation operations, etc.). In some examples, the structured query can include an insertion query, update query, merge query, load instruction, application programming interface (API) payload, serialized command, or other machine-readable instruction configured to migrate at least a portion of the client data onto the metadata-based platform (e.g., a SQL insert statement, SQL merge statement, staged load command, or platform-specific ingestion payload, etc.). In some examples, generating the structured query can include constructing, formatting, populating, serializing, or otherwise producing the structured query based on the validated combined table and one or more schema definitions, mappings, or loading parameters associated with the metadata-based platform.

In some examples of the method 300, the computing system can identify a conversion stage associated with migration of the client data. For example, the conversion stage can include a processing stage, onboarding stage, workflow stage, migration phase, execution state, or other stage associated with migration of the client data (e.g., an analysis stage, extraction stage, mapping stage, translation stage, transformation stage, validation stage, filtering stage, loading stage, or review stage, etc.). In some examples, identifying the conversion stage can include determining, detecting, selecting, inferring, retrieving, or otherwise establishing a current or next stage of migration based on one or more inputs, outputs, metadata values, routing indicators, workflow records, state machine values, or user selections associated with the client data (e.g., a stage identifier stored in a session record, a status value output by an agent, a workflow flag, or a user-selected stage transition, etc.).

In some examples of the method 300, the computing system can query, based at least in part on identification of the conversion stage, a knowledge base to retrieve a plurality of migration instructions that correspond to the conversion stage. For example, the knowledge base can include a repository, data store, indexed collection, instruction library, rules database, or other information source storing migration instructions associated with one or more conversion stages (e.g., prior onboarding records, stage-specific rules, configuration templates, source-system guidance, or historical workflow definitions, etc.). In some examples, the plurality of migration instructions can include instructions, parameters, rules, mappings, templates, examples, directives, prompts, or other migration-related information corresponding to the conversion stage (e.g., mapping rules for a mapping stage, validation checks for a validation stage, translation guidance for a translation stage, or filtering templates for a filtering stage, etc.). In some examples, querying the knowledge base can include searching, accessing, retrieving, filtering, ranking, or otherwise obtaining the plurality of migration instructions using one or more query terms, identifiers, metadata values, stage labels, source-system identifiers, vendor identifiers, or context indicators associated with the identified conversion stage (e.g., a query using a stage identifier and a source-system type, etc.).

In some examples of the method 300, the computing system can apply a first migration instruction of the plurality of migration instructions to directly modify execution of a first function of the respective functions of the plurality of agents. For example, the first migration instruction can include a predefined instruction, deterministic rule, configuration parameter, execution directive, mapping definition, routing parameter, validation rule, transformation rule, filtering template, or other structured instruction capable of being directly applied to execution of the first function (e.g., a field-mapping rule, an execution threshold, a sequence constraint, a formatting instruction, or a target-field directive, etc.). In some examples, directly modifying execution of the first function can include controlling, adjusting, parameterizing, constraining, redirecting, sequencing, enabling, disabling, or otherwise changing how the first function is executed by at least one of the plurality of agents (e.g., by changing mapping behavior, selecting a target schema, applying a rule set, updating a processing threshold, or modifying routing to a downstream agent, etc.).

In some examples of the method 300, the computing system can provide a second migration instruction of the plurality of migration instructions as input to an artificial intelligence model used to execute a second function of the respective functions of the plurality of agents. For example, the second migration instruction can include contextual information, guidance information, reference information, example information, historical information, domain information, or other supplemental instruction used by the artificial intelligence model during execution of the second function (e.g., a prompt, retrieved example, prior mapping, explanation, workflow history entry, policy reference, or domain-specific note, etc.). In some examples, the artificial intelligence model can include a large language model, machine learning model, neural network, retrieval-augmented generation model, classifier, ranking model, or other model used by one or more agents to execute the second function (e.g., a model used for mapping, transformation, translation, validation, or review generation, etc.). In some examples, providing the second migration instruction as input can include supplying, appending, embedding, referencing, injecting, transmitting, or otherwise furnishing the second migration instruction to the artificial intelligence model for use in generating an output associated with execution of the second function (e.g., by including the second migration instruction in a prompt, structured payload, retrieved context set, model input object, or inference request, etc.).

In some examples of the method 300, the computing system can determine, based on the state of metadata, a plurality of execution contexts associated with the client data. For example, the plurality of execution contexts can include processing contexts, operational contexts, jurisdictional contexts, regional contexts, language contexts, source-system contexts, organizational contexts, product contexts, or other distinct contexts associated with migration of the client data (e.g., contexts corresponding to different countries, business units, legal entities, source systems, operating regions, languages, tenants, or service platforms, etc.). The computing system can adapt to different contexts to support globalization during migration of client data. In some examples, determining the plurality of execution contexts can include identifying, deriving, classifying, segmenting, assigning, or otherwise establishing distinct contexts based on one or more metadata values, attributes of the client data, field values, source identifiers, region indicators, authorization settings, or other context-related information associated with the client data (e.g., country codes, locale fields, source-system identifiers, business-unit tags, product identifiers, or workflow parameters, etc.).

In some examples of the method 300, the computing system can initialize, for each execution context of the plurality of execution contexts, a context-specific metadata state. For example, the context-specific metadata state can include a metadata state, metadata profile, metadata subset, metadata configuration, metadata instance, or other metadata representation corresponding to a particular execution context (e.g., a context-specific set of schemas, mappings, validation rules, translation parameters, formatting conventions, routing directives, or loading definitions, etc.). In some examples, initializing the context-specific metadata state can include creating, retrieving, loading, assigning, instantiating, configuring, or otherwise establishing a metadata state for the respective execution context based on the state of metadata and one or more attributes associated with the respective execution context (e.g., by selecting a region-specific schema set, applying context-specific rules, loading a context-specific version of metadata, or creating a working metadata instance for a given source-system or jurisdictional context, etc.).

In some examples of the method 300, the computing system can execute, for each execution context, a respective migration workflow using the plurality of agents based on the context-specific metadata state to generate one or more results. For example, the respective migration workflow can include an onboarding workflow, conversion workflow, processing flow, agent workflow, or other migration-related sequence of operations performed for the respective execution context (e.g., a workflow including one or more of analysis, extraction, filtering, mapping, translation, transformation, validation, integrity checking, review, or loading operations, etc.). In some examples, the one or more results can include outputs, records, mappings, translations, transformed values, validation results, review outputs, status indicators, structured queries, or other results generated during execution of the respective migration workflow (e.g., context-specific source tables, context-specific validation reports, translated field values, transformed records, or workflow completion statuses, etc.). In some examples, executing the respective migration workflow can include initiating, coordinating, sequencing, repeating, parallelizing, or otherwise causing the plurality of agents to perform one or more respective functions for each execution context in accordance with the corresponding context-specific metadata state (e.g., by running separate workflow instances for different countries, source systems, or languages, etc.).

In some examples of the method 300, the computing system can update, based at least in part on the one or more results, the context-specific metadata state for each execution context. For example, updating the context-specific metadata state can include revising, modifying, augmenting, synchronizing, storing, versioning, or otherwise changing one or more metadata values, rules, mappings, state indicators, validation parameters, workflow attributes, or other metadata elements associated with the respective execution context (e.g., by updating a context-specific mapping table, storing a validation outcome, revising a translation rule, recording a workflow state, or incrementing a metadata version, etc.). In some examples, the computing system can update the context-specific metadata state based on one or more context-specific outputs, corrections, validations, user inputs, workflow transitions, or execution results generated during the respective migration workflow (e.g., accepted mappings, detected errors, completed stages, review overrides, or successful data-load results, etc.).

In some examples of the method 300, the computing system can receive a request associated with filtering of the client data. For example, the request can include a user request, system request, agent-generated request, workflow request, review-stage request, or other request associated with filtering of the client data (e.g., a request received via a graphical user interface, an API call, a workflow control, a metadata-driven trigger, a rule-based condition, or an output of a prior analysis operation, etc.). In some examples, filtering of the client data can include excluding, retaining, segmenting, isolating, limiting, or otherwise identifying one or more portions of the client data for further processing or non-processing (e.g., removing incomplete records, excluding duplicate rows, isolating records associated with a selected region, retaining records satisfying a threshold condition, or limiting processing to a selected subset of fields or entries, etc.). In some examples, receiving the request can include detecting, obtaining, accessing, accepting, or otherwise receiving one or more filtering instructions, filtering conditions, filtering parameters, or filtering selections associated with the client data (e.g., record-selection criteria, field-based conditions, user-defined rules, or metadata-based filtering directives, etc.).

In some examples of the method 300, the computing system can generate, responsive at least in part to receipt of the request, one or more executable filters. For example, the one or more executable filters can include computer-executable code with filter expressions, filter rules, query conditions, logical criteria, or other executable instructions configured to process the client data according to the request (e.g., Boolean expressions, row-selection rules, field-based comparisons, threshold conditions, pattern-matching rules, or metadata-aligned filter templates, etc.). In some examples, generating the one or more executable filters can include constructing, deriving, translating, compiling, parameterizing, testing, or otherwise producing the one or more executable filters from the request and one or more associated filtering instructions, metadata values, field definitions, or context parameters (e.g., converting a user-specified request into executable query syntax, generating a filter from a selected field condition, or creating a metadata-based exclusion rule, etc.).

In some examples of the method 300, the computing system can execute the one or more executable filters to remove at least a portion of the client data. For example, the at least the portion of the client data can include one or more records, rows, fields, values, entries, data segments, or other portions of the client data identified by the one or more executable filters (e.g., records associated with invalid values, duplicate entries, incomplete fields, non-selected entities, or non-compliant source data, etc.). In some examples, executing the one or more executable filters can include applying, running, enforcing, evaluating, or otherwise using the one or more executable filters to identify and remove, exclude, omit, or otherwise prevent further processing of the at least the portion of the client data (e.g., by deleting filtered records from a working copy, excluding rows from downstream mapping, suppressing non-selected fields, or generating a filtered dataset for subsequent migration operations, etc.). In some examples, the computing system can execute the one or more executable filters prior to execution of one or more additional migration operations (e.g., prior to mapping, translation, transformation, validation, or loading, etc.).

In some examples of the method 300, the computing system can cause a graphical user interface to display a tracker comprising a sequence of stages of a migration workflow, wherein the sequence of stages correspond to execution states of the respective functions of the plurality of agents. For example, the graphical user interface can include a dashboard, application interface, web interface, review interface, workflow interface, or other visual interface presented via a client device (e.g., a web application, desktop application, low-code interface, implementation console, or administrative interface, etc.). In some examples, the tracker can include a progress tracker, workflow tracker, status tracker, stage indicator, progress bar, step sequence, or other interface element configured to visually represent progression through the migration workflow (e.g., a horizontal stage bar, vertical workflow list, timeline, node-based sequence, or other stage-oriented display, etc.). In some examples, the sequence of stages can include analysis, extraction, filtering, mapping, translation, transformation, validation, integrity checking, target-environment selection, loading, review, or other stages of the migration workflow (e.g., completed stages, active stages, pending stages, blocked stages, or exception stages, etc.). In some examples, causing the graphical user interface to display the tracker can include generating, rendering, updating, refreshing, or otherwise presenting the tracker based on one or more execution states associated with the respective functions of the plurality of agents (e.g., agent completion states, in-progress states, validation states, review states, failure states, or queued states, etc.).

In some examples of the method 300, the computing system can output, via the graphical user interface, one or more selectable controls configured to control one or more stages of the sequence of stages. For example, the one or more selectable controls can include buttons, links, toggles, menus, tabs, icons, checkboxes, pop-up controls, modal controls, confirmation controls, navigation controls, or other interactive interface elements configured to receive user input associated with the migration workflow (e.g., controls to start a stage, pause a stage, confirm a result, revise a mapping, configure a translation, request filtering, select a target environment, or advance to a next stage, etc.). In some examples, controlling the one or more stages of the sequence of stages can include initiating, pausing, resuming, revising, approving, rejecting, advancing, repeating, bypassing, or otherwise affecting execution or presentation of the one or more stages (e.g., triggering an agent operation, reopening a review stage, submitting a validation approval, applying a selected configuration, or requesting additional processing for a stage, etc.). In some examples, outputting the one or more selectable controls can include displaying, rendering, presenting, activating, or otherwise providing the one or more selectable controls based on a current execution state, a user role, a metadata-defined condition, a review requirement, or an output of one or more of the plurality of agents (e.g., showing a confirmation control when a mapping review is pending, displaying a filtering control after data analysis, or activating a target-environment selection control after validation, etc.).

FIG. 4 is an illustrative block diagram depicting a system 400 for rapid data migration between computing systems using autonomous metadata-driven processes, according to some aspects. The system 400 can be implemented using one or more of the computing systems, subsystems, or devices described herein (e.g., computing system 120). In some aspects, the system 400 includes a layered architecture to coordinate data processing functions across multiple stages of onboarding. For example, the system 400 can include a data analysis and extraction layer 405, a data mapping and review layer 410, a data transformation layer 415, and a data validation and loading layer 420. Each layer can include a respective subset of specialized agents, interfaces, outputs, or components for onboarding client data onto a metadata-based platform.

The data analysis and extraction layer 405 can include an implementation consultant system 425. In some examples, the implementation consultant system 425 can provide information (e.g., instructional or contextual information) to assist a client in onboarding data (e.g., client data 435) onto the platform 175. In some examples, the implementation consultant system 425 can be used to initialize a client onboarding operation (e.g., in response to user input via an interface of the implementation consultant system 425). In some examples, the guided interview system 430 can be configured to provide one or more prompts (e.g., via a chatbot) to receive client data 435 (e.g., using structured uploads, etc.) or inputs associated with the client data 435 (e.g., additional company information, client-specific instructions, etc.). The launchpad 440 can be configured to receive outputs (e.g., aggregated client data, instructions, preferences, etc.) collected from the guided interview system 430 and provide further outputs to one or more downstream components. For example, the launchpad 440 can receive client data 435 or metadata from the guided interview system 430 and initiate execution of one or more agents (e.g., the data extraction agent 130 or the data analysis agent 125). In some examples, the data analysis agent 125 can execute one or more respective functions on the client data 435, such as field classification, schema profiling, or data summarization. For example, the data analysis agent 125 can access domain-specific reference data from the knowledge base 115 to classify inputs and generate metadata-aligned representations based on the client data 435 provided for onboarding. The output of the data analysis agent 125 can include a summarized representation of field types, formats, and distributions used in the client data 435. The data analysis agent 125 can transmit a message to one or more additional agents, and the message can be received by the data extraction agent 130. In some examples, the data extraction agent 130 can retrieve the client data 435 based information included in the message (e.g., a reference or identifier to a shared data source) and can parse the client data 435 extract data structures, fields, values, or other information. The data extraction agent 130 can transmit a message to one or more additional agents in response to performing the extraction on the client data 435. In some examples, the state machine controller 165 can identify the metadata state of the platform 175 and provide the metadata state for use in execution of one or more operations of the data analysis agent 125 or data extraction agent 130.

The data mapping and review layer 410 can include one or more agents configured to align extracted field values with target schemas defined in a metadata state. For example, the data mapping agent 135 can receive the message transmitted by the data extraction agent 130. The data mapping agent 135 can interface with one or more components (e.g., an AI model, knowledge base 115, etc.) to generate AI mappings 445 (e.g., schema mapping proposals for the client data 435). For example, the data mapping agent 135 can use field definitions, mapping dictionaries, or prior mappings from similar clients to generate AI mappings 445. In some examples, the data mapping agent 135 can implement pattern recognition functions (e.g., via AI) and generate confidence scores or other metrics associated with the generated AI mappings 445. The data mapping agent 135 can transmit a message to one or more additional agents in response to generating the AI mappings 445, and the message can be received by the data transformation agent 140. In some aspects, the data transformation agent 140 can generate transformation instructions 450. For example, the transformation instructions 450 can include instructions executable by an AI model to convert mapped fields or values of the client data 435 into compliant formats based on the metadata state of the platform 175. The data transformation agent 140 can transmit a message to one or more additional agents, and the message can be received by the data validation agent 150. In some examples, the data validation agent 150 can verify that outputs of one or more of the data mapping agent 135 or data transformation agent 140 (e.g., mapped and transformed fields of client data 435) conform to various schemas, formats, or constraints (e.g., expected formats, allowable ranges, or expected values). In response to verifying conformance, the data validation agent 150 can transmit a message to one or more additional agents.

The data transformation layer 415 can include one or more agents configured to localize, translate, or further adjust the client data based on translation logic. For example, the data translation agent 145 can receive the message transmitted by the data transformation agent 140 or the validation agent 150 and can apply one or more translations to the client data 435. For example, the data translation agent 145 can interface with the knowledge base 115 to identify field guides or reference tables used for translation of the client data 435 into one or more schemas, languages, or formats. In some examples, the data translation agent 145 can apply context-based adjustments to the client data 435 based on prior translations, domain-specific models, or rule-based formatting logic. The data translation agent 145 can transmit a message to one or more additional agents, and the message can be received by the data validation agent 150. In some examples, the data validation agent 150 can evaluate outputs of the data translation agent 145 against translation constraints or formatting parameters defined in the metadata state provided by the state machine controller 165. In some examples, the data validation agent 150 can provide a reviewed AI translation 455 that includes translated fields, values, or associated information derived from the client data 435. In response to executing one or more respective operations, the data validation agent 150 can transmit a message to one or more additional agents.

The data validation and loading layer 420 can execute one or more verification steps and complete onboarding of the client data onto the platform 175. For example, the data integrity check agent 155 can receive the message transmitted by the validation agent 150 and can further perform one or more checks (e.g., validations, verifications, integrity checks, etc.) to confirm that the transformed data (e.g., reviewed AI translation) is complete, accurate, and aligned with various constraints or formatting attributes (e.g., schema-level and inter-record constraints) associated with a metadata based platform (e.g., platform 175). In some examples, the integrity check agent 155 can reference prior metadata states or platform-specific onboarding rules to detect violations or deviations (e.g., duplicates, null fields, consistency errors, or mismatches). Responsive to, subsequent to, or otherwise based on a confirmation of integrity, the system 400 can generate a structured query to submit the updated client data to the platform 175 for activation or integration (e.g., rapid implementation). In some aspects, various systems or components of data validation and loading layer 420 can generate or provide audit logs or validation outcomes and output such data to a compliance dashboard or review console.

The state machine controller 165 can coordinate the execution of one or more AI-based agents included in the system 400. For example, the state machine controller 165 can track metadata states and orchestrate agent selection and message propagation across the data analysis and extraction layer 405, data mapping and review layer 410, data transformation layer 415, and data validation and loading layer 420. For example, the state machine controller 165 can maintain a current processing context, evaluate agent readiness, and transition between stages of onboarding based on the metadata state, message content, and outputs provided by one or more agents. In some aspects, the state machine controller 165 can incorporate fallback logic, dynamically update routing strategies, or expose execution progress via external orchestration tools (e.g., a GUI). Additionally, the state machine controller 165 can integrate with a mixture of experts system (e.g., MoE system 160 of FIG. 1) to manage conflict resolution, agent performance metrics, and selection history across one or more onboarding workflows.

In some aspects, the system 400 can be used to control client onboarding for different service platforms or products by selecting different metadata configurations for layers and included agents. For example, the system 400 can implement a standardized migration framework across a plurality of products while varying product-specific parameters, such as field definitions, rule sets, transformation logic, or validation criteria based on the selected metadata configuration. In some examples, the system 400 can access stage-specific entries from a knowledge base to modify execution of one or more layers or agents based on an indicator, such as current conversion stage, vendor type, or context identifier. In some aspects, workflow states or validation states generated by the system 400 can be provided to a graphical user interface for display as a stage tracker or for interaction using one or more selectable controls.

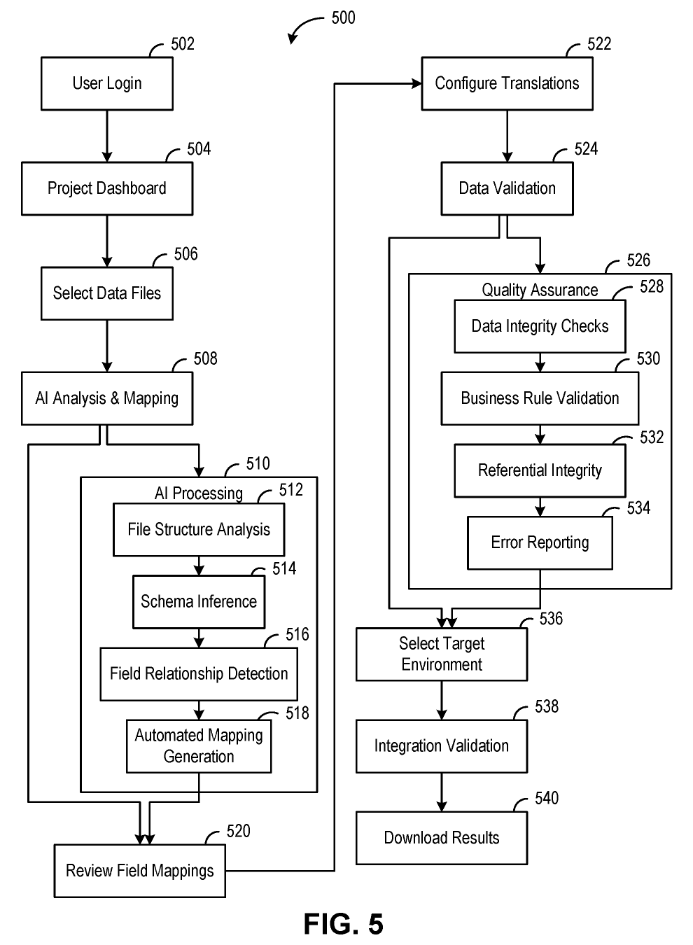

FIG. 5 is an illustrative example of a computer-implemented method for full-stack rapid data conversion using autonomous metadata-driven processes. Method 500 can be implemented using various systems, devices, or components discussed herein (e.g., one or more processors, one or more agents, system 100 or computing system 120 of FIG. 1, system 400 of FIG. 4, system 1100 of FIG. 11, etc.). Method 500 can include one or more operations 502-540. Operations 502-540 can be removed, reordered, adjusted, bypassed, repeated, omitted, or otherwise modified in various aspects. In some aspects, one or more operations of the method 500 can be incorporated into other methods discussed herein.\

The method 500 can include a computing system (e.g., computing system 120, one or more processors, one or more agents, etc.) receiving a user login at operation 502. For example, receiving the user login can include receiving authentication information, account credentials, session information, or other access information associated with a user of the computing system (e.g., OAuth credentials, single sign-on credentials, secure tokens, session cookies, or other authentication input, etc.). In some examples, the computing system can use the received user login to establish a user session, validate permissions, identify one or more accessible projects, or initialize access to one or more migration workflows associated with the user. The method 500 can include the computing system outputting a project dashboard at operation 504. For example, the project dashboard can include a graphical user interface, workflow interface, project overview interface, or other display configured to present one or more migration projects, workflow stages, status indicators, or selectable controls (e.g., a project summary view, a workflow-stage display, a navigation panel, a status dashboard, or one or more controls for file selection, mapping review, translation review, validation, or download, etc.). In some examples, the project dashboard can present project metadata, iteration data, workflow progress, stage completion states, or pending actions.

The method 500 can include the computing system receiving a selection of data files at operation 506. For example, the selected data files can include source files, upload files, client-provided files, vendor files, or other files associated with client data to be converted or migrated (e.g., CSV files, spreadsheet files, JSON files, XML files, delimited text files, or other source-system files, etc.). In some examples, receiving the selection of the data files can include receiving one or more uploads, file references, file identifiers, or user selections corresponding to one or more datasets or import types. In some examples, the computing system can store the selected data files in external storage, associate the selected data files with a project or iteration, and prepare the selected data files for downstream analysis and processing. The method 500 can include the computing system performing AI analysis and mapping at operation 508. For example, performing AI analysis and mapping can include executing one or more artificial intelligence-assisted operations to analyze the selected data files and generate one or more candidate mappings between source data and target schema elements associated with a metadata-based platform. In some examples, the computing system can use one or more AI models to evaluate file contents, infer structure, identify relationships, classify fields, or generate mapping suggestions. In some aspects, operation 508 can include or invoke one or more operations 510-518.

The method 500 can include the computing system performing AI processing at operation 510. For example, AI processing can include one or more model inference operations, machine learning operations, large language model operations, or other automated analysis operations applied to the selected data files (e.g., intelligent data analysis, automated field mapping, quality-assurance analysis, or natural-language-assisted interpretation, etc.). In some examples, the computing system can perform the AI processing using multiple AI providers, multiple models, or multiple agent instances in coordination with one or more metadata states or workflow states. The method 500 can include the computing system performing file structure analysis at operation 512. For example, file structure analysis can include identifying, parsing, detecting, or otherwise determining one or more structural characteristics of the selected data files (e.g., file type, delimiter format, header structure, column arrangement, table layout, record organization, or schema-like structure, etc.). In some examples, the computing system can use the file structure analysis to determine how source data is to be ingested, stored, or transformed in subsequent workflow stages.

The method 500 can include the computing system performing schema inference at operation 514. For example, schema inference can include deriving, estimating, identifying, or otherwise determining one or more source schema characteristics or target schema relationships associated with the selected data files (e.g., inferred field types, candidate table structures, target import types, etc.). In some examples, the computing system can use the schema inference to support dynamic table generation, mapping generation, data transformation, or validation operations. The method 500 can include the computing system performing field relationship detection at operation 516. For example, field relationship detection can include identifying, determining, correlating, or otherwise detecting one or more relationships among source fields, inferred fields, records, or tables of the selected data files (e.g., cross-file relationships, source-to-target associations, repeated groups, parent-child relationships, or field dependencies, etc.). In some examples, the computing system can use the detected relationships to improve mapping quality, infer transformation requirements, or support downstream validation.

The method 500 can include the computing system performing automated mapping generation at operation 518. For example, automated mapping generation can include generating, predicting, synthesizing, or otherwise determining one or more candidate mappings between source fields and destination fields of the metadata-based platform (e.g., source-column-to-target-column mappings, source-table-to-target-table mappings, candidate import-type mappings, or one or more field-alignment suggestions with confidence scores, etc.). In some examples, the computing system can store the generated mappings, output the generated mappings for user review, or use the generated mappings in subsequent translation, generation, or validation operations. The method 500 can include the computing system outputting a review of field mappings at operation 520. For example, reviewing the field mappings can include displaying one or more proposed mappings, confidence scores, source fields, target fields, or mapping rationales via review prompt on a graphical interface (e.g., a mapping review screen, an editable grid, or one or more review controls for approval, correction, or override, etc.). In some examples, the computing system can receive one or more mapping revisions or confirmations from a user and can use the received inputs to update one or more stored mappings, metadata values, or workflow states.

The method 500 can include the computing system receiving or applying translation configurations at operation 522. For example, the translation configurations can include one or more value-mapping definitions, format-conversion rules, translation rules, locale rules, or other configuration data used to convert one or more values or formats of the client data (e.g., source-to-target value mappings, standardized labels, code conversions, formatting conventions, or one or more translation instructions, etc.). In some examples, the computing system can output one or more translation suggestions for review and can apply one or more user-approved translations prior to subsequent validation or generation operations. The method 500 can include the computing system performing data validation at operation 524. For example, data validation can include validating mapped data, translated data, transformed data, or generated outputs against one or more schema definitions, metadata rules, quality rules, or platform-specific requirements associated with migration of the client data. In some aspects, operation 524 can include or invoke one or more operations 526-534.

The method 500 can include the computing system performing quality assurance at operation 526. For example, quality assurance can include one or more review, verification, auditing, or checking operations used to assess whether processed client data satisfies one or more expected quality standards or workflow requirements (e.g., completeness checks, consistency checks, validation summaries, or issue identification operations, etc.). In some examples, the computing system can coordinate quality assurance using outputs of one or more validation, error-detection, and reporting operations. The method 500 can include the computing system performing data integrity checks at operation 528. For example, data integrity checks can include verifying one or more record-level, field-level, table-level, or dataset-level integrity conditions associated with the processed client data (e.g., required-field checks, duplicate detection, null-value checks, consistency checks, or integrity-rule checks, etc.). In some examples, the computing system can use the data integrity checks to identify one or more errors, omissions, or anomalies prior to downstream validation or deployment.

The method 500 can include the computing system performing business rule validation at operation 530. For example, business rule validation can include determining whether one or more values, records, relationships, or transformations satisfy one or more business rules, policy rules, domain-specific rules, or configuration rules associated with the metadata-based platform (e.g., conditional rules, threshold requirements, workflow constraints, or client-specific logic, etc.). In some examples, the business rules can be defined in a metadata state, stored in a configuration store, or otherwise retrieved from one or more system components. The method 500 can include the computing system performing referential integrity validation at operation 532. For example, referential integrity validation can include determining whether one or more references, links, keys, or related records of the processed client data properly correspond to one another across one or more tables, files, or generated outputs (e.g., whether key values are valid, whether parent-child relationships are preserved, whether linked records remain consistent, or whether one or more references are resolvable, etc.). In some examples, the computing system can use the referential integrity validation to identify cross-record or cross-table defects before final deployment or delivery.

The method 500 can include the computing system outputting error reporting at operation 534. For example, error reporting can include generating, displaying, storing, or transmitting one or more error reports, issue summaries, exception records, discrepancy logs, or remediation prompts associated with one or more validation failures or warnings (e.g., failed rule checks, missing values, invalid references, unmatched fields, or one or more other quality issues, etc.). In some examples, the computing system can present the error reporting via a graphical user interface and can provide one or more selectable controls for remediation, reprocessing, or guided correction. The method 500 can include the computing system selecting a target environment at operation 536. For example, the target environment can include a destination environment, deployment environment, validation environment, certification environment, or other computing environment configured to receive or process the converted client data (e.g., a user acceptance testing environment, production environment, staging environment, or another target environment, etc.). In some examples, selecting the target environment can include receiving a user selection, detecting an environment setting, or applying a workflow rule corresponding to deployment and delivery of the processed client data.

The method 500 can include the computing system performing integration validation at operation 538. For example, integration validation can include one or more implementation, configuration, compatibility, interoperability, or import-readiness validation operations associated with the selected target environment and the processed client data (e.g., target-environment checks, import checks, certification checks, schema-alignment checks, or downstream system integration checks, etc.). In some examples, the computing system can use the integration validation to confirm that the processed client data is activated for downstream loading, approval, activation, or use within the selected target environment. The method 500 can include the computing system outputting downloadable results at operation 540. For example, the downloadable results can include processed files, validation outputs, mapping outputs, translation outputs, audit logs, reports, or other machine-readable or human-readable artifacts associated with the migration workflow (e.g., downloadable file packages, validation reports, transformed datasets, issue summaries, or one or more output files prepared for review, archival, or transfer, etc.). In some examples, outputting the downloadable results can include packaging, generating, or otherwise providing one or more outputs for user download after completion of one or more workflow stages.

In some aspects, the method 500 can be implemented using a full-stack architecture including one or more frontend components and one or more backend services coordinated through one or more application programming interfaces, event streams, or message-based workflows. For example, one or more frontend components can include micro-frontend components configured to provide project selection, file upload, mapping review, translation review, validation review, or file download functions, and one or more backend services can include workflow orchestration services, mapping services, translation services, validation services, or instruction-processing services used to execute the conversion workflow. In some aspects, the method 500 can maintain workflow state across multiple processing stages using one or more state-management data stores. For example, the computing system can store job state information, stage progression information, mapping information, processing metadata, workflow messages, or other state data in one or more data stores (e.g., a NoSQL data store, relational database, object store, cache, or other storage system, etc.). In some examples, the computing system can track a current stage, a stage status, one or more stage-specific results, and one or more processing summaries associated with the method 500.

In some aspects, the method 500 can use a multi-tier storage architecture to store different types of workflow data at different stages of processing. For example, the computing system can store source files, processed files, mapping files, translation outputs, validation reports, schema artifacts, or backup artifacts in one or more external storage locations, can store workflow states and mapping metadata in one or more real-time state stores, and can store processed client data in one or more relational data stores used for dynamic schema generation and data transformation. In some aspects, the method 500 can use one or more real-time update mechanisms to synchronize frontend workflow views with backend processing states. For example, the computing system can use polling, server-sent events, message-driven updates, status notifications, or other communication mechanisms to update a graphical user interface with one or more stage states, progress indicators, validation results, or error conditions associated with the method 500.

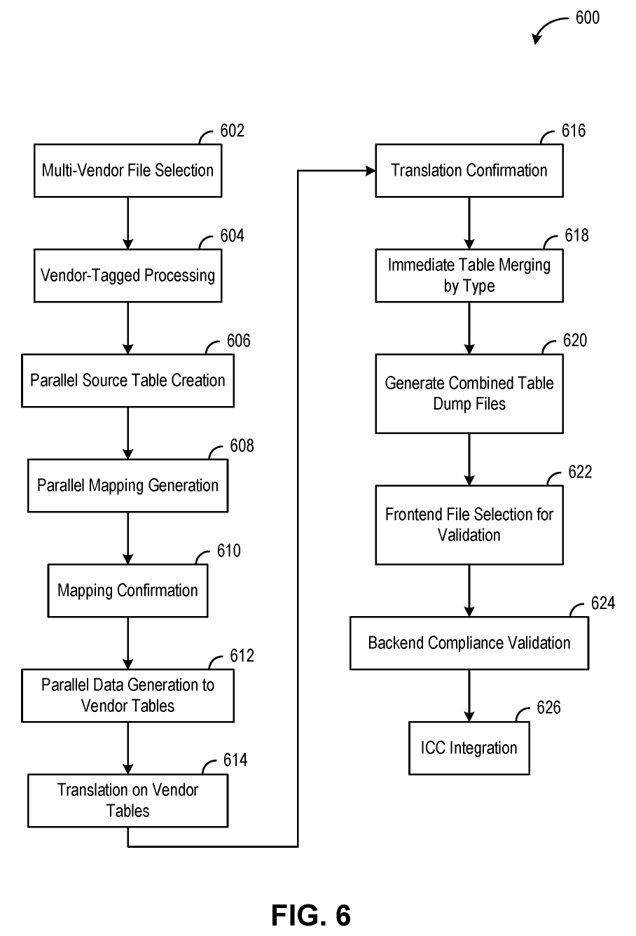

FIG. 6 is an illustrative example of a computer-implemented method for multi-vendor data conversion using parallel vendor-specific processing and table merging. Method 600 can be implemented using various systems, devices, or components discussed herein (e.g., one or more processors, one or more agents, system 100 or computing system 120 of FIG. 1, system 400 of FIG. 4, system 1100 of FIG. 11, etc.). Method 600 can include one or more operations 602-626. Operations 602-626 can be removed, reordered, adjusted, bypassed, repeated, omitted, or otherwise modified in various aspects. In some aspects, one or more operations of the method 600 can be incorporated into other methods discussed herein.

The method 600 can include a computing system (e.g., computing system 120, one or more processors, one or more agents, etc.) receiving a multi-vendor file selection at operation 602. For example, the multi-vendor file selection can include a selection of source files, datasets, records, or other client data associated with a plurality of vendors or service providers. In some examples, receiving the multi-vendor file selection can include receiving one or more vendor identifiers or other data associating each selected file with a corresponding vendor. The method 600 can include the computing system performing vendor-tagged processing at operation 604. For example, vendor-tagged processing can include classifying, grouping, routing, organizing, or otherwise processing the selected files according to vendor identifiers or other vendor context associated with the selected files. In some examples, the computing system can organize the selected files into vendor-specific groups, folders, workflows, or processing contexts (e.g., by creating or using vendor-specific storage paths, vendor-specific job metadata, vendor-specific status records, or vendor-specific workflow instances, etc.). In some examples, the computing system can use the vendor-tagged processing to maintain separation among vendor-specific source data while targeting a unified destination schema associated with a metadata-based platform.

The method 600 can include the computing system performing parallel source table creation at operation 606. For example, source table creation can include creating, generating, populating, or otherwise establishing one or more vendor-specific source tables for the selected files (e.g., source tables having names that include one or more vendor identifiers or suffixes, source tables grouped by dataset type, or source tables corresponding to employee data, payroll data, benefits data, or other categories, etc.). In some examples, performing the source table creation in parallel can include concurrently generating source tables for multiple vendors during overlapping time intervals using separate workflow instances, processing threads, or agent executions. In some examples, the computing system can use the vendor-specific source tables as inputs to downstream mapping, translation, and data generation operations.

The method 600 can include the computing system performing parallel mapping generation at operation 608. For example, mapping generation can include generating, predicting, retrieving, confirming, or otherwise determining one or more mappings between vendor-specific source data and one or more target schema elements of the metadata-based platform. In some examples, the computing system can generate mappings independently for each vendor while targeting the unified destination schema. In some examples, the computing system can retrieve one or more vendor-specific knowledge entries, apply one or more existing mapping rules, or use one or more artificial intelligence models to generate mappings for source fields that remain unmapped for a particular vendor. The method 600 can include the computing system performing mapping confirmation at operation 610. For example, mapping confirmation can include receiving one or more approvals, revisions, overrides, or confirmations associated with vendor-specific mappings. In some examples, the computing system can confirm mappings individually for each vendor, dataset, import type, or target table while preserving the unified destination schema. In some examples, the computing system can store confirmed mappings for subsequent use.

The method 600 can include the computing system performing parallel data generation to vendor tables at operation 612. For example, the vendor tables can include vendor-specific destination tables, staging tables, generated tables, or intermediate tables corresponding to one or more dataset types or import types (e.g., vendor-specific employee tables, payroll tables, etc.). In some examples, performing parallel data generation to the vendor tables can include generating, populating, updating, or otherwise producing vendor-specific output tables based on the confirmed mappings. In some examples, the computing system can perform the data generation for multiple vendors in parallel to improve processing efficiency while isolating the vendor-specific outputs prior to merging. The method 600 can include the computing system performing translation on vendor tables at operation 614. For example, translation on the vendor tables can include applying one or more translations, value mappings, normalization rules, localization rules, or other translation logic to data stored in the vendor-specific tables. In some examples, the computing system can retrieve one or more vendor-specific translation entries from a knowledge base, apply one or more confirmed translation values received from a user interface, or generate one or more artificial intelligence-based translation predictions for one or more values not covered by existing knowledge. In some examples, translation on the vendor tables can be completed independently for each vendor prior to initiation of one or more table merging operations.

The method 600 can include the computing system performing translation confirmation at operation 616. For example, translation confirmation can include receiving one or more approvals, confirmations, corrections, or finalized translation values associated with one or more vendor-specific translations. In some examples, the computing system can, responsive to translation confirmation, store one or more translation outputs in one or more vendor-specific data stores or storage paths and trigger one or more downstream processing operations. In some examples, translation confirmation can mark completion of a translation stage for one or more vendors and initiate transition to a merging stage. The method 600 can include the computing system performing immediate table merging by type at operation 618. For example, immediate table merging by type can include merging, combining, reconciling, or otherwise integrating vendor-specific tables that correspond to a dataset type, import type, or destination table type into a unified table (e.g., merging employee tables from multiple vendors into a single employee table, merging payroll tables from multiple vendors into a single payroll table, or merging other vendor-specific destination tables into corresponding unified tables, etc.). In some examples, the computing system can preserve the existing single-vendor destination table pattern for the merged tables while using vendor-specific suffixes for pre-merge vendor tables.

The method 600 can include the computing system generating combined table dump files at operation 620. For example, the combined table dump files can include one or more output files, master files, exported files, validation-ready files, or other file-based representations of the unified tables generated by the table merging operation (e.g., CSV files, structured text files, table dump files, or other machine-readable outputs stored in master or output locations, etc.). In some examples, generating the combined table dump files can include exporting, serializing, storing, or otherwise writing the unified tables to one or more file locations for downstream validation or review. The method 600 can include the computing system performing frontend file selection for validation at operation 622. For example, frontend file selection for validation can include displaying one or more combined table dump files or one or more file references via a graphical user interface and receiving a user selection of one or more files for validation. In some examples, the computing system can maintain backward compatibility by using standardized validation-stage inputs for both single-vendor and multi-vendor workflows.

The method 600 can include the computing system performing backend compliance validation at operation 624. For example, backend compliance validation can include validating the combined table dump files, unified tables, or other processed outputs against one or more target-environment constraints, schema rules, compliance requirements, or other validation criteria associated with migration of the client data. In some examples, the backend compliance validation can include one or more business rule checks, referential integrity checks, completeness checks, or target-platform validation operations performed on the merged outputs. The method 600 can include the computing system performing integration validation at operation 626. For example, integration validation can include one or more implementation, configuration, compatibility, interoperability, or import-readiness validation operations associated with the merged outputs and a selected target environment (e.g., target-environment checks, import checks, certification checks, schema-alignment checks, or downstream system integration checks, etc.).

In some examples of method 600, the computing system can process files from multiple vendors independently through one or more stages of an existing conversion pipeline and can merge outputs subsequent to translation confirmation. For example, each vendor can proceed through one or more stages corresponding to initiation, extraction, mapping, translation, generation, or other vendor-specific processing stages using separate status tracking, separate storage paths, or separate intermediate tables. In some examples, the computing system can preserve a standardized validation and downstream loading workflow by merging vendor-specific outputs into unified tables prior to validation. In some examples of method 600, the computing system can maintain vendor-specific status tracking together with overall job status tracking. For example, the computing system can store one or more vendor identifiers, vendor stage states, vendor-specific completion states, vendor-specific error states, or other per-vendor workflow data in association with a standardized or unified job instance or iteration. In some examples, the computing system can present the vendor-specific status data via a graphical user interface to support user selection, review, and visibility into progress for each vendor included in a multi-vendor job.

In some examples of method 600, the computing system can use vendor-specific storage patterns and naming conventions for pre-merge data structures while using standardized naming conventions for merged outputs. For example, the computing system can generate vendor-specific source tables, mappings, translations, storage paths, or other records that include a vendor identifier or vendor suffix. In some examples, after merging by table type, the computing system can generate unified destination tables, output files, or master files using non-vendor-specific names corresponding to a unified destination schema of the metadata-based platform. In some examples of method 600, the computing system can distinguish between single-vendor workflows and multi-vendor workflows based on one or more vendor indicators included in job configuration data. For example, the computing system can detect a multi-vendor workflow based on a plurality of vendor identifiers, a vendor-types array, source file metadata associating different files with different vendors, or other vendor-specific job configuration data. In some examples, if the multi-vendor indicators are absent, the computing system can execute a single-vendor workflow.

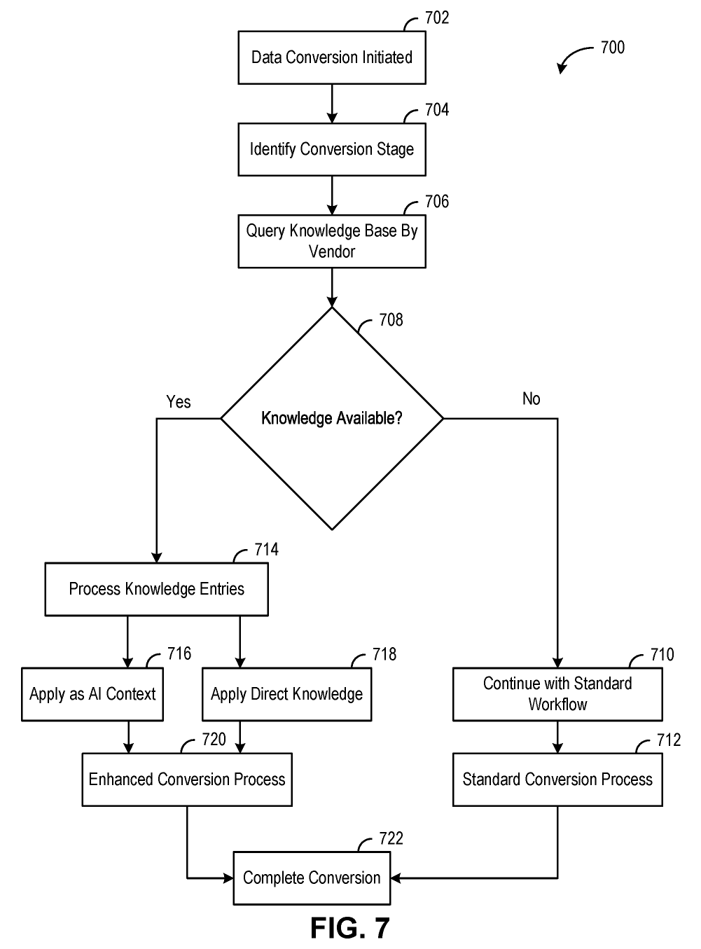

FIG. 7 is an illustrative example of a computer-implemented method for using a knowledge base for data conversion with autonomous metadata-driven processes. Method 700 can be implemented using various systems, devices, or components discussed herein (e.g., one or more processors, one or more agents, system 100 or computing system 120 of FIG. 1, system 400 of FIG. 4, system 1100 of FIG. 11, etc.). Method 700 can include one or more operations 702-722. Operations 702-722 can be removed, reordered, adjusted, bypassed, repeated, omitted, or otherwise modified in various aspects. In some aspects, one or more operations of the method 700 can be incorporated into other methods discussed herein.

The method 700 can include a computing system (e.g., computing system 120, one or more processors, one or more agents, etc.) initiating data conversion at operation 702. Data conversion can include a workflow for migrating or transforming client data for use by a metadata-based platform. For example, initiating data conversion can include receiving or detecting a request to begin the workflow (e.g., via a user selection, a workflow trigger, an API call, or another initiation event, etc.). The method 700 can include the computing system identifying a conversion stage at operation 704. The conversion stage can include a current or next stage of a multi-stage conversion workflow. For example, identifying the conversion stage can include determining or retrieving a stage indicator associated with the workflow (e.g., a mapping stage, a translation stage, a validation stage, or another stage defined by a workflow state or metadata state, etc.). The method 700 can include the computing system querying a knowledge base by vendor at operation 706. The knowledge base can include stored conversion information associated with one or more vendors and one or more conversion stages. For example, querying the knowledge base by vendor can include submitting a query using a vendor identifier together with one or more additional parameters (e.g., a target table, a target column, a conversion stage, a client identifier, or a status filter, etc.).

The method 700 can include the computing system determining whether knowledge is available at operation 708. Available knowledge can include one or more knowledge entries that satisfy one or more query conditions associated with the vendor and the conversion stage. For example, determining whether knowledge is available can include executing a data retrieval query against the knowledge based and evaluating whether the query returned one or more matching entries (e.g., active mappings, active translations, applicable rules, or other retrieved conversion assets, etc.).

If knowledge is not available at operation 708, the method 700 can include the computing system continuing with a standard workflow at operation 710. The standard workflow can include a conversion workflow that proceeds without applying retrieved knowledge entries from the knowledge base (e.g., a mapping operation, a translation operation, etc.). For example, continuing with the standard workflow can include executing one or more agent functions using existing metadata, model logic, or processing rules without stage-specific augmentation from the knowledge base (e.g., mapping, translation, transformation, or validation operations, etc.). The method 700 can include the computing system performing a standard conversion process at operation 712. The standard conversion process can include executing one or more conversion operations for the client data in accordance with a non-knowledge-enhanced workflow. For example, performing the standard conversion process can include carrying out one or more downstream stages without applying retrieved knowledge (e.g., schema alignment, field mapping, translation, validation, or structured query generation, etc.).

If knowledge is available at operation 708, the method 700 can include the computing system processing knowledge entries at operation 714. The knowledge entries can include migration instructions, such as reusable conversion information (e.g., mapping data, translation data, etc.) retrieved from the knowledge base for the vendor and the conversion stage. For example, processing the knowledge entries can include evaluating the retrieved information for applicability to the workflow (e.g., by parsing, ranking, filtering, selecting, or classifying retrieved mappings, translations, rules, or instructions, etc.). The method 700 can include the computing system applying the knowledge entries as artificial intelligence context at operation 716. Artificial intelligence context can include supplemental information provided to an artificial intelligence model to guide generation of an output. For example, applying the knowledge entries as artificial intelligence context can include providing the retrieved knowledge entries as input to a model or agent (e.g., as prompts, retrieved examples, prior mappings, translation guidance, or other contextual input, etc.). The method 700 can include the computing system applying direct knowledge at operation 718. Direct knowledge can include structured knowledge that is sufficiently applicable to be used without inferential model processing. For example, applying direct knowledge can include directly using one or more retrieved knowledge entries to control execution of a conversion operation (e.g., by applying a predefined mapping, a translation rule, a generated function, or another stored instruction, etc.).

If knowledge is available at operation 708, the method 700 can include the computing system performing an enhanced conversion process at operation 720. The enhanced conversion process can include a conversion workflow that uses retrieved knowledge from the knowledge base during execution of one or more stages. For example, performing the enhanced conversion process can include combining direct knowledge application and context-guided model execution to improve one or more conversion outcomes (e.g., accuracy, consistency, speed, or reduction in manual intervention, etc.).

The method 700 can include the computing system completing conversion at operation 722. Completing conversion can include finishing one or more processing stages associated with migration of the client data and producing one or more resulting outputs. For example, completing conversion can include outputting converted data or one or more workflow artifacts (e.g., a structured query, validation output, mapping output, translation output, or completion status, etc.).

In some examples of method 700, the computing system can maintain the knowledge base as a repository of vendor-specific conversion intelligence. The vendor-specific conversion intelligence can represent reusable information derived from prior conversion workflows for a vendor. For example, the reusable information can include mappings, translations, rules, or usage information (e.g., field-to-field mappings, value-to-value conversions, stored functions, user-defined instructions, or client usage associations, etc.). In some examples of method 700, the computing system can ingest knowledge into the knowledge base from one or more completed client implementations. For example, the computing system can retrieve conversion assets, extract reusable components, categorize the reusable components, and store the categorized components with metadata in the knowledge base (e.g., mapping assets, translation assets, client associations, or status metadata, etc.).

In some examples of method 700, the computing system can organize one or more knowledge entries according to a conceptual graph or another relationship-based data structure. The relationship-based data structure can represent associations among vendors, schema elements, and reusable conversion information. For example, the computing system can associate one or more knowledge entries with one or more entities or relationships (e.g., vendor-to-target-table associations, target-column-to-mapping associations, target-column-to-translation associations, or client usage associations, etc.). In some examples of method 700, the computing system can store the knowledge base using one or more storage architectures selected based on one or more operational requirements. For example, the computing system can use a key-value architecture, a graph architecture, or a relational architecture (e.g., a NoSQL store, a graph database, a relational database, or another storage system, etc.).

In some examples of method 700, the computing system can expose one or more knowledge base interfaces configured to create, list, retrieve, update, or otherwise manage knowledge entries. The one or more knowledge base interfaces can include one or more programmatic or graphical interfaces for interacting with the knowledge base. For example, the computing system can provide one or more interfaces that support entry creation, type listing, filtered retrieval, single-entry retrieval, or entry updates (e.g., one or more API endpoints, administrative pages, upload interfaces, or management views, etc.). In some examples of method 700, the computing system can integrate the knowledge base with one or more conversion services such that one or more services retrieve existing knowledge before generating new predictions. The one or more conversion services can include services that execute mapping, translation, instruction processing, or another stage of the conversion workflow. For example, a mapping service can retrieve existing mappings before predicting new mappings, and a translation service can retrieve existing translations before predicting new translations (e.g., limiting model prediction to unmapped columns or unknown values, etc.).

In some examples of method 700, the computing system can use one or more source tables representing consolidated data for predefined categories from multiple source files associated with a vendor. The one or more source tables can include category-based data structures used in place of file-specific data structures during one or more conversion stages. For example, the computing system can group source files by category, merge content from the grouped source files, and query the knowledge base using source-table-related identifiers (e.g., source table identifiers, source column identifiers, target table identifiers, or target column identifiers, etc.). In some examples of method 700, the computing system can update the knowledge base responsive to successful completion of one or more conversion operations. Updating the knowledge base can include storing additional reusable information derived from the completed conversion operations. For example, the computing system can store one or more confirmed mappings, confirmed translations, successful patterns, or usage values for later reuse (e.g., client associations, status values, last-used values, or other usage metadata, etc.). In some examples of method 700, the computing system can use one or more updates to the knowledge base to support one or more additional machine learning operations. The one or more additional machine learning operations can include one or more model-development or model-improvement processes that use stored knowledge patterns. For example, the computing system can detect knowledge base updates, extract relevant patterns, generate training datasets, store the training datasets, and initiate model training or fine-tuning operations (e.g., model-update workflows based on newly stored mappings or translations, etc.).

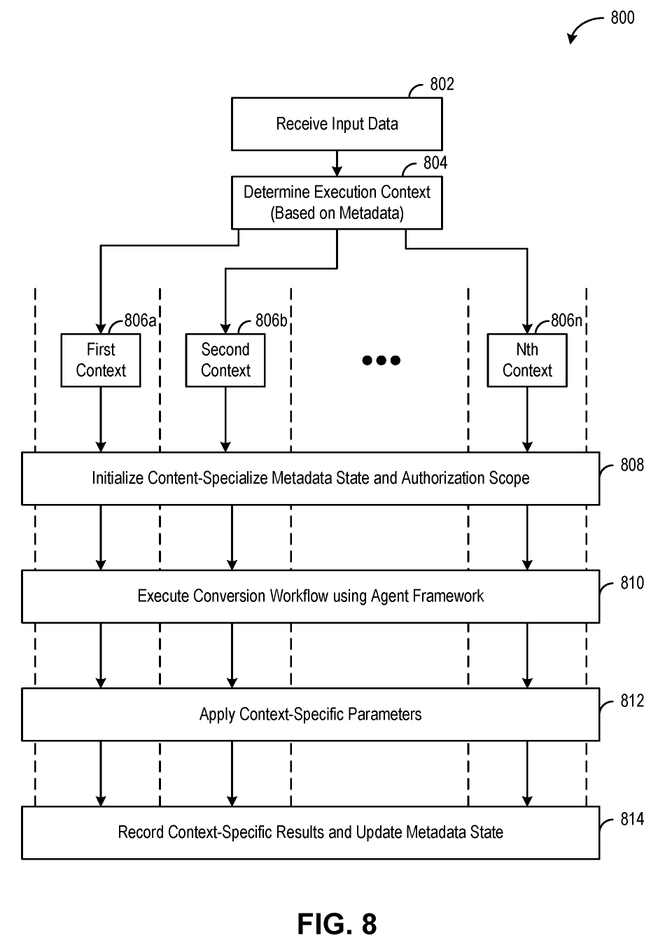

FIG. 8 is an illustrative example of a computer-implemented method for context-specific data conversion across a plurality of execution contexts. Method 800 can be implemented using various systems, devices, or components discussed herein (e.g., one or more processors, one or more agents, system 100 or computing system 120 of FIG. 1, system 400 of FIG. 4, system 1100 of FIG. 11, etc.). Method 800 can include one or more operations 802-814. Operations 802-814 can be removed, reordered, adjusted, bypassed, repeated, omitted, or otherwise modified in various aspects. In some aspects, one or more operations of the method 800 can be incorporated into other methods discussed herein.

The method 800 can include a computing system (e.g., computing system 120, one or more processors, etc.) receiving input data at operation 802. The input data can include client data associated with one or more associates, entities, records, or files to be processed during a conversion workflow. The method 800 can include the computing system determining an execution context at operation 804. The execution context can include a processing context used to localize one or more portions of the conversion workflow (e.g., for globalization). For example, determining the execution context can include identifying one or more context indicators associated with the input data (e.g., a country, a legal entity, an operational region, a locale, a jurisdiction, or another context derived from metadata, etc.). The method 800 can include the computing system identifying multiple contexts (e.g., a first context, a second context, and an Nth context) at operations 806a-806c. These execution contexts can be associated with different subsets of the input data. For example, the different execution contexts can correspond to different countries, legal entities, operational regions, or localized processing scopes (e.g., a first country-specific context, a second country-specific context, and one or more additional country-specific or region-specific contexts, etc.).

The method 800 can include the computing system initializing a context-specialized metadata state and authorization scope at operation 808. The context-specialized metadata state can include metadata configured for a particular execution context. For example, initializing the context-specialized metadata state and authorization scope can include selecting or generating one or more context-specific schemas, fields, rules, or permissions (e.g., localized import definitions, country-specific field applicability, required-field indicators, validation rules, or access restrictions associated with a selected context, etc.). The method 800 can include the computing system executing a conversion workflow using an agent framework at operation 810. The conversion workflow can include one or more agent-driven operations performed for a corresponding execution context. For example, executing the conversion workflow can include causing one or more agents to perform extraction, mapping, translation, transformation, validation, or review operations using the context-specialized metadata state (e.g., localized field selection, context-aware translation, context-based dataset routing, or country-specific validation, etc.).

The method 800 can include the computing system applying context-specific parameters at operation 812. The context-specific parameters can include configuration values that affect how the conversion workflow is executed for a corresponding execution context. For example, applying the context-specific parameters can include applying one or more context-dependent rules or settings during processing (e.g., field applicability rules, required-field rules, country-specific import availability, localized translate constraints, or routing parameters that funnel records into context-specific datasets, etc.). The method 800 can include the computing system recording context-specific results and updating the metadata state at operation 814. The context-specific results can include outputs generated for a corresponding execution context during execution of the conversion workflow. For example, recording the context-specific results and updating the metadata state can include storing one or more outputs or status values and modifying the metadata state based on those outputs (e.g., validation results, translated values, dataset-routing results, completion states, or updated context-specific mappings, etc.).

In some examples of method 800, the computing system can determine the execution context based on a legal entity associated with an associate record. The legal entity can serve as a context indicator for routing the associate record into a localized dataset. For example, the computing system can use the legal entity to identify a country or region associated with the associate record and then use the identified country or region to determine where the associate record is to be processed (e.g., a country-specific associate dataset, a localized payroll dataset, or another context-specific dataset, etc.). In some examples of method 800, the computing system can determine the execution context for an address record or an identification record based on a country value associated with the address record or the identification record. The country value can include a record-level context indicator distinct from an associate-level legal entity context. For example, the computing system can use a physical country value, a mailing country value, or another record-specific country value to determine which localized fields or translations are applicable to the address record or the identification record (e.g., country-specific address lines, state or province fields, or localized identification attributes, etc.).

In some examples of method 800, the computing system can distinguish between global data elements and localized data elements during execution of the conversion workflow. The global data elements can include fields or imports that are generally applicable across contexts, while the localized data elements can include fields or imports that are applicable only to one or more specific contexts. For example, the computing system can present or process global data elements across the plurality of execution contexts while selectively enabling localized data elements based on context applicability (e.g., payroll imports for a selected country, country-specific tax fields, or localized address fields, etc.). In some examples of method 800, the computing system can use operational region information to determine which context-specific files, fields, or datasets are applicable to a client. The operational region information can include configuration data indicating where the client operates. For example, the computing system can use the operational region information to decide which localized payroll imports or fields are to be shown, enabled, or blocked during the conversion workflow (e.g., country-specific tax imports, payroll profile fields, banking direct deposit fields, or other localized files associated with one or more operational regions, etc.).

In some examples of method 800, the computing system can permit mapping of one or more localized fields without requiring that each localized field be treated as globally required. The localized fields can include fields that apply to one or more contexts but not to all contexts. For example, the computing system can indicate which contexts a localized field is applicable to and which contexts the localized field is required for, while refraining from marking the localized field as universally required across all execution contexts (e.g., country-specific payroll fields or non-global address fields, etc.). In some examples of method 800, the computing system can support translation of localized values using context-dependent source values and context-dependent target selections. The localized values can include values with a meaning or allowable outputs that depend on a corresponding context. For example, the computing system can generate or present translations using a source country, a source state, a legal-entity-derived country, or another context value together with a source value (e.g., state, county, country subdivision, demographic value, or another localized picklist value, etc.).

In some examples of method 800, the computing system can gate execution of one or more translation operations based on completion of a legal entity operation. The legal entity operation can include a preliminary operation used to establish a context for downstream localized translations. For example, the computing system can block or defer one or more translation stages until legal entity information has been confirmed, and can output one or more messages indicating that translation is not ready until the legal entity operation is completed (e.g., a message indicating that legal entity confirmation is required before demographic or dataset translations can proceed, etc.). In some examples of method 800, the computing system can split the input data into context-specific datasets after application of one or more context-establishing translations. The context-specific datasets can include datasets corresponding to different countries, regions, or other execution contexts. For example, the computing system can apply one or more legal-entity-based translations and then separate associate records or company records into different datasets for subsequent processing (e.g., a first country-specific associate dataset, a second country-specific payroll dataset, or another context-specific dataset, etc.).

In some examples of method 800, the computing system can validate consistency between different sources of context information used during the conversion workflow. The different sources of context information can include operational region information, legal entity information, or other context-defining data. For example, the computing system can detect that a legal entity corresponds to a country not represented in configured operational regions and can flag one or more records, block one or more downstream actions, or output one or more error messages indicating that the context information is inconsistent (e.g., a mismatch between legal entity country and configured operational regions, etc.). In some examples of method 800, the computing system can support validation or commit operations across a plurality of context-specific datasets. The plurality of context-specific datasets can include separate datasets prepared for different countries or regions within a client integration workflow.

In some examples of method 800, the computing system can update one or more workflow states responsive to a change in client configuration associated with the plurality of execution contexts. The client configuration can include one or more settings that affect which contexts are applicable to the client. For example, if operational regions or purchased capabilities change during an implementation, the computing system can mark one or more workflow stages as incomplete, update one or more applicable files or fields, or output one or more messages indicating that the workflow is to be refreshed to reflect the changed configuration (e.g., newly added regions, removed regions, or changed feature availability, etc.). In some examples of method 800, the computing system can use message-based coordination between a user interface and one or more backend services to manage context-specific workflow progression. The message-based coordination can include asynchronous messages indicating completion of one or more context-related operations. For example, the user interface can detect completion of one or more mapping, translation, or data-splitting operations and can initiate one or more subsequent operations based on the detected completion.

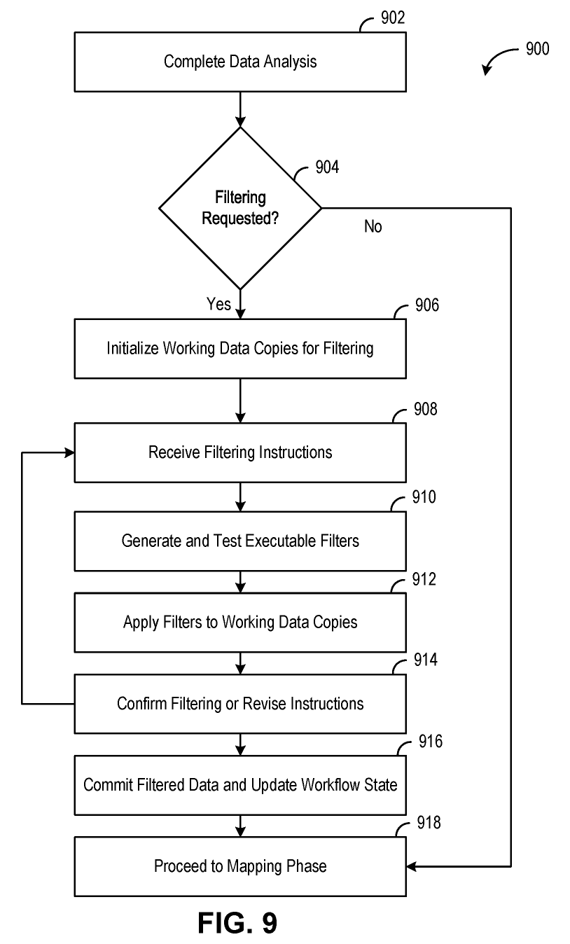

FIG. 9 is an illustrative example of a computer-implemented method for associate-data filtering for a data conversion workflow. Method 900 can be implemented using various systems, devices, or components discussed herein (e.g., one or more processors, one or more agents, system 100 or computing system 120 of FIG. 1, system 400 of FIG. 4, system 1100 of FIG. 11, etc.). Method 900 can include one or more operations 902-918. Operations 902-918 can be removed, reordered, adjusted, bypassed, repeated, omitted, or otherwise modified in various aspects. In some aspects, one or more operations of the method 900 can be incorporated into other methods discussed herein.

The method 900 can include a computing system (e.g., computing system 120, one or more processors, one or more agents, etc.) completing data analysis at operation 902. Data analysis can include an upstream analysis stage that prepares client data for subsequent conversion operations. For example, completing data analysis can include generating one or more analysis artifacts and one or more source data structures for use in filtering (e.g., source-file mappings, column metadata, detected relationships, source tables, filtered working tables, or record-count metadata, etc.). The method 900 can include the computing system determining whether filtering is requested at operation 904. Filtering can include an intermediate stage used in some examples to remove or exclude one or more portions of client data before mapping. For example, determining whether filtering is requested can include detecting a user request, a workflow selection, or a navigation event associated with a filtering interface (e.g., selection of a filter-data tab, submission of a filtering request, or another filtering-stage trigger, etc.).

The method 900 can include the computing system initializing working data copies for filtering at operation 906. The working data copies can include temporary data structures used to apply filtering operations without modifying baseline source data. For example, initializing the working data copies can include creating or populating one or more temporary tables corresponding to one or more source tables (e.g., copies of source tables having filtered-table identifiers or other temporary-table designations, etc.). The method 900 can include the computing system receiving filtering instructions at operation 908. The filtering instructions can include user-provided instructions indicating which records or data subsets are to be excluded from downstream processing. For example, receiving the filtering instructions can include receiving one or more natural language instructions associated with a selected vendor or file (e.g., an instruction to remove terminated associates, exclude records matching a date condition, or filter records associated with a selected status, etc.).

The method 900 can include the computing system generating and testing executable filters at operation 910. The executable filters can include machine-executable filtering logic derived from the filtering instructions. For example, generating and testing the executable filters can include converting a natural language instruction into one or more query expressions and evaluating the one or more query expressions against source data to preview impacted records (e.g., generating a select query, a filter query, an impact count, or sample data associated with the instruction, etc.). The method 900 can include the computing system applying filters to working data copies at operation 912. Applying the filters can include executing the generated filtering logic against the working data copies while preserving the underlying source data. For example, applying the filters can include deleting, excluding, or otherwise removing records from one or more working tables based on the executable filters (e.g., removing matching rows from temporary filtered tables while leaving original source tables unchanged, etc.).

The method 900 can include the computing system confirming filtering or revising instructions at operation 914. Confirming filtering or revising instructions can include either accepting the current filtering state or modifying one or more previously provided instructions. For example, confirming filtering or revising instructions can include receiving a confirmation input, an edit input, or a deletion input and then updating the working data copies accordingly (e.g., confirming all instructions, editing a natural language instruction, deleting an instruction, or reapplying remaining instructions in sequence, etc.). The method 900 can include the computing system committing filtered data and updating workflow state at operation 916. Committing the filtered data can include replacing or updating one or more workflow-stage data structures with data that reflects the applied filtering operations. For example, committing the filtered data and updating the workflow state can include transferring filtered data from working tables into source tables, exporting filtered data to external storage, dropping temporary tables, and updating one or more workflow-state indicators to reflect completion of the filtering stage (e.g., emitting a completion message, updating a stage status, or enabling downstream controls, etc.).

The method 900 can include the computing system proceeding to a mapping phase at operation 918. The mapping phase can include a downstream conversion stage in which source data is aligned with target schema elements of a metadata-based platform. For example, proceeding to the mapping phase can include activating or initiating one or more mapping operations after the filtering stage is completed or, if filtering is not requested, bypassing the filtering stage and continuing directly to mapping. In some examples of method 900, the computing system can present a graphical element for associate-data filtering as a selectable workflow stage after analysis and before mapping that is performed in some examples and excluded in others. In some examples of method 900, the computing system can maintain original source data separately from filtered working data during execution of the filtering stage. The filtered working data can provide a modifiable working set while preserving the original source data as a baseline. For example, the computing system can create temporary working tables from source tables during analysis and can apply filtering instructions to the temporary working tables rather than to the original source tables (e.g., to support rollback, reapplication of instructions, or efficient preview operations, etc.).

In some examples of method 900, the computing system can support vendor-specific filtering within the filtering stage. Vendor-specific filtering can permit a user to apply instructions to one vendor dataset while leaving another vendor dataset unmodified. For example, the computing system can present one or more vendors for selection, permit one or more vendors to be ignored, and restrict filtering instructions to files associated with a selected vendor (e.g., by graying out ignored-vendor data, hiding ignored-vendor files, or applying instructions only within a selected vendor scope, etc.). In some examples of method 900, the computing system can process one or more master-file instructions differently from one or more non-master-file instructions. A master-file instruction can include an instruction associated with a primary file that affects related files within the same vendor dataset. For example, the computing system can apply an instruction associated with a master file across related working tables, while an instruction associated with another file can be applied only to the corresponding file-specific working table (e.g., a human resources master file, a payroll master file, or another designated master file, etc.).

In some examples of method 900, the computing system can provide impact preview information before committing filtered data. The impact preview information can indicate how one or more filtering instructions affect one or more records within a selected file or dataset. For example, the computing system can generate or display impacted-record counts, sample records, record lists, or mismatch indicators associated with a filtering instruction (e.g., a preview of records matching an instruction, a count of excluded records, or an indication that a related file is impacted more than a master file, etc.). In some examples of method 900, the computing system can support viewing records before and after filtering using one or more paginated interfaces. The paginated interfaces can present source data and filtered data in a format that permits a user to inspect the effect of one or more filtering instructions. For example, the computing system can provide a first view showing all records with indicators identifying records that will be filtered and a second view showing only records that remain after filtering (e.g., paginated source-table views, filtered-table views, or record lists with will-be-filtered indicators, etc.).

In some examples of method 900, the computing system can manage filtering instructions across iterations of a conversion workflow. Managing the filtering instructions across iterations can include loading, reusing, modifying, or deleting one or more instructions stored from a prior iteration. For example, when a user accesses the filtering stage in a later iteration, the computing system can load previously stored instructions, display the loaded instructions, and permit confirmation, editing, deletion, or addition of instructions in the later iteration (e.g., preserving instruction continuity while permitting further refinement, etc.). In some examples of method 900, the computing system can coordinate the filtering stage with one or more mapping-stage states. The one or more mapping-stage states can affect whether filtering actions are permitted or whether mapping is to be re-confirmed. For example, if mappings were previously confirmed and one or more filtering instructions are changed, the computing system can invalidate one or more prior mapping confirmations and prompt for re-confirmation, or if mapping confirmation is in progress, the computing system can block modification of filtering instructions until the in-progress mapping action is completed (e.g., by disabling one or more controls and outputting a blocking message, etc.).

In some examples of method 900, the computing system can use one or more distributed services to execute the filtering stage. The one or more distributed services can include one or more services that coordinate user-interface interactions, instruction processing, and data-table operations. For example, a first service can receive filtering requests, a second service can convert natural language instructions into executable filters, a third service can apply the executable filters to working tables, and a workflow-coordination service can update one or more workflow states or user-interface states based on completion of the filtering operations (e.g., by using one or more asynchronous messages, status updates, or external storage artifacts, etc.).

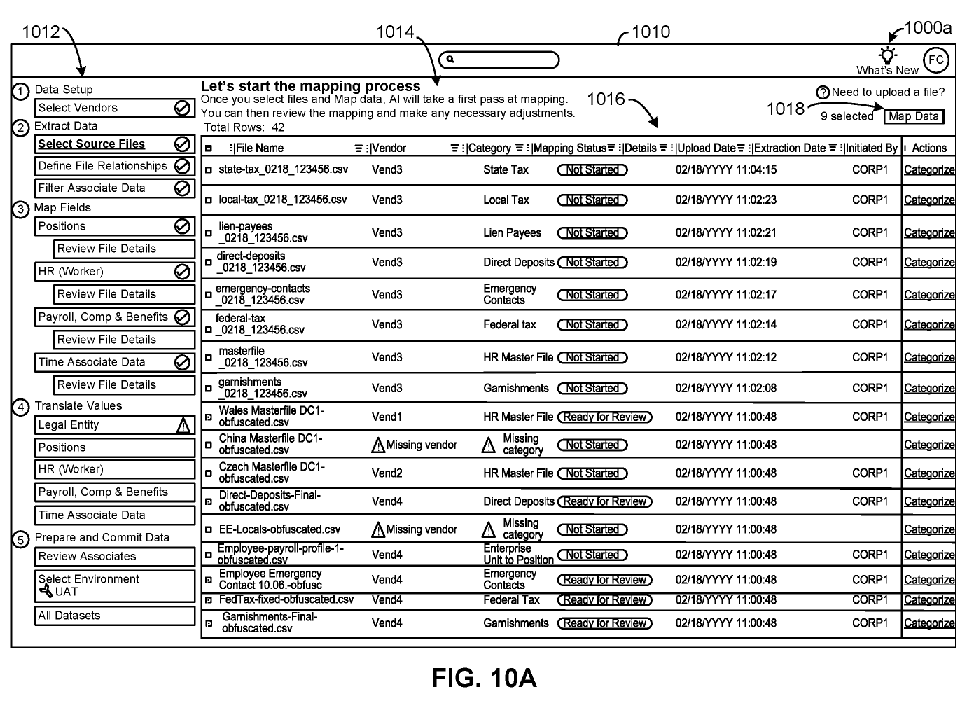

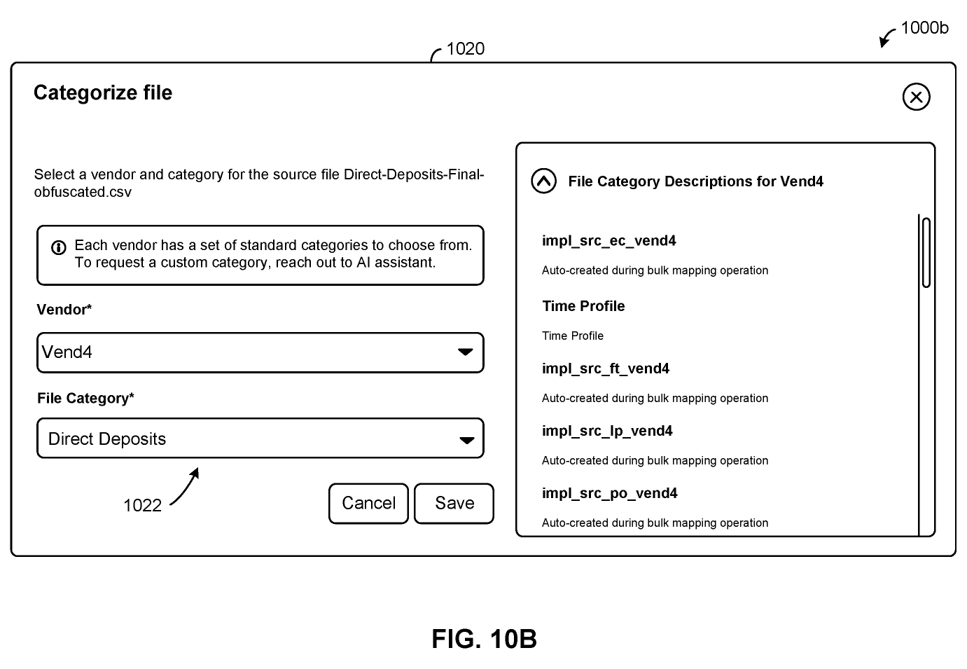

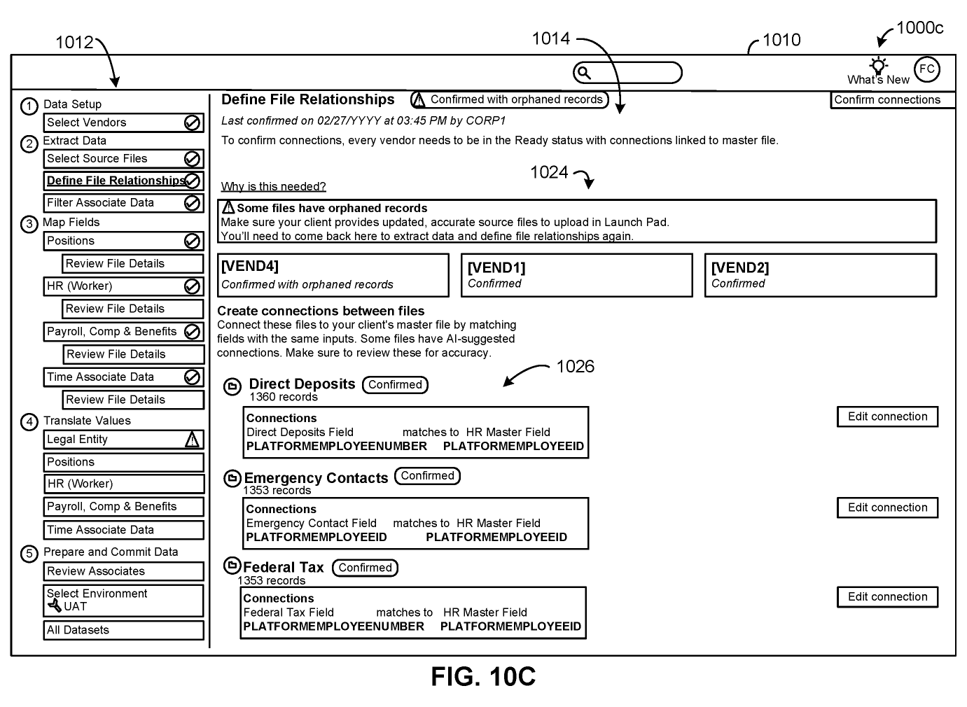

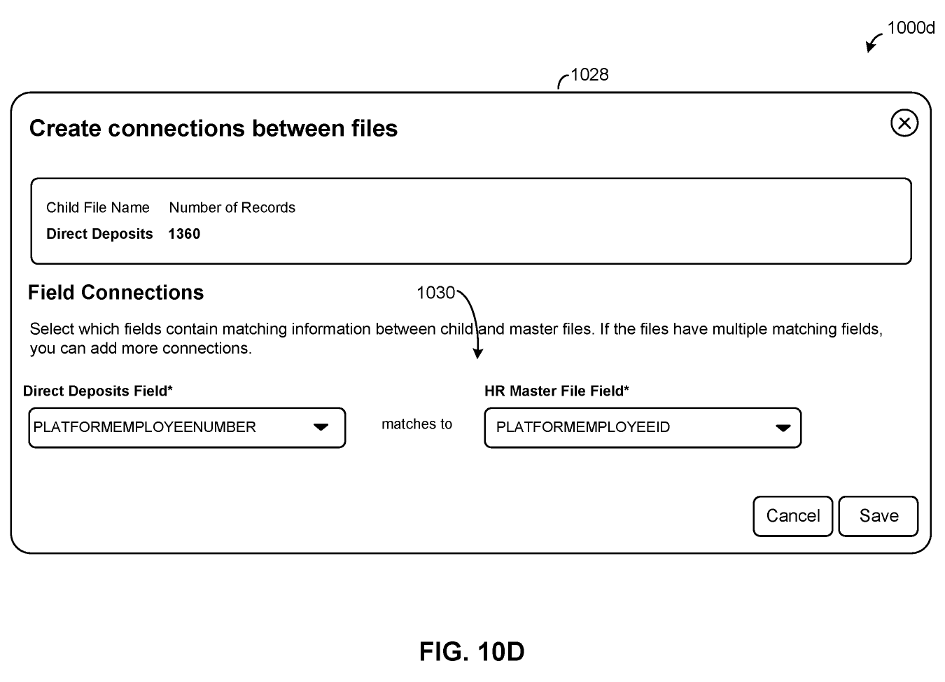

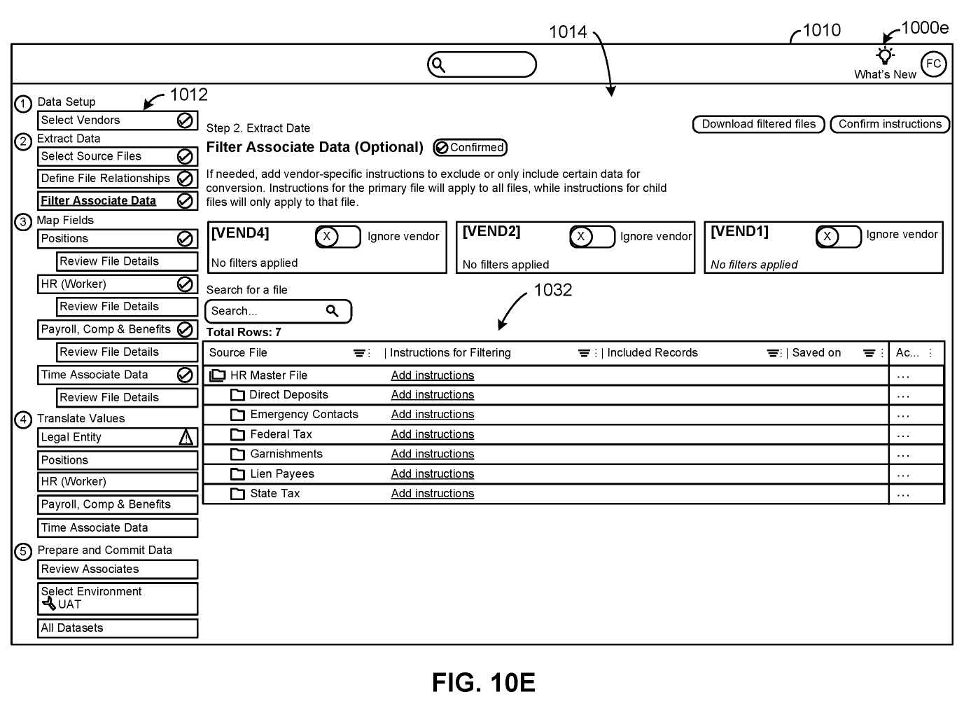

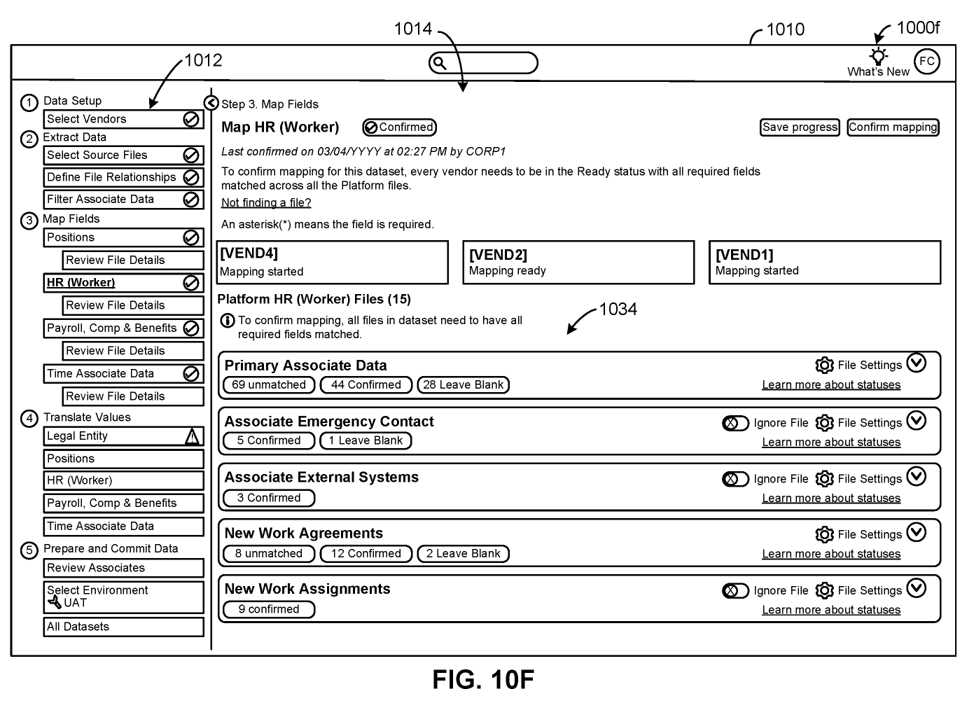

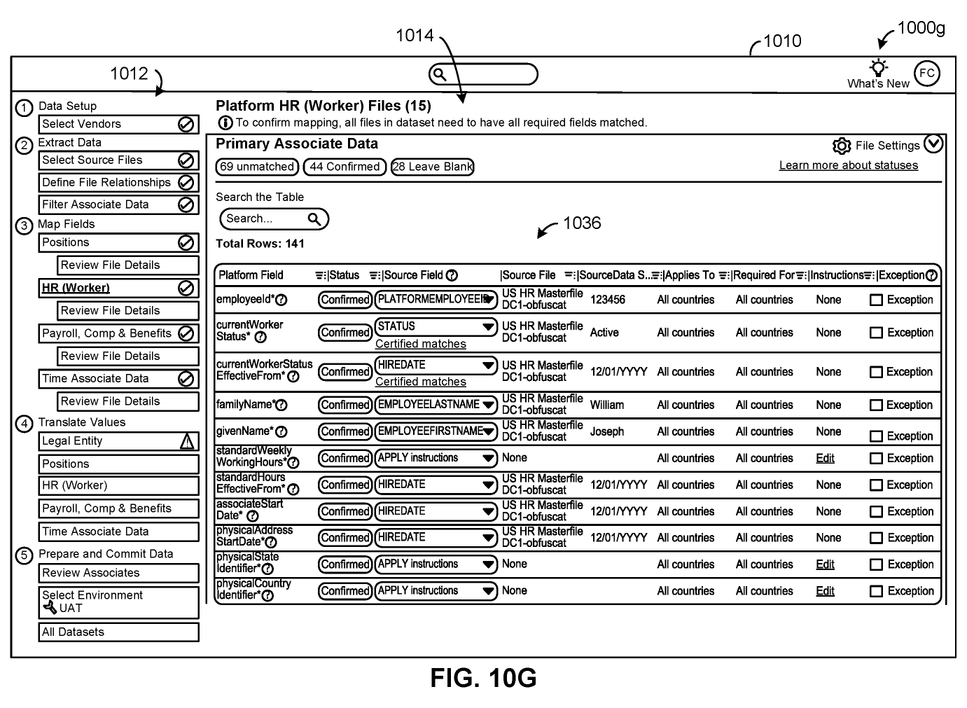

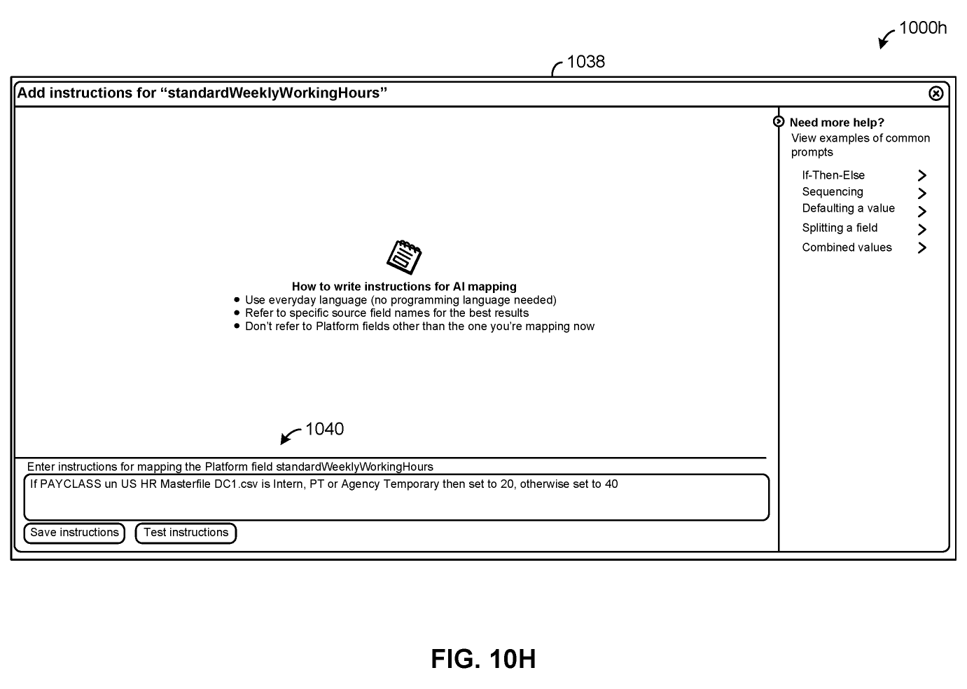

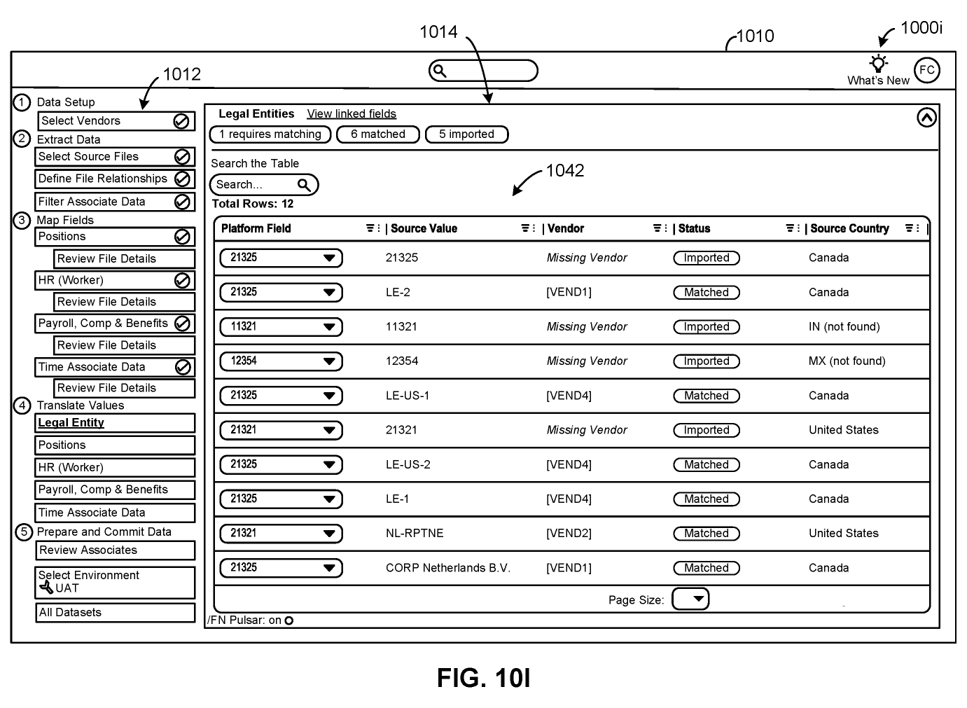

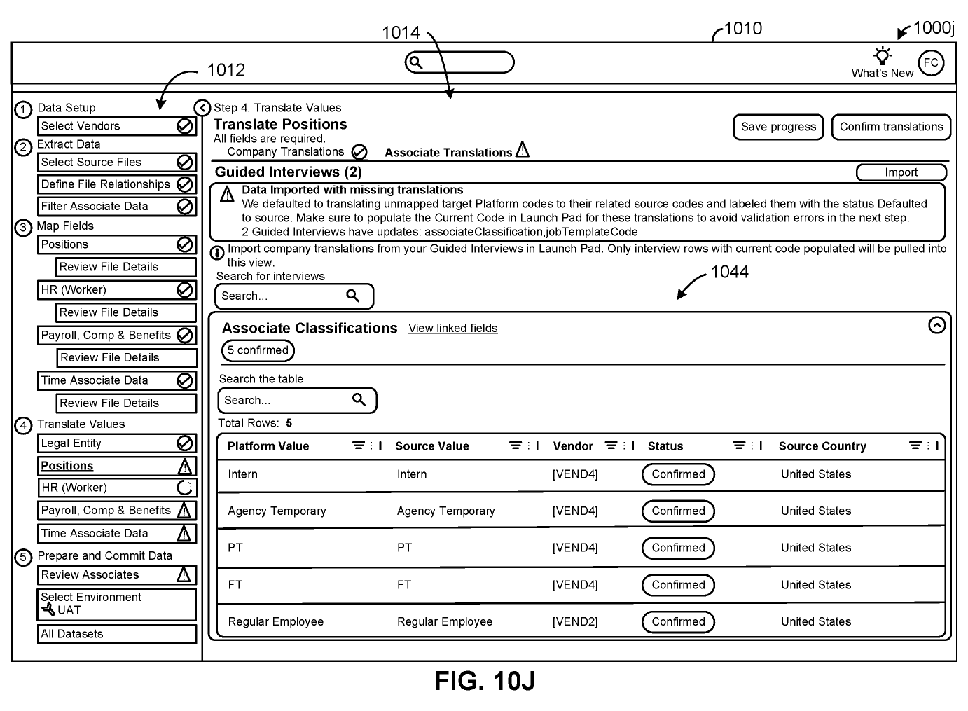

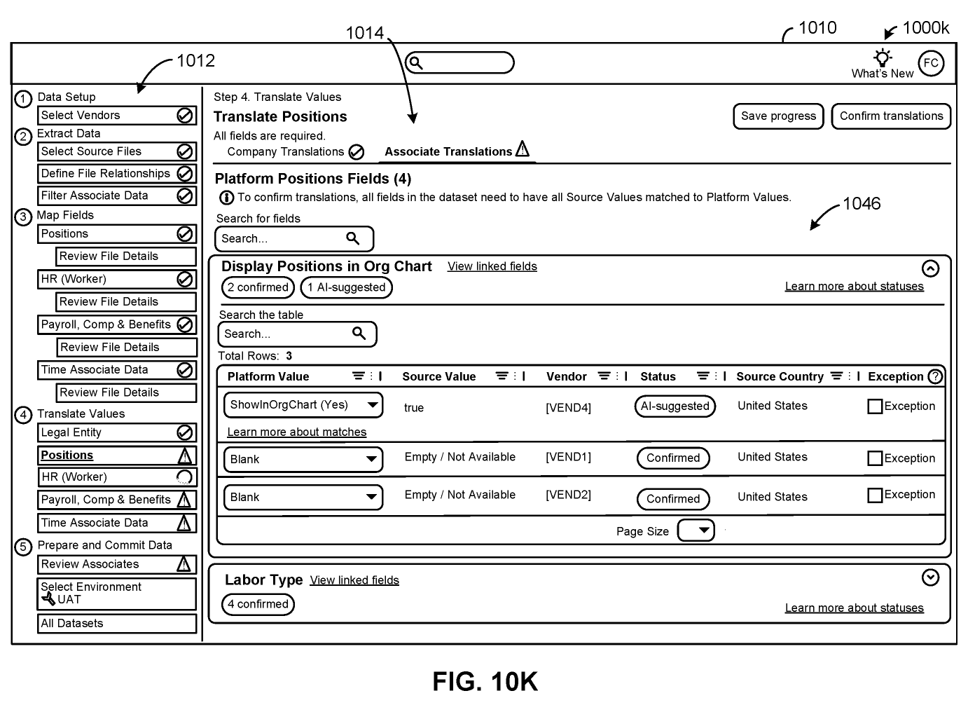

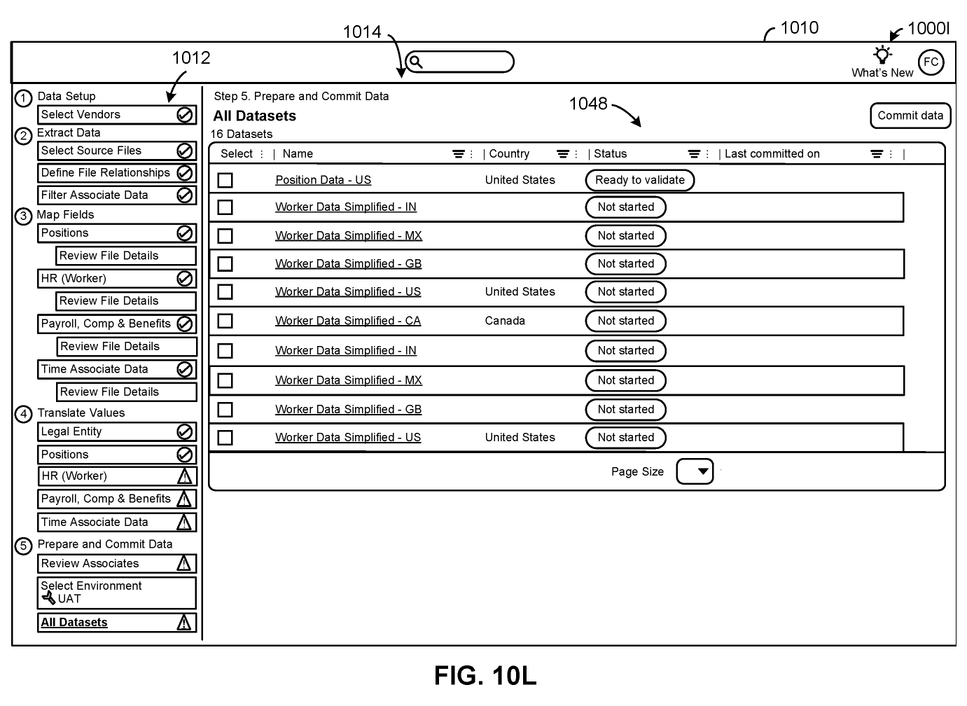

FIGS. 10A-10L depicts illustrative examples of graphical user interfaces used for rapid data migration between computing systems using autonomous metadata-driven processes. For example, graphical user interface (GUI) 1010 can be configured to present one or more stages of a migration workflow and one or more interface components for controlling the migration workflow. The GUI 1010 can include a tracker region 1012 configured to display a sequence of stages associated with execution states of respective functions of a plurality of agents (e.g., file selection, extraction, filtering, mapping, translation, validation, environment selection, or commit stages, etc.). For example, the tracker region 1012 can identify one or more completed stages, active stages, pending stages, or review stages associated with the migration workflow. The GUI 1010 can further present one or more display regions or interface components configured to present data or provide graphical controls associated with particular execution stages. In some examples, additional GUIs (e.g., pop-up windows) can be rendered in association with GUI 1010 to support stage-specific operations, as further described herein. Various elements of the GUI 1010 or other interfaces can be dynamically updated to correspond to different workflow stages. For example, the GUI 1010 can update the tracker region 1012 and other presented information or controls based on messages sent between agents that are used for performing different tasks for rapid client migration.

FIG. 10A depicts an illustrative example of an interface state 1000a of GUI 1010 for a mapping stage of a migration workflow. In some aspects, the tracker region 1012 can indicate a “select source files” stage is in progress (e.g., by emphasizing or otherwise applying a visual property to a corresponding stage in the tracker). In some examples, the interface state 1000a of GUI 1010 can be presented in response to a selection of vendors performed via the GUI 1010. The display region 1014 can present a title, instructional text, record count, workflow message, or other status information associated with source data selected for mapping. GUI 1010 can include interface components 1016 configured to present a set of source files or source records associated with the migration workflow. For example, the interface components 1016 can present a table with one or more rows corresponding to source files (e.g., client data) together with one or more attributes of the source files (e.g., file name, vendor, category, mapping status, upload date, extraction date, initiating user, or other file-related metadata, etc.). GUI 1010 can include an interface component 1018 configured to receive a user input associated with progressing the mapping stage. For example, the interface component 1018 can include a selectable control (e.g., “map data”) for initiating or confirming mapping operations for one or more selected files displayed in the display region 1016.

FIG. 10B depicts an illustrative example of an interface state 1000b of a pop-up GUI 1020 rendered in association with GUI 1010 to support categorization of a source file during a migration workflow. In some aspects, GUI 1020 can present instructional text associated with categorization of the source file, such as a file identifier, explanatory text, or category guidance associated with the source file selected for categorization. GUI 1020 can include interface components 1022 configured to receive one or more user inputs corresponding to a source-system identifier (e.g., vendor ID) or a file category. For example, the interface components 1022 can include one or more selectable controls, drop-down menus, or form fields used to assign the source file to a selected vendor and file category (e.g., direct deposits). In some aspects, GUI 1020 can present category-description information associated with the selected source-system identifier. For example, GUI 1020 can present one or more predefined categories, source-table names, descriptive labels, or usage descriptions associated with the selected source-system identifier. In some examples, GUI 1020 can include one or more interactive components configured to cancel or save the vendor and file category assignment inputs.

FIG. 10C depicts an illustrative example of an interface state 1000c of GUI 1010 for a file-relationship definition stage of a migration workflow. In some aspects, the tracker region 1012 can indicate a “define file relationships” stage is in progress. The display region 1014 can present a title, instructional text, warning message, or other status information associated with defining relationships among source files. GUI 1010 can include a display region 1024 configured to present one or more source-system groupings, vendor groupings, or file-group summaries associated with the migration workflow. For example, the display region 1024 can present one or more grouping identifiers together with one or more status indicators showing whether file relationships for the corresponding grouping have been confirmed. GUI 1010 can include interface components 1026 configured to present relationship information associated with one or more selected files. For example, the interface components 1026 can present one or more file types, record counts, matched fields, or status indicators associated with relationships between a selected file and a master file or another related file. In some examples, GUI 1010 can further include one or more interface components configured to edit or confirm the displayed file relationships.

FIG. 10D depicts an illustrative example of an interface state 1000d of a pop-up GUI 1028 rendered in association with GUI 1010 to support definition of field-level connections between files during a migration workflow. In some aspects, GUI 1028 can present summary information associated with a selected child file. For example, the display region can present a file identifier, a record count, or other summary information associated with the selected child file for which one or more connections are to be defined. For example, the GUI 1028 can include an interface to create new connections for a particular file or file type selected using the interface components 1026 discussed with reference to FIG. 10C (e.g., in response to selection of an “Edit Connection” button displayed for “Direct Deposits” file(s)). GUI 1028 can include one or more interface components 1030 configured to receive user input defining a connection between a field of the selected child file and a field of a master file. For example, the interface component 1030 can include one or more selectable controls, drop-down menus, or field-selection inputs used to indicate that a first field of the child file corresponds to a second field of the master file (e.g., a child-file identifier field and a platform master-file identifier field, etc.). In some examples, GUI 1028 can permit definition of multiple field-level connections for the selected child file and can include one or more interface components configured to cancel or save the defined connections.

FIG. 10E depicts an illustrative example of an interface state 1000e of GUI 1010 for an associate-data filtering stage of a migration workflow. In some aspects, the tracker region 1012 can indicate a “filter associate data” stage is in progress. The display region 1014 can present a title, instructional text, stage-status indicator, or other status information associated with filtering source data. GUI 1010 can include interface components 1032 configured to present one or more source files or source-file groupings associated with a selected vendor or source-system grouping. For example, the interface components 1032 can present one or more file entries together with one or more attributes or controls associated with filtering (e.g., source-file identifiers, instruction status, included-record indicators, save-time indicators, or one or more controls to add filtering instructions, etc.). In some aspects, GUI 1010 can further include one or more interface components configured to receive user input associated with vendor selection, vendor exclusion, searching for files, confirming instructions, or downloading filtered files. In some examples, the display of filtering instructions can differ based on whether a file is designated as a master file or a non-master file.

FIG. 10F depicts an illustrative example of an interface state 1000f of GUI 1010 for a field-mapping stage of a migration workflow. In some aspects, the tracker region 1012 can indicate a step of a “map fields” stage (e.g., “HR (Worker)”) is in progress. The display region 1014 can present a title, instructional text, stage-status indicator, or other status information associated with mapping fields for one or more selected datasets. GUI 1010 can include interface components 1034 configured to present one or more dataset groupings, import-type groupings, or mapping sections associated with the selected dataset. For example, the interface components 1034 can present one or more entries corresponding to platform dataset sections together with one or more mapping-status indicators or file-settings controls (e.g., counts of unmapped fields, confirmed mappings, unresolved issues, ignored-file settings, or file-configuration controls, etc.). In some examples, GUI 1010 can further include one or more interface components configured to receive user input associated with saving mapping progress or confirming mappings for the selected dataset(s).

FIG. 10G depicts an illustrative example of an interface state 1000g of GUI 1010 for a field-level mapping review stage of a migration workflow. In some aspects, the tracker region 1012 can indicate the “HR (Worker)” step of the “map fields” stage is in progress, as described with regard to FIG. 10F. The display region 1014 can present a title, instructional text, dataset identifier, or other status information associated with field-level mapping review. GUI 1010 can include interface components 1036 configured to present a table with one or more rows corresponding to platform fields associated with one or more selected datasets. The interface components 1036 can indicate which source field is mapped to each platform field for mapping, along with additional information. For example, the interface components 1036 can present one or more attributes associated with a respective platform field (e.g., field name, mapping status, source field, source file, source value, context applicability, required context, instruction status, or exception indicators, etc.). In some examples, GUI 1010 can permit a user to confirm, revise, or add mapping logic for one or more of the displayed platform fields.

FIG. 10H depicts an illustrative example of an interface state 1000h of a pop-up GUI 1038 rendered in association with GUI 1010 to support entry of mapping instructions during a migration workflow. In some aspects, GUI 1038 can present a title, help information, or instructional guidance associated with a selected platform field for which AI-based mapping instructions are to be entered. For example, GUI 1038 can present one or more display regions providing links to examples of instruction patterns, usage guidance, or suggested transformation approaches associated with the selected platform field. GUI 1038 can include one or more interface components 1040 configured to receive a user-provided mapping instruction. For example, the interface components 1040 can include a text-entry field and one or more selectable controls configured to test or save the entered instruction. Selecting a component to save the instructions can cause the instructions to be implemented into the mapping stage of the migration workflow (e.g., via a prompt or message provided to an AI-based agent), and selecting a component to test the instructions can initiate a simulation (e.g., in a sandboxed or other isolated execution environment) that provides a preview of application of the instructions to the corresponding field(s). In some examples, GUI 1038 can receive natural-language instructions used to define one or more mapping, transformation, or conditional-processing rules used in an AI-driven mapping workflow for the selected platform field. In some examples, the GUI 1010 can display information or interface components and receive inputs for mapping fields associated with other steps in the “map fields” stage, such as for a “positions” step, a “payroll, comp, and benefits” step, and a “time associated data” step, as well as corresponding “review file details” steps (e.g., for confirming such mappings).

FIG. 10I depicts an illustrative example of an interface state 1000i of GUI 1010 for a legal-entity translation stage of a migration workflow. In some aspects, the tracker region 1012 can indicate a “legal entity” step of a “translate values” stage is in progress. The display region 1014 can present a title, instructional text, or other status information associated with translation of legal-entity values. GUI 1010 can include interface components 1042 configured to present a table with one or more rows corresponding to source values and target values associated with legal-entity translation. For example, the interface components 1042 can present one or more attributes associated with a respective translation row (e.g., a platform value, a source value, a vendor identifier, a translation status, a source country, or another context indicator, etc.). In some examples, GUI 1010 can permit a user to review, confirm, or modify one or more translated legal-entity values based on country-specific or context-specific information displayed in the interface components 1042.

FIG. 10J depicts an illustrative example of an interface state 1000j of GUI 1010 for a translation stage of a migration workflow. In some aspects, the tracker region 1012 can indicate a “positions” step of a “translate values” stage is in progress. The display region 1014 can present a title, instructional text, warning message, or other status information associated with translation of values for a selected dataset. GUI 1010 can include interface components 1044 configured to present a table to associate classifications/link fields, and the table can include one or more rows associated with one or more source values and corresponding platform values. For example, the interface component 1044 can present one or more attributes associated with a row for translation (e.g., a platform value, a source value, a vendor identifier, a translation status, a source country, or one or more guided-interview indicators, etc.). In some examples, GUI 1010 can further include one or more interface components configured to import translations, save translation progress, or confirm translations for the selected dataset. In some examples, the GUI 1010 can display information or interface components and receive inputs for translating values associated with other steps in the “translate values” stage, such as for an “HR (worker)” step, a “payroll, comp, and benefits” step, and a “time associated data” step.

FIG. 10K depicts an illustrative example of an interface state 1000k of GUI 1010 for a translation review stage of a migration workflow. In some aspects, the tracker region 1012 can indicate a “positions” step of a “translate values” stage is in progress. The display region 1014 can present a title, instructional text, dataset identifier, or other status information associated with review of translated values for one or more platform fields. GUI 1010 can include interface components 1046 configured to present one or more translation sections corresponding to one or more platform field groups. For example, the interface components 1046 can present a table with one or more rows associated with a selected platform field group together with one or more translation attributes (e.g., a platform value, a source value, a vendor identifier, a translation status, a source country, or one or more exception indicators, etc.). In some examples, GUI 1010 can further include one or more interface components configured to save translation progress or confirm translations for the selected platform field group or dataset.

FIG. 10L depicts an illustrative example of an interface state 1000l of GUI 1010 for a dataset preparation or commit stage of a migration workflow. In some aspects, the tracker region 1012 can indicate an “all datasets” step of a “prepare and commit data” stage is in progress. The display region 1014 can present a title, instructional text, or other status information associated with one or more datasets prepared for validation or commitment. GUI 1010 can include one or more interface components 1048 configured to present a table with one or more dataset rows associated with the migration workflow. For example, the interface component 1048 can present one or more attributes associated with a respective dataset row provided for commitment/validation (e.g., a dataset identifier, a country or context indicator, a status value, a last-committed value, or another workflow-state attribute, etc.). In some examples, GUI 1010 can further include one or more interface components configured to receive user input associated with committing (e.g., completing migration for) one or more selected datasets. In some examples, the GUI 1010 can display information or interface components and receive inputs for associated with other steps in the “prepare and commit data” stage, such as for a “review associates” step or a “select environment” step.

FIG. 11 depicts an illustrative architecture of a computing system 1100. The block diagram of the example computing system 1100 can be referred to as the computer system 1100 or a computing environment. Computing system 1100 can be used to implement elements of the systems and methods described and illustrated herein, such as, commands, instructions, or data described herein. Computing system 1100 can be included in or run any system, subsystem, or device (e.g., a data processing system, client device 110, computing system 120, one or more agents, etc.).

Computing system 1100 can include at least one bus data bus 1105 or other communication device, structure or component for communicating information or data. Computing system 1100 can include at least one processor 1110 or processing circuit coupled to the data bus 1105 for executing instructions or processing data or information. Computing system 1100 can include one or more processors 1110 or processing circuits coupled to the data bus 1105 for exchanging or processing data or information along with other computing systems 1100. Computing system 1100 can include one or more main memories 1115, such as a random-access memory (RAM), dynamic RAM (DRAM), cache memory, or other dynamic storage device, which can be coupled to the data bus 1105 for storing information, data and instructions to be executed by the processor(s) 1110. Main memory 1115 can be used for storing information (e.g., data, computer code, commands, or instructions) during the execution of instructions by the processor(s) 1110.

Computing system 1100 can include one or more read only memories (ROMs) 1120 or other static storage device 1125 coupled to the bus 1105 for storing static information and instructions for the processor(s) 1110. Storage devices 1125 can include any storage device, such as a solid state device, magnetic disk, or optical disk, which can be coupled to the data bus 1105 to persistently store information and instructions.

Computing system 1100 can be coupled via the data bus 1105 to one or more output devices 1135, such as speakers or displays (e.g., liquid crystal display or active matrix display) for displaying or providing information to a user. Input devices 1130, such as keyboards, touch screens, or voice interfaces, can be coupled to the data bus 1105 for communicating information and commands to the processor(s) 1110. Input device 1130 can include, for example, a touch screen display (e.g., output device 1135). Input device 1130 can include a cursor control, such as a mouse, a trackball, or cursor direction keys, for communicating direction information and command selections to the processor(s) 1110 for controlling cursor movement on a display.

The processes, systems and methods described herein can be implemented by the computing system 1100 in response to the processor 1110 executing an arrangement of instructions contained in main memory 1115. Such instructions can be read into main memory 1115 from another non-transitory computer-readable medium (CRM), such as the storage device 1125. Execution of the arrangement of instructions stored thereon main memory 1115 causes the computing system 1100 to perform or execute the illustrative processes described herein. One or more processors 1110 in a multi-processing arrangement can be employed to execute the instructions contained in main memory 1115. Hard-wired circuitry can be used in place of or in combination with software instructions together with the systems and methods described herein. Systems and methods described herein are not limited to any specific combination of hardware circuitry and software.

Although an example computing system has been described in FIG. 11, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of this patent application. While aspects of this patent application have been described with reference to an exemplary embodiment, it is understood that the words which have been used herein are words of description and illustration, rather than words of limitation. Changes can be made, within the purview of the appended claims, as presently stated and as amended, without departing from the scope and spirit of this patent application in its aspects. Although aspects of this patent application have been described herein with reference to particular means, materials and embodiments, this patent application is not intended to be limited to the particulars disclosed herein; rather, this patent application extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can be performed by, and apparatuses can be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an aspect of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative aspects, it is apparent that the foregoing is illustrative and not limiting, having been presented by way of example. In particular, although many of the examples presented herein involve specific combinations of method operations or system elements, those operations and those elements can be combined in other ways to accomplish the same objectives. Operations, elements and features discussed in connection with one aspect are not intended to be excluded from a similar role in other aspects.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate aspects consisting of the items listed thereafter exclusively. In one aspect, the systems and methods described herein consist of one, each combination of more than one, or all of the described elements, operations, or components.

Any references to aspects or elements or operations of the systems and methods herein referred to in the singular may or can embrace aspects including a plurality of these elements, and any references in plural to any aspect or element or operation herein may embrace aspects including only a single element. References in the singular or plural form are not intended to limit the presently disclosed systems or methods, their components, operations, or elements to single or plural configurations. References to any operation or element being based on any information, operation or element can include aspects where the operation or element is based at least in part on any information, operation, or element.

Any aspect disclosed herein can be combined with any other aspect or example, and references to “an aspect,” “some aspects,” “one aspect” or the like are not necessarily mutually exclusive and are intended to indicate that a particular feature, structure, or characteristic described in connection with the aspect can be included in at least one aspect or example. Such terms as used herein are not necessarily all referring to the same aspect. Any aspect can be combined with any other aspect, inclusively or exclusively, in any manner consistent with the aspects disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and operations such as substitutions, changes and omissions can be made in the design, operating conditions and arrangement of the disclosed elements and operations without departing from the scope of this patent application.

What is claimed is:

1. A system comprising:
one or more processors, coupled with memory, to:
select one or more agents from a plurality of agents based on a state of metadata that corresponds to a metadata-based platform, wherein each of the plurality of agents are configured to execute respective functions to migrate client data onto the metadata-based platform;
transmit, using a first agent of the plurality of agents, a first message comprising a reference to the state of metadata of the metadata-based platform;
select, based on the first message, a second agent of the plurality of agents to execute a respective function of the second agent, the second agent different from the first agent; and
generate, based on execution of respective functions of the first agent and the second agent, a structured query configured to migrate at least a portion of the client data onto the metadata-based platform.

2. The system of claim 1, wherein the state of metadata corresponds to at least one configuration of a plurality of configurations associated with a plurality of service platforms, and wherein the one or more processors further:
select the at least one configuration based on an input corresponding with at least one service platform of the plurality of service platforms; and
execute, responsive at least in part to selection of the at least one configuration, the respective functions of the plurality of agents to migrate the client data in accordance with the at least one configuration.

3. The system of claim 1, wherein the first message further comprises a reference to the client data stored in a shared data repository or data source, and the one or more processors further:
responsive at least in part to receiving the first message, access the client data from the shared data repository or data source using the reference.

4. The system of claim 1, wherein at least one of the plurality of agents comprises a validation agent, and the one or more processors further:
responsive to execution of the respective functions of the one or more agents of the plurality of agents, compare, using the validation agent, one or more values of the client data to the state of metadata; and
output, using the validation agent, a validation result based on determining the client data conforms to the state of metadata.

5. The system of claim 1, wherein the state of metadata comprises a mapping of one or more definitions, constraints, schemas, or transformations associated with the metadata-based platform, and the one or more processors further:
update, using at least one of the plurality of agents, the client data using a respective function of the at least one of the plurality of agents in accordance with the one or more definitions, constraints, schemas, or transformations; and
generate the structured query based on the one or more definitions, constraints, schemas, or transformations.

6. The system of claim 1, wherein the one or more processors further:
remove personally identifiable information from the client data; and
process, using each agent of the plurality of agents, the state of metadata based on one or more predefined conditions associated with a respective function of each agent to determine whether to execute the respective function of each agent.

7. The system of claim 1, wherein the one or more processors further:
access, based on the state of metadata, a knowledge base comprising one or more migration instructions associated with prior onboarding instances; and
execute, using at least one agent of the plurality of agents, a respective function of the at least one agent based at least in part on the one or more migration instructions associated with the prior onboarding instances.

8. The system of claim 1, wherein the one or more processors further:
generate, using at least one agent of the plurality of agents, a review prompt based on a confidence threshold associated with execution of a respective function of the at least one agent; and
update, using the at least one agent, the client data based on input received via the review prompt.

9. The system of claim 1, wherein the one or more processors are further configured to:
execute, using at least one translation agent of the plurality of agents, a translation operation on the client data based on the state of metadata, wherein the translation operation converts one or more parameters of the client data that are associated with a first context to a second context selected for migration via the metadata-based platform.

10. The system of claim 1, wherein the one or more processors further:
receive the client data from a plurality of source systems;
generate, in parallel for the plurality of source systems, respective source tables and respective mappings for the client data;
merge at least a portion of the respective source tables into a combined table;
validate the combined table; and
generate the structured query responsive at least in part to validation of the combined table.

11. The system of claim 1, wherein the one or more processors further:
identify a conversion stage associated with migration of the client data;
query, based at least in part on identification of the conversion stage, a knowledge base to retrieve a plurality of migration instructions that correspond to the conversion stage;
apply a first migration instruction of the plurality of migration instructions to directly modify execution of a first function of the respective functions of the plurality of agents; and
provide a second migration instruction of the plurality of migration instructions as input to an artificial intelligence model used to execute a second function of the respective functions of the plurality of agents.

12. The system of claim 1, wherein the one or more processors further:
determine, based on the state of metadata, a plurality of execution contexts associated with the client data;
initialize, for each execution context of the plurality of execution contexts, a context-specific metadata state;
execute, for each execution context, a respective migration workflow using the plurality of agents based on the context-specific metadata state to generate one or more results; and
update, based at least in part on the one or more results, the context-specific metadata state for each execution context.

13. The system of claim 1, wherein the one or more processors further:
receive a request associated with filtering of the client data;
generate, responsive at least in part to receipt of the request, one or more executable filters; and
execute the one or more executable filters to remove at least a portion of the client data.

14. The system of claim 1, wherein the one or more processors further:
cause a graphical user interface to display a tracker comprising a sequence of stages of a migration workflow, wherein the sequence of stages correspond to execution states of the respective functions of the plurality of agents; and
output, via the graphical user interface, one or more selectable controls configured to control one or more stages of the sequence of stages.

15. A method comprising:
selecting, by one or more processors, coupled with memory, one or more agents from a plurality of agents based on a state of metadata that corresponds to a metadata-based platform, wherein each of the plurality of agents are configured to execute respective functions to migrate client data onto the metadata-based platform;
transmitting, by the one or more processors, using a first agent of the plurality of agents, a first message comprising a reference to the state of metadata of the metadata-based platform;
selecting, by the one or more processors, based on the first message, a second agent of the plurality of agents to execute a respective function of the second agent, the second agent different from the first agent; and
generating, by the one or more processors, based on execution of respective functions of the first agent and the second agent, a structured query configured to migrate at least a portion of the client data onto the metadata-based platform.

16. The method of claim 15, wherein the state of metadata corresponds to at least one configuration of a plurality of configurations associated with a plurality of service platforms, and wherein the method further comprises:
selecting, by the one or more processors, the at least one configuration based on an input corresponding with at least one service platform of the plurality of service platforms; and
executing, by the one or more processors, responsive at least in part to selection of the at least one configuration, the respective functions of the plurality of agents to migrate the client data in accordance with the at least one configuration.

17. The method of claim 15, wherein the first message further comprises a reference to the client data stored in a shared data repository or data source, and the method further comprising:
responsive at least in part to receiving the first message, accessing, by the one or more processors, the client data from the shared data repository or data source using the reference.

18. The method of claim 15, wherein at least one of the plurality of agents comprises a validation agent, and the method further comprising:
responsive to execution of the respective functions of the one or more agents of the plurality of agents, comparing, by the one or more processors, using the validation agent, one or more values of the client data to the state of metadata; and
outputting, by the one or more processors, using the validation agent, a validation result based on determining the client data conforms to the state of metadata.

19. The method of claim 15, wherein the state of metadata comprises a mapping of one or more definitions, constraints, schemas, or transformations associated with the metadata-based platform, and the method further comprising:
updating, by the one or more processors, using at least one of the plurality of agents, client data using a respective function of the at least one of the plurality of agents in accordance with the one or more definitions, constraints, schemas, or transformations; and
generating, by the one or more processors, the structured query based on the one or more definitions, constraints, schemas, or transformations.

20. One or more non-transitory computer-readable storage medium (CRM) having one or more instructions stored thereon, the one or more instructions executable by one or more processors to:
select one or more agents from a plurality of agents based on a state of metadata that corresponds to a metadata-based platform, wherein each of the plurality of agents are configured to execute respective functions to migrate client data onto the metadata-based platform;
transmit, using a first agent of the plurality of agents, a first message comprising a reference to the state of metadata of the metadata-based platform;
select, based on the first message, a second agent of the plurality of agents to execute a respective function of the second agent, the second agent different from the first agent; and
generate, based on execution of respective functions of the first agent and the second agent, a structured query configured to migrate at least a portion of the client data onto the metadata-based platform.
